(19) United States
(12) Patent Application Publication
(10) Pub. No.: US 2025/0176019 A1
(43) Pub. Date: May 29, 2025

(54) SYSTEMS AND METHODS FOR MAINTAINING A PREFERENTIAL SENSING LINK UPON REASSOCIATION

(71) Applicant: COGNITIVE SYSTEMS CORP., Waterloo (CA)

(72) Inventors: Chris BEG, Waterloo, Ontario (CA); Mohammad OMER, Waterloo, Ontario (CA)

(21) Appl. No.: 18/841,265

(22) PCT Filed: Feb. 24, 2023
(86) PCT No.: PCT/IB2023/051753

§ 371 Date: Aug. 23, 2024

Related U.S. Application Data
(60) Provisional application No. 63/324,954, filed on Mar. 29, 2022.
(60) Provisional application No. 63/314,966, filed on Feb. 28, 2022.

(51) Int. Cl. H04W 74/0808; H04W 24/10; H04W 60/04; H04W 76/10

(52) U.S. Cl. CPC H04W 74/0808; H04W 24/10; H04W 60/04; H04W 76/10

(57) ABSTRACT

A method is described for Wi-Fi sensing. The method is carried out by a networking device configured to operate as a station (STA) and includes at least one processor configured to execute instructions. The STA is associated with an original access point (AP) of an original basic service set (BSS) to establish an original association between the STA and the original AP. The STA and the original AP have an original communication link and an original sensing link established therebetween, the original communication link being established for data transmissions and the original sensing link being established for sensing transmissions. A transition management request identifying a preferred communication link between the STA and a preferred AP of a preferred BSS different than the original communication link with the original AP is received. Further, transmission of a transition preference indicating a preference to preserve the original sensing link is caused.

### RELATED MATTERS

This application claims priority to U.S. Provisional Application No. 63/324,954, filed Mar. 29, 2022 and to U.S. Provisional Application No. 63/314,996, filed Feb. 28, 2022, both of which are hereby incorporated herein in their entirety.

### TECHNICAL FIELD

The present disclosure generally relates to systems and methods for Wi-Fi sensing. In particular, the present disclosure relates to systems and methods for maintaining a preferential sensing link upon reassociation.

### BACKGROUND OF THE DISCLOSURE

Motion detection systems have been used to detect movement in an environment, for example, of objects in a room or in an outdoor area, in general referred to as a sensing space. The sensing space may refer to any physical space in which the Wi-Fi sensing system may operate, such as a place of residence, a place of work, a shopping mall, a sports hall or sports stadium, a garden, or any other physical space. In some example motion detection systems, infrared or optical sensors are used to detect movement of objects in the sensor's field of view. Motion detection systems have been used in security systems, automated control systems, and other types of systems. A Wi-Fi network is one recent addition to the systems that can be used to detect motion. A Wi-Fi sensing system may be a network of Wi-Fi-enabled devices that may be a part of an IEEE 802.11 network. Different Wi-Fi network configurations may be possible. Wi-Fi enabled devices in the IEEE 802.11 network may behave as sensing transmitters, sensing receivers, and sensing initiators. The Wi-Fi sensing system may be configured to detect motion or features of interest in a sensing space. The features of interest may include motion of objects and motion tracking, presence detection, intrusion detection, gesture recognition, fall detection, breathing rate detection, and other applications.

A Wi-Fi sensing system may be made up of a network of Wi-Fi devices acting as access points (APs) or stations (STAs). In examples, a STA may be capable of transmitting and receiving data traffic and also operating as a sensing transmitter. A communication link may be used for data communications between an AP and a STA, and a sensing link may be used for sensing transmissions between an AP and a STA. In certain situations, it may be preferable to change a communication link that data traffic is sent on. At the same time, it may be preferrable to maintain the sensing link without any change. In an example, a STA may only be associated with one AP at one time. If the STA becomes associated with a different AP in a different basic service set (BSS) in an extended service set (ESS), then this may result in sensing measurements being performed on a different sensing link that they were originally performed on, which may result in mischaracterization of sensing space and a deterioration in Wi-Fi sensing performance.

### BRIEF SUMMARY OF THE DISCLOSURE

The present disclosure generally relates to systems and methods for Wi-Fi sensing. In particular, the present disclosure relates to systems and methods for maintaining a preferential sensing link upon reassociation.

Systems and methods are provided for Wi-Fi sensing. In an example embodiment, a method for Wi-Fi sensing is described. The method is carried out by a networked device configured to operate as a station (STA). The networked device operating as a STA includes at least one processor configured to execute instructions. The method includes associating the STA with an original access point (AP) of an original basic service set (BSS) to establish an original association between the STA and the original AP, where the STA and the original AP have an original communication link and an original sensing link established therebetween, the original communication link being established for data transmissions and the original sensing link being established for sensing transmissions. In some embodiments, the method includes receiving a transition management request identifying a preferred communication link between the STA and a preferred AP of a preferred BSS different than the original communication link with the original AP, and causing transmission of a transition preference indicating a preference to preserve the original sensing link.

In some embodiments, the preferred communication link is identified by a distribution system based on load balancing within an extended service set (ESS) including the original BSS and the preferred BSS.

In some embodiments, the method further includes maintaining the original association between the STA and the original AP responsive to the transition preference.

In some embodiments, the transition preference indicates a requirement that the STA maintain the original association.

In some embodiments, the transition preference indicates a request that at least one other STA within the original BSS associates with an alternate AP before the STA associates with an alternate AP.

In some embodiments, the transition preference indicates a minimum performance threshold for the original communication link and a requirement that the STA maintain the original association while the original communication link maintains performance above the minimum performance threshold.

In some embodiments, the transition preference is indicated by a sensing link preference action frame indicating the preference to maintain the original association.

In some embodiments, the transition preference is indicated by a wireless network management field value in a wireless network management action frame.

In some embodiments, the transition preference includes one of a BSS transition management query and a BSS transition management response indicating a preference to maintain the original association by a preferred BSS transition candidate list.

In some embodiments, the transition preference includes a BSS transition management response indicating a preference to maintain the original association by a BSS transition management status code.

In some embodiments, the transition preference includes a BSS transition management query indicating a preference to maintain the original association in a BSS transition query reason field.

In some embodiments, the method further includes establishing a preferred association between the STA and the preferred AP.

In some embodiments, the method further includes periodically reassociating the STA to the original AP to perform a sensing measurement and reassociating the STA to the preferred AP subsequent to the sensing measurement.

In some embodiments, reassociating the STA to the original AP is performed via a fast BSS transition protocol.

In an example embodiment, a method for Wi-Fi sensing is described. The method is carried out by a networked device configured to operate as an AP of an original BSS. The method includes at least one processor configured to execute instructions. The method includes associating the AP with a STA to establish an original association between the AP and the STA, wherein the AP and the STA have an original communication link and an original sensing link established therebetween, the original communication link being established for data transmissions and the original sensing link being established for sensing transmissions. In some embodiments, the method includes receiving a transition management query identifying a preferred communication link between the STA and a preferred AP of a preferred BSS different than the original communication link with the AP, and causing transmission of a transition preference indicating a preference to preserve the original sensing link.

In some embodiments, the method includes maintaining the original association between the AP and the STA responsive to the transition preference.

In some embodiments, the transition preference indicates a requirement that the STA maintain the original association with the AP.

In some embodiments, the transition preference indicates a minimum performance threshold for the original communication link and a requirement that the STA maintain the original association with the AP while the original communication link maintains performance above the minimum performance threshold.

In some embodiments, the transition preference is indicated by a sensing link preference action frame indicating the preference to maintain the original sensing link.

In some embodiments, the transition preference is indicated by a wireless network management field value in a wireless network management action frame.

In some embodiments, the transition preference includes a BSS transition management request.

In some embodiments, the BSS transition management request indicates the preference to maintain the original association by a preferred BSS transition candidate list.

Other aspects and advantages of the disclosure will become apparent from the following detailed description, taken in conjunction with the accompanying drawings, which illustrate by way of example, the principles of the disclosure.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a diagram showing an example wireless communication system.

FIG. 2A and FIG. 2B are diagrams showing example wireless signals communicated between wireless communication devices.

FIG. 3A and FIG. 3B are plots showing examples of channel responses computed from the wireless signals communicated between wireless communication devices in FIG. 2A and FIG. 2B.

FIG. 4A and FIG. 4B are diagrams showing example channel responses associated with motion of an object in distinct regions of a space.

FIG. 4C and FIG. 4D are plots showing the example channel responses of FIG. 4A and FIG. 4B overlaid on an example channel response associated with no motion occurring in the space.

FIG. 5 depicts some of an architecture of an implementation of a Wi-Fi system for Wi-Fi sensing, according to some embodiments;

FIG. 6 depicts an example representation of a basic service set (BSS), according to some embodiments;

FIG. 7 depicts an example representation of an extended service set (ESS), according to some embodiments;

FIG. 8 depicts a process of a station (STA) authenticating and associating with an access point (AP), according to some embodiments;

FIG. 9A and FIG. 9B depict a process for BSS transition management, according to some embodiments;

FIG. 10A and FIG. 10B depict a process for fast BSS transition (FT) initial mobility domain association in a robust security network (RSN), according to some embodiments;

FIG. 11A and FIG. 11B depict an example of an over-the-air fast BSS transition protocol in an RSN, according to some embodiments;

FIG. 12A and FIG. 12B depict an example of an over-the-air fast BSS transition protocol with a resource request in an RSN, according to some embodiments;

FIG. 13 depicts a process for pre-association security negotiation (PASN) authentication, according to some embodiments;

FIG. 14A depicts an example of a Wi-Fi network including two APs that are in different BSSs as a part of an ESS, according to some embodiments;

FIG. 14B depicts an example of a Wi-Fi network including a dual-band AP, according to some embodiments;

FIG. 15A and FIG. 15B depict preferred communication links and preferred sensing links for an STA, according to some embodiments;

FIG. 16A depicts an action field format for an action frame, according to some embodiments;

FIG. 16B depicts an action field format for a sensing link preference action frame, according to some embodiments;

FIG. 17A depicts an exemplary sensing link preference request action frame, according to some embodiments;

FIG. 17B depicts an exemplary sensing link preference response action frame, according to some embodiments;

FIG. 18 depicts a BSS transition management query action frame, according to some embodiments;

FIG. 19 depicts a BSS transition management query action frame when BSS transition candidate list entries are included, according to some embodiments;

FIG. 20 depicts a neighbor report element format for use in a BSS transition management query action frame when BSS transition candidate list entries are included, according to some embodiments;

FIG. 21 depicts a BSS transition candidate preference subelement format, according to some embodiments;

FIG. 22A and FIG. 22B depict a BSS transition management request frame action field format, according to some embodiments;

FIG. 23 depicts a BSS transition management response frame action field format, according to some embodiments

FIG. 24A and FIG. 24B depict a process in media access control (MAC) sublayer management entity (MLME) interfaces for over-the-distribution system FT protocol messages, according to some embodiments;

FIG. 25 depicts a FT request frame action field format, according to some embodiments;

FIG. 26 depicts an example representation of an over-the-air FT protocol, according to some embodiments;

FIG. 27 depicts a wrapped data element format, according to some embodiments;

FIG. 28 depicts a PASN parameters element format, according to some embodiments;

FIG. 29 depicts an authentication frame body, according to some embodiments;

FIG. 30 depicts a flowchart for causing transmission of a transition preference indicating a preference to preserve an original sensing link, according to some embodiments;

FIG. 31 depicts a flowchart for maintaining an original association between a STA and an original AP responsive to a transition preference, according to some embodiments;

FIG. 32A and FIG. 32B depict a flowchart for performing a sensing measurement according to PASN authentication frames exchanged between a STA and an original AP while maintaining a preferred association, according to some embodiments;

FIG. 33A and FIG. 33B depict a flowchart for reassociation of a STA to a preferred AP subsequent to a sensing measurement, according to some embodiments;

FIG. 34 depicts a flowchart for causing transmission of a transition preference indicating a preference to preserve an original sensing link, according to some embodiments; and

FIG. 35 depicts a flowchart for maintaining an original association between an AP and a STA responsive to a transition preference, according to some embodiments.

### DETAILED DESCRIPTION

In some aspects of what is described herein, a wireless sensing system may be used for a variety of wireless sensing applications by processing wireless signals (e.g., radio frequency (RF) signals) transmitted through a space between wireless communication devices. Example wireless sensing applications include motion detection, which can include the following: detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications. Other examples of wireless sensing applications include object recognition, speaking recognition, keystroke detection and recognition, tamper detection, touch detection, attack detection, user authentication, driver fatigue detection, traffic monitoring, smoking detection, school violence detection, human counting, human recognition, bike localization, human queue estimation, Wi-Fi imaging, and other types of wireless sensing applications. For instance, the wireless sensing system may operate as a motion detection system to detect the existence and location of motion based on Wi-Fi signals or other types of wireless signals. As described in more detail below, a wireless sensing system may be configured to control measurement rates, wireless connections, and device participation, for example, to improve system operation or to achieve other technical advantages. The system improvements and technical advantages achieved when the wireless sensing system is used for motion detection are also achieved in examples where the wireless sensing system is used for another type of wireless sensing application.

In some example wireless sensing systems, a wireless signal includes a component (e.g., a synchronization preamble in a Wi-Fi PHY frame, or another type of component) that wireless devices can use to estimate a channel response or other channel information, and the wireless sensing system can detect motion (or another characteristic depending on the wireless sensing application) by analyzing changes in the channel information collected over time. In some examples, a wireless sensing system can operate similar to a bistatic radar system, where a Wi-Fi access point (AP) assumes the receiver role, and each Wi-Fi device (station (STA), node, or peer) connected to the AP assumes the transmitter role. The wireless sensing system may trigger a connected device to generate a transmission and produce a channel response measurement at a receiver device. This triggering process can be repeated periodically to obtain a sequence of time variant measurements. A wireless sensing algorithm may then receive the generated time-series of channel response measurements (e.g., computed by Wi-Fi receivers) as input, and through a correlation or filtering process, may then make a determination (e.g., determine if there is motion or no motion within the environment represented by the channel response, for example, based on changes or patterns in the channel estimations). In examples where the wireless sensing system detects motion, it may also be possible to identify a location of the motion within the environment based on motion detection results among a number of wireless devices.

Accordingly, wireless signals received at each of the wireless communication devices in a wireless communication network may be analyzed to determine channel information for the various communication links (between respective pairs of wireless communication devices) in the network. The channel information may be representative of a physical medium that applies a transfer function to wireless signals that traverse a space. In some instances, the channel information includes a channel response. Channel responses can characterize a physical communication path, representing the combined effect of, for example, scattering, fading, and power decay within the space between the transmitter and receiver. In some instances, the channel information includes beamforming state information (e.g., a feedback matrix, a steering matrix, channel state information, etc.) provided by a beamforming system. Beamforming is a signal processing technique often used in multi antenna (multiple-input/multiple-output (MIMO)) radio systems for directional signal transmission or reception. Beamforming can be achieved by operating elements in an antenna array in such a way that signals at some angles experience constructive interference while others experience destructive interference.

The channel information for each of the communication links may be analyzed (e.g., by a hub device or other device in a wireless communication network, or a sensing transmitter, sensing receiver, or sensing initiator communicably coupled to the network) to, for example, detect whether motion has occurred in the space, to determine a relative location of the detected motion, or both. In some aspects, the channel information for each of the communication links may be analyzed to detect whether an object is present or absent, e.g., when no motion is detected in the space.

In some cases, a wireless sensing system can control a node measurement rate. For instance, a Wi-Fi motion system may configure variable measurement rates (e.g., channel estimation/environment measurement/sampling rates) based on criteria given by a current wireless sensing application (e.g., motion detection). In some implementations, when no motion is present or detected for a period of time, for example, the wireless sensing system can reduce the rate that the environment is measured, such that the connected device will be triggered or caused to make sensing transmissions or sensing measurements less frequently. In some implementations, when motion is present, for example, the wireless sensing system can increase the triggering rate or sensing transmission rate or sensing measurement rate to produce a time-series of measurements with finer time resolution. Controlling the variable sensing measurement rate can allow energy conservation (through the device triggering), reduce processing (less data to correlate or filter), and improve resolution during specified times.

In some cases, a wireless sensing system can perform band steering or client steering of nodes throughout a wireless network, for example, in a Wi-Fi multi-AP or extended service set (ESS) topology, multiple coordinating wireless APs each provide a basic service set (BSS) which may occupy different frequency bands and allow devices to transparently move between from one participating AP to another (e.g., mesh). For instance, within a home mesh network, Wi-Fi devices can connect to any of the APs, but typically select one with good signal strength. The coverage footprint of the mesh APs typically overlap, often putting each device within communication range or more than one AP. If the AP supports multi-bands (e.g., 2.4 GHz and 5 GHZ), the wireless sensing system may keep a device connected to the same physical AP but instruct it to use a different frequency band to obtain more diverse information to help improve the accuracy or results of the wireless sensing algorithm (e.g., motion detection algorithm). In some implementations, the wireless sensing system can change a device from being connected to one mesh AP to being connected to another mesh AP. Such device steering can be performed, for example, during wireless sensing (e.g., motion detection), based on criteria detected in a specific area to improve detection coverage, or to better localize motion within an area.

In some cases, beamforming may be performed between wireless communication devices based on some knowledge of the communication channel (e.g., through feedback properties generated by a receiver), which can be used to generate one or more steering properties (e.g., a steering matrix) that are applied by a transmitter device to shape the transmitted beam/signal in a particular direction or directions. Thus, changes to the steering or feedback properties used in the beamforming process indicate changes, which may be caused by moving objects, in the space accessed by the wireless communication system. For example, a motion may be detected by substantial changes in the communication channel, e.g., as indicated by a channel response, or steering or feedback properties, or any combination thereof, over a period of time.

In some implementations, for example, a steering matrix may be generated at a transmitter device (beamformer) based on a feedback matrix provided by a receiver device (beamformee) based on channel sounding. Because the steering and feedback matrices are related to propagation characteristics of the channel, these matrices change as objects move within the channel. Changes in the channel characteristics are accordingly reflected in these matrices, and by analyzing the matrices, motion can be detected, and different characteristics of the detected motion can be determined. In some implementations, a spatial map may be generated based on one or more beamforming matrices. The spatial map may indicate a general direction of an object in a space relative to a wireless communication device. In some cases, many beamforming matrices (e.g., feedback matrices or steering matrices) may be generated to represent a multitude of directions that an object may be located relative to a wireless communication device. These many beamforming matrices may be used to generate the spatial map. The spatial map may be used to detect the presence of motion in the space or to detect a location of the detected motion.

In some instances, a motion detection system can control a variable device measurement rate in a motion detection process. For example, a feedback control system for a multi-node wireless motion detection system may adaptively change the sample rate based on the environment conditions. In some cases, such controls can improve operation of the motion detection system or provide other technical advantages. For example, the measurement rate may be controlled in a manner that optimizes or otherwise improves air-time usage versus detection ability suitable for a wide range of different environments and different motion detection applications. The measurement rate may be controlled in a manner that reduces redundant measurement data to be processed, thereby reducing processor load/power requirements. In some cases, the measurement rate is controlled in a manner that is adaptive, for instance, an adaptive sample can be controlled individually for each participating device. An adaptive sample rate can be used with a tuning control loop for different use cases, or device characteristics.

In some cases, a wireless sensing system can allow devices to dynamically indicate and communicate their wireless sensing capability or wireless sensing willingness to the wireless sensing system. For example, there may be times when a device does not want to be periodically interrupted or triggered to transmit a wireless signal that would allow the AP to produce a channel measurement. For instance, if a device is sleeping, frequently waking the device up to transmit or receive wireless sensing signals could consume resources (e.g., causing a cell phone battery to discharge faster). These and other events could make a device willing or not willing to participate in wireless sensing system operations. In some cases, a cell phone running on its battery may not want to participate, but when the cell phone is plugged into the charger, it may be willing to participate. Accordingly, if the cell phone is unplugged, it may indicate to the wireless sensing system to exclude the cell phone from participating; whereas if the cell phone is plugged in, it may indicate to the wireless sensing system to include the cell phone in wireless sensing system operations. In some cases, if a device is under load (e.g., a device streaming audio or video) or busy performing a primary function, the device may not want to participate; whereas when the same device's load is reduced and participating will not interfere with a primary function, the device may indicate to the wireless sensing system that it is willing to participate.

Example wireless sensing systems are described below in the context of motion detection (detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications). However, the operation, system improvements, and technical advantages achieved when the wireless sensing system is operating as a motion detection system are also applicable in examples where the wireless sensing system is used for another type of wireless sensing application.

In various embodiments of the disclosure, non-limiting definitions of one or more terms that will be used in the document are provided below.

A term “sensing initiator” may refer to a device that initiates a Wi-Fi sensing session. The role of sensing initiator may be taken on by a sensing receiver and a sensing transmitter.

A term “sensing transmission” may refer to any transmission made from a sensing transmitter to a sensing receiver that may be used to make a sensing measurement. In an example, sensing transmission may also be referred to as wireless sensing signal or wireless signal.

A term “sensing measurement” may refer to a measurement of a state of a channel i.e., channel state information measurement between the sensing transmitter and the sensing receiver derived from a transmission, for example, a sensing transmission.

A term “sensing transmitter” may refer to a device that sends transmissions used for sensing measurements in a wireless local area network (WLAN) sensing session. In an example, a station (STA) is an example of a sensing transmitter. In some examples, an access point (AP) may also be a sensing transmitter for Wi-Fi sensing purposes in the example where a STA acts as a sensing receiver.

A term “sensing receiver” may refer to a device that receives transmission sent by a sensing transmitter and performs one or more sensing measurements in a WLAN sensing session. An AP is an example of a sensing receiver. In some examples, a STA may also be a sensing receiver in a mesh network scenario.

A term “sensing space” may refer to a physical space in which a Wi-Fi sensing system may operate.

A term “pre-association security negotiation (PASN)” may be a robust security networks association (RSNA) authentication protocol in all cases where it relies on the existence of a pairwise master key security association (PMKSA) for an authentication and key management (AKM).

A term “authentication and key management (AKM)” may be used to describe the process of IEEE 802.1X/extensible authentication protocol (EAP) authentication and subsequent encryption key generation and is a major component of EAP and IEEE 802.1X. Each time a device associates or re-associates, the entire AKM process must occur, which may result in an extremely secure and robust wireless network.

A term “pairwise master key security association (PMKSA)” may refer to an association that may be generated at the end of an EAP handshake (successful 802.1X negotiation) or when a pre-shared key (PSK) is configured. In an example, the PMKSA may bind a pairwise master key (PMK) to a lifetime which can persist across multiple associations by a roaming STA.

A term “pairwise master key (PMK)” may refer to a shared secret key that is generated after the PSK or 802.1X authentication. In PSK authentication, the PMK is actually the PSK, which is typically derived from a Wi-Fi password by putting it through a key derivation function that uses secure hash algorithm 1 (SHA-1) as the cryptographic hash function. If an 802.1X EAP exchange was carried out, the PMK may be derived from EAP parameters provided by an authentication server.

A term “extensible authentication protocol (EAP)” may refer to an authentication framework that may frequently be used in network and internet connections. For example, in IEEE 802.11 (Wi-Fi), the Wi-Fi protected access (WPA) and Wi-Fi protected access 2 (WPA2) standards may have adopted IEEE 802.1X (with various EAP types) as the canonical authentication mechanism.

A term “Wi-Fi sensing session” may refer to a period during which objects in a physical space may be probed, detected and/or characterized. In an example, during a Wi-Fi sensing session, several devices participate in, and thereby contribute to the generation of sensing measurements. A Wi-Fi sensing session may also be referred to as a WLAN sensing session or simply a sensing session.

For purposes of reading the description of the various embodiments below, the following descriptions of the sections of the specifications and their respective contents may be helpful:

Section A describes a wireless communications system, wireless transmissions and sensing measurements which may be useful for practicing embodiments described herein.

Section B describes systems and methods that are useful for a Wi-Fi sensing system configured to send sensing transmissions and make sensing measurements.

Section C describes embodiments of systems and methods for maintaining a preferential sensing link upon reassociation.

### A. Wireless Communications System, Wireless Transmissions, and Sensing Measurements

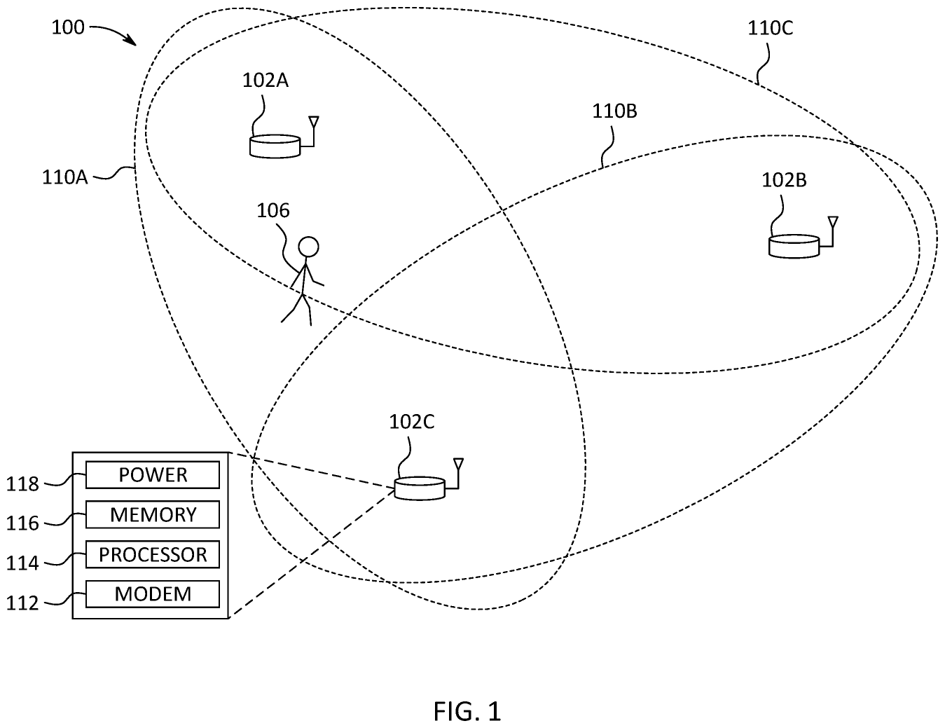

FIG. 1 illustrates wireless communication system 100. Wireless communication system 100 includes three wireless communication devices: first wireless communication device 102A, second wireless communication device 102B, and third wireless communication device 102C. Wireless communication system 100 may include additional wireless communication devices and other components (e.g., additional wireless communication devices, one or more network servers, network routers, network switches, cables, or other communication links, etc.).

Wireless communication devices 102A, 102B, 102C can operate in a wireless network, for example, according to a wireless network standard or another type of wireless communication protocol. For example, the wireless network may be configured to operate as a wireless local area network (WLAN), a personal area network (PAN), a metropolitan area network (MAN), or another type of wireless network. Examples of WLANs include networks configured to operate according to one or more of the 802.11 family of standards developed by IEEE (e.g., Wi-Fi networks), and others. Examples of PANs include networks that operate according to short-range communication standards (e.g., Bluetooth®, Near Field Communication (NFC), ZigBee), millimeter wave communications, and others.

In some implementations, wireless communication devices 102A, 102B, 102C may be configured to communicate in a cellular network, for example, according to a cellular network standard. Examples of cellular networks include networks configured according to 2G standards such as Global System for Mobile (GSM) and Enhanced Data rates for GSM Evolution (EDGE) or EGPRS; 3G standards such as code division multiple access (CDMA), wideband code division multiple access (WCDMA), Universal Mobile Telecommunications System (UMTS), and time division synchronous code division multiple access (TD-SCDMA); 4G standards such as Long-Term Evolution (LTE) and LTE-Advanced (LTE-A); 5G standards, and others.

In the example shown in FIG. 1, wireless communication devices 102A, 102B, 102C can be, or they may include standard wireless network components. For example, wireless communication devices 102A, 102B, 102C may be commercially-available Wi-Fi APs or another type of wireless access point (WAP) performing one or more operations as described herein that are embedded as instructions (e.g., software or firmware) on the modem of the WAP. In some cases, wireless communication devices 102A, 102B, 102C may be nodes of a wireless mesh network, such as, for example, a commercially-available mesh network system (e.g., Plume Wi-Fi, Google Wi-Fi, Qualcomm Wi-Fi SON, etc.). In some cases, another type of standard or conventional Wi-Fi transmitter device may be used. In some instances, one or more of wireless communication devices 102A, 102B, 102C may be implemented as WAPs in a mesh network, while other wireless communication device(s) 102A, 102B, 102C are implemented as leaf devices (e.g., mobile devices, smart devices, etc.) that access the mesh network through one of the WAPs. In some cases, one or more of wireless communication devices 102A, 102B, 102C is a mobile device (e.g., a smartphone, a smart watch, a tablet, a laptop computer, etc.), a wireless-enabled device (e.g., a smart thermostat, a Wi-Fi enabled camera, a smart TV), or another type of device that communicates in a wireless network.

Wireless communication devices 102A, 102B, 102C may be implemented without Wi-Fi components; for example, other types of standard or non-standard wireless communication may be used for motion detection. In some cases, wireless communication devices 102A, 102B, 102C can be, or they may be part of, a dedicated motion detection system. For example, the dedicated motion detection system can include a hub device and one or more beacon devices (as remote sensor devices), and wireless communication devices 102A, 102B, 102C can be either a hub device or a beacon device in the motion detection system.

As shown in FIG. 1, wireless communication device 102C includes modem 112, processor 114, memory 116, and power unit 118; any of wireless communication devices 102A, 102B, 102C in wireless communication system 100 may include the same, additional or different components, and the components may be configured to operate as shown in FIG. 1 or in another manner. In some implementations, modem 112, processor 114, memory 116, and power unit 118 of a wireless communication device are housed together in a common housing or other assembly. In some implementations, one or more of the components of a wireless communication device can be housed separately, for example, in a separate housing or other assembly.

Modem 112 can communicate (receive, transmit, or both) wireless signals. For example, modem 112 may be configured to communicate RF signals formatted according to a wireless communication standard (e.g., Wi-Fi or Bluetooth). Modem 112 may be implemented as the example wireless network modem 112 shown in FIG. 1, or may be implemented in another manner, for example, with other types of components or subsystems. In some implementations, modem 112 includes a radio subsystem and a baseband subsystem. In some cases, the baseband subsystem and radio subsystem can be implemented on a common chip or chipset, or they may be implemented in a card or another type of assembled device. The baseband subsystem can be coupled to the radio subsystem, for example, by leads, pins, wires, or other types of connections.

In some cases, a radio subsystem in modem 112 can include one or more antennas and RF circuitry. The RF circuitry can include, for example, circuitry that filters, amplifies, or otherwise conditions analog signals, circuitry that up-converts baseband signals to RF signals, circuitry that down-converts RF signals to baseband signals, etc. Such circuitry may include, for example, filters, amplifiers, mixers, a local oscillator, etc. The radio subsystem can be configured to communicate radio frequency wireless signals on the wireless communication channels. As an example, the radio subsystem may include a radio chip, an RF front end, and one or more antennas. A radio subsystem may include additional or different components. In some implementations, the radio subsystem can be or include the radio electronics (e.g., RF front end, radio chip, or analogous components) from a conventional modem, for example, from a Wi-Fi modem, pico base station modem, etc. In some implementations, the antenna includes multiple antennas.

In some cases, a baseband subsystem in modem 112 can include, for example, digital electronics configured to process digital baseband data. As an example, the baseband subsystem may include a baseband chip. A baseband subsystem may include additional or different components. In some cases, the baseband subsystem may include a digital signal processor (DSP) device or another type of processor device. In some cases, the baseband system includes digital processing logic to operate the radio subsystem, to communicate wireless network traffic through the radio subsystem, to detect motion based on motion detection signals received through the radio subsystem or to perform other types of processes. For instance, the baseband subsystem may include one or more chips, chipsets, or other types of devices that are configured to encode signals and deliver the encoded signals to the radio subsystem for transmission, or to identify and analyze data encoded in signals from the radio subsystem (e.g., by decoding the signals according to a wireless communication standard, by processing the signals according to a motion detection process, or otherwise).

In some instances, the radio subsystem in modem 112 receives baseband signals from the baseband subsystem, up-converts the baseband signals to RF signals, and wirelessly transmits the RF signals (e.g., through an antenna). In some instances, the radio subsystem in modem 112 wirelessly receives RF signals (e.g., through an antenna), down-converts the RF to baseband signals, and sends the baseband signals to the baseband subsystem. The signals exchanged between the radio subsystem and the baseband subsystem may be digital or analog signals. In some examples, the baseband subsystem includes conversion circuitry (e.g., a digital-to-analog converter, an analog-to-digital converter) and exchanges analog signals with the radio subsystem. In some examples, the radio subsystem includes conversion circuitry (e.g., a digital-to-analog converter, an analog-to-digital converter) and exchanges digital signals with the baseband subsystem.

In some cases, the baseband subsystem of modem 112 can communicate wireless network traffic (e.g., data packets) in the wireless communication network through the radio subsystem on one or more network traffic channels. The baseband subsystem of modem 112 may also transmit or receive (or both) signals (e.g., motion probe signals or motion detection signals) through the radio subsystem on a dedicated wireless communication channel. In some instances, the baseband subsystem generates motion probe signals for transmission, for example, to probe a space for motion. In some instances, the baseband subsystem processes received motion detection signals (signals based on motion probe signals transmitted through the space), for example, to detect motion of an object in a space.

Processor 114 can execute instructions, for example, to generate output data based on data inputs. The instructions can include programs, codes, scripts, or other types of data stored in memory. Additionally, or alternatively, the instructions can be encoded as pre-programmed or re-programmable logic circuits, logic gates, or other types of hardware or firmware components. Processor 114 may be or include a general-purpose microprocessor, as a specialized co-processor or another type of data processing apparatus. In some cases, processor 114 performs high level operation of the wireless communication device 102C. For example, processor 114 may be configured to execute or interpret software, scripts, programs, functions, executables, or other instructions stored in memory 116. In some implementations, processor 114 may be included in modem 112.

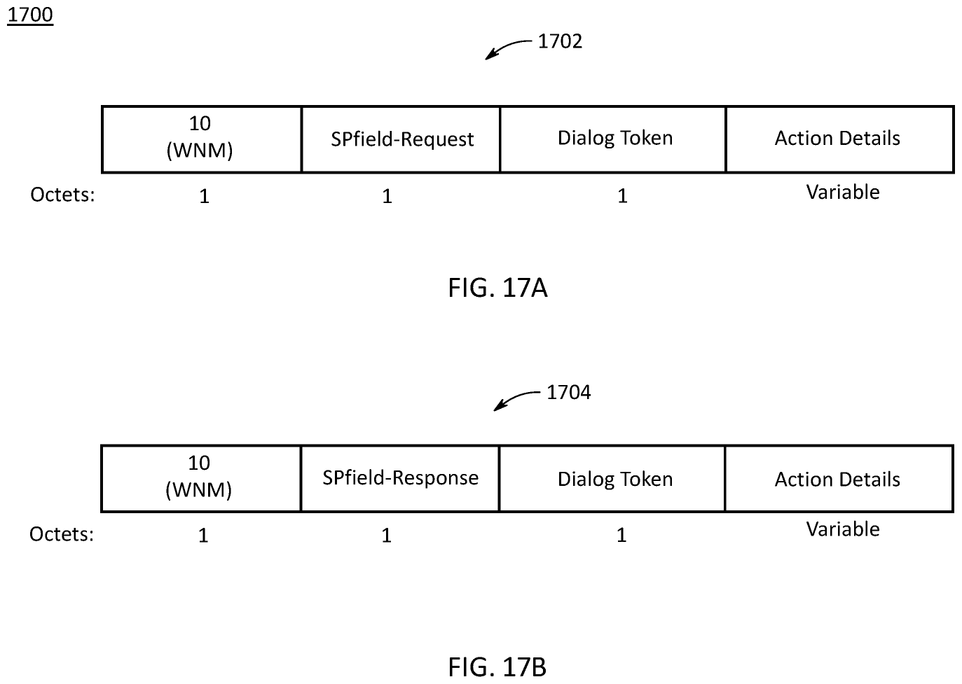

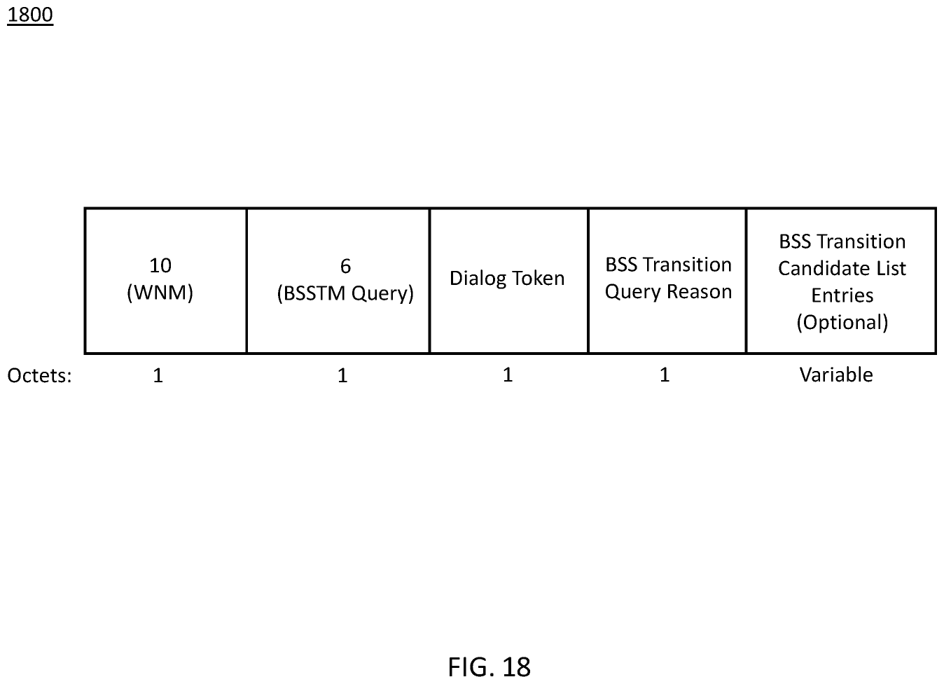

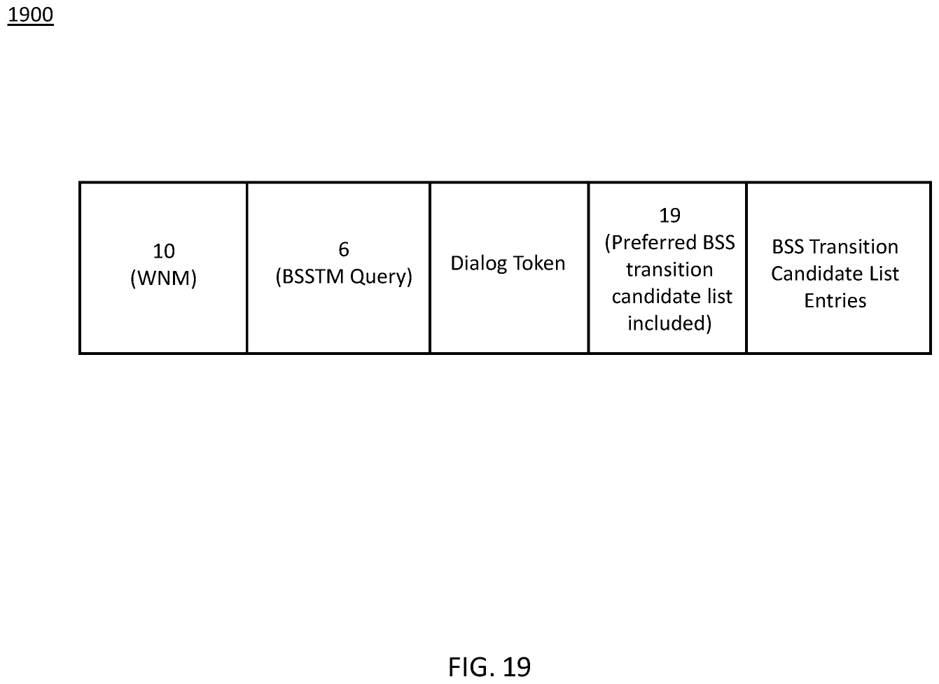

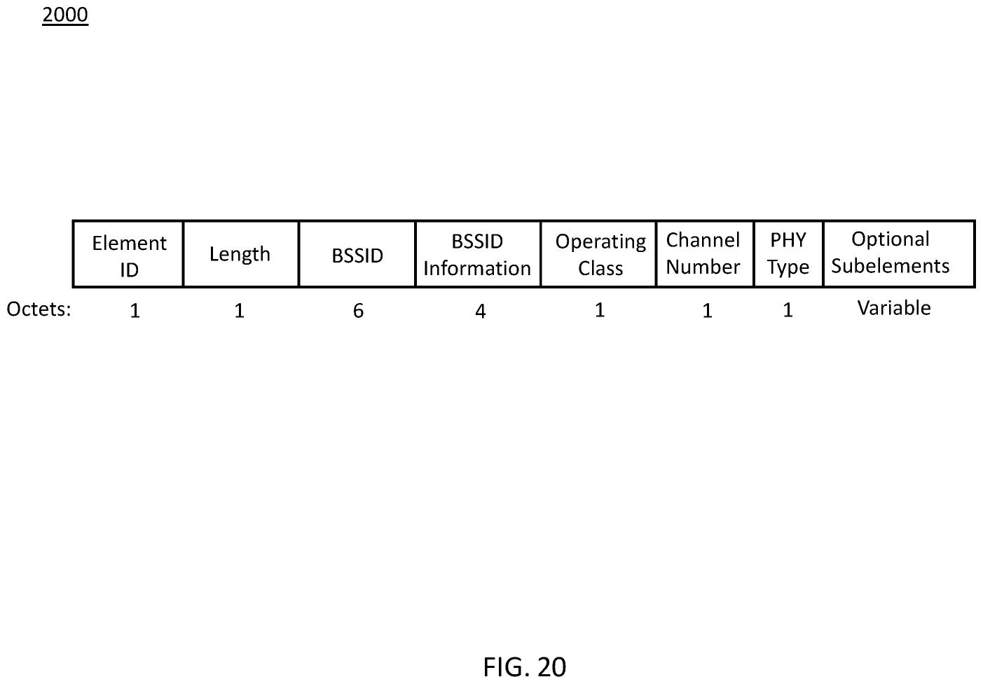

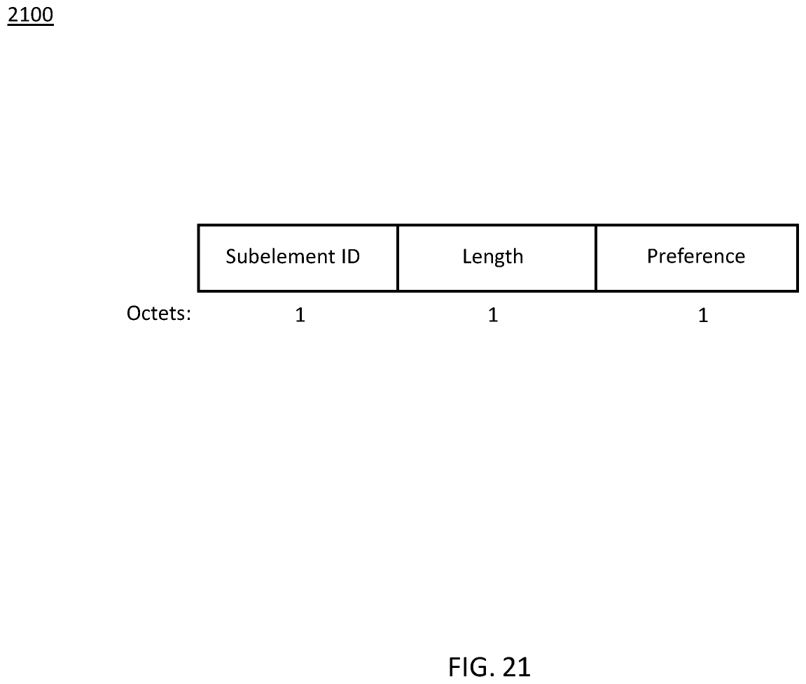

Memory 116 can include computer-readable storage media, for example, a volatile memory device, a non-volatile memory device, or both. Memory 116 can include one or more read-only memory devices, random-access memory devices, buffer memory devices, or a combination of these and other types of memory devices. In some instances, one or more components of the memory can be integrated or otherwise associated with another component of wireless communication device 102C. Memory 116 may store instructions that are executable by processor 114. For example, the instructions may include instructions for time-aligning signals using an interference buffer and a motion detection buffer, such as through one or more of the operations of the example processes of FIG. 17, FIG. 18A, FIG. 18B, FIG. 19A, FIG. 19B, FIG. 20A, FIG. 20B, FIG. 21A, and FIG. 21B. Power unit 118 provides power to the other components of wireless communication device 102C. For example, the other components may operate based on electrical power provided by power unit 118 through a voltage bus or other connection. In some implementations, power unit 118 includes a battery or a battery system, for example, a rechargeable battery. In some implementations, power unit 118 includes an adapter (e.g., an alternating current (AC) adapter) that receives an external power signal (from an external source) and coverts the external power signal to an internal power signal conditioned for a component of wireless communication device 102C. Power unit 118 may include other components or operate in another manner.

In the example shown in FIG. 1, wireless communication devices 102A, 102B transmit wireless signals (e.g., according to a wireless network standard, a motion detection protocol, or otherwise). For instance, wireless communication devices 102A, 102B may broadcast wireless motion probe signals (e.g., reference signals, beacon signals, status signals, etc.), or they may send wireless signals addressed to other devices (e.g., a user equipment, a client device, a server, etc.), and the other devices (not shown) as well as wireless communication device 102C may receive the wireless signals transmitted by wireless communication devices 102A, 102B. In some cases, the wireless signals transmitted by wireless communication devices 102A, 102B are repeated periodically, for example, according to a wireless communication standard or otherwise.

In the example shown, wireless communication device 102C processes the wireless signals from wireless communication devices 102A, 102B to detect motion of an object in a space accessed by the wireless signals, to determine a location of the detected motion, or both. For example, wireless communication device 102C may perform one or more operations of the example processes described below with respect to FIG. 17, FIG. 18A, FIG. 18B, FIG. 19A, FIG. 19B, FIG. 20A, FIG. 20B, FIG. 21A, and FIG. 21B, or another type of process for detecting motion or determining a location of detected motion. The space accessed by the wireless signals can be an indoor or outdoor space, which may include, for example, one or more fully or partially enclosed areas, an open area without enclosure, etc. The space can be or can include an interior of a room, multiple rooms, a building, or the like. In some cases, the wireless communication system 100 can be modified, for instance, such that wireless communication device 102C can transmit wireless signals and wireless communication devices 102A, 102B can processes the wireless signals from wireless communication device 102C to detect motion or determine a location of detected motion.

The wireless signals used for motion detection can include, for example, a beacon signal (e.g., Bluetooth Beacons, Wi-Fi Beacons, other wireless beacon signals), another standard signal generated for other purposes according to a wireless network standard, or non-standard signals (e.g., random signals, reference signals, etc.) generated for motion detection or other purposes. In examples, motion detection may be carried out by analyzing one or more training fields carried by the wireless signals or by analyzing other data carried by the signal. In some examples data will be added for the express purpose of motion detection or the data used will nominally be for another purpose and reused or repurposed for motion detection. In some examples, the wireless signals propagate through an object (e.g., a wall) before or after interacting with a moving object, which may allow the moving object's movement to be detected without an optical line-of-sight between the moving object and the transmission or receiving hardware. Based on the received signals, wireless communication device 102C may generate motion detection data. In some instances, wireless communication device 102C may communicate the motion detection data to another device or system, such as a security system, which may include a control center for monitoring movement within a space, such as a room, building, outdoor area, etc.

In some implementations, wireless communication devices 102A, 102B can be modified to transmit motion probe signals (which may include, e.g., a reference signal, beacon signal, or another signal used to probe a space for motion) on a separate wireless communication channel (e.g., a frequency channel or coded channel) from wireless network traffic signals. For example, the modulation applied to the payload of a motion probe signal and the type of data or data structure in the payload may be known by wireless communication device 102C, which may reduce the amount of processing that wireless communication device 102C performs for motion sensing. The header may include additional information such as, for example, an indication of whether motion was detected by another device in communication system 100, an indication of the modulation type, an identification of the device transmitting the signal, etc.

In the example shown in FIG. 1, wireless communication system 100 is a wireless mesh network, with wireless communication links between each of wireless communication devices 102. In the example shown, the wireless communication link between wireless communication device 102C and wireless communication device 102A can be used to probe motion detection field 110A, the wireless communication link between wireless communication device 102C and wireless communication device 102B can be used to probe motion detection field 110B, and the wireless communication link between wireless communication device 102A and wireless communication device 102B can be used to probe motion detection field 110C. In some instances, each wireless communication device 102 detects motion in motion detection fields 110 accessed by that device by processing received signals that are based on wireless signals transmitted by wireless communication devices 102 through motion detection fields 110. For example, when person 106 shown in FIG. 1 moves in motion detection field 110A and motion detection field 110C, wireless communication devices 102 may detect the motion based on signals they received that are based on wireless signals transmitted through respective motion detection fields 110. For instance, wireless communication device 102A can detect motion of person 106 in motion detection fields 110A, 110C, wireless communication device 102B can detect motion of person 106 in motion detection field 110C, and wireless communication device 102C can detect motion of person 106 in motion detection field 110A.

In some instances, motion detection fields 110 can include, for example, air, solid materials, liquids, or another medium through which wireless electromagnetic signals may propagate. In the example shown in FIG. 1, motion detection field 110A provides a wireless communication channel between wireless communication device 102A and wireless communication device 102C, motion detection field 110B provides a wireless communication channel between wireless communication device 102B and wireless communication device 102C, and motion detection field 110C provides a wireless communication channel between wireless communication device 102A and wireless communication device 102B. In some aspects of operation, wireless signals transmitted on a wireless communication channel (separate from or shared with the wireless communication channel for network traffic) are used to detect movement of an object in a space. The objects can be any type of static or moveable object and can be living or inanimate. For example, the object can be a human (e.g., person 106 shown in FIG. 1), an animal, an inorganic object, or another device, apparatus, or assembly, an object that defines all or part of the boundary of a space (e.g., a wall, door, window, etc.), or another type of object. In some implementations, motion information from the wireless communication devices may be analyzed to determine a location of the detected motion. For example, as described further below, one of wireless communication devices 102 (or another device communicably coupled to wireless communications devices 102) may determine that the detected motion is nearby a particular wireless communication device.

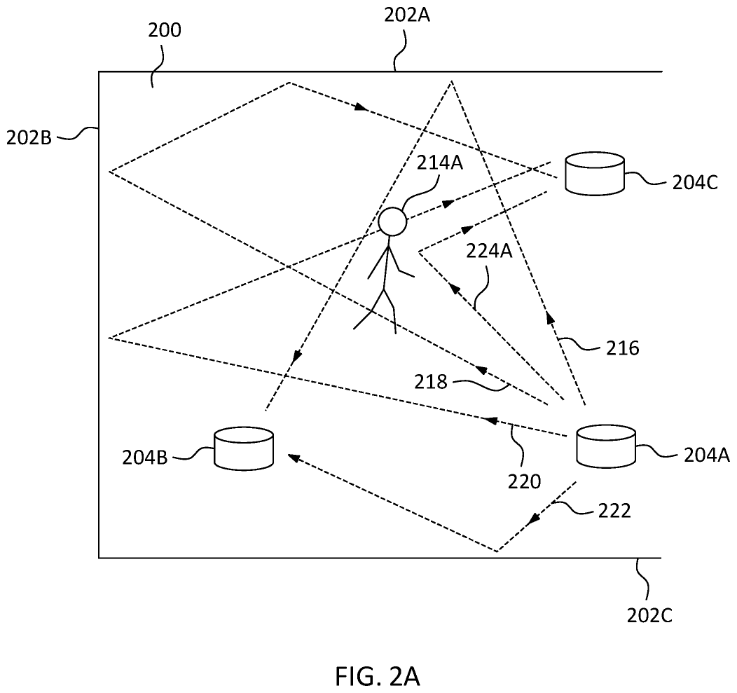

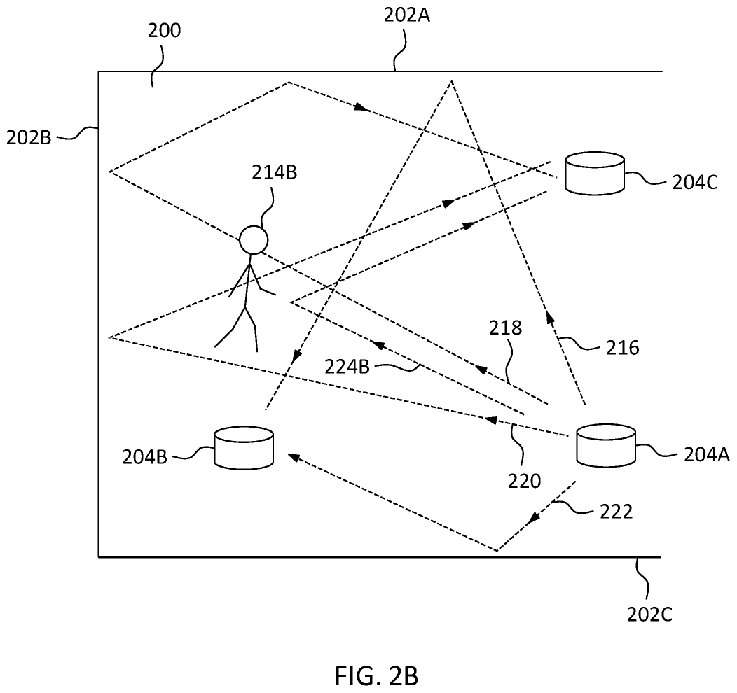

FIG. 2A and FIG. 2B are diagrams showing example wireless signals communicated between wireless communication devices 204A, 204B, 204C. Wireless communication devices 204A, 204B, 204C can be, for example, wireless communication devices 102A, 102B, 102C shown in FIG. 1, or other types of wireless communication devices. Wireless communication devices 204A, 204B, 204C transmit wireless signals through space 200. Space 200 can be completely or partially enclosed or open at one or more boundaries. In an example, space 200 may be a sensing space. Space 200 can be or can include an interior of a room, multiple rooms, a building, an indoor area, outdoor area, or the like. First wall 202A, second wall 202B, and third wall 202C at least partially enclose space 200 in the example shown.

In the example shown in FIG. 2A and FIG. 2B, wireless communication device 204A is operable to transmit wireless signals repeatedly (e.g., periodically, intermittently, at scheduled, unscheduled or random intervals, etc.). Wireless communication devices 204B, 204C are operable to receive signals based on those transmitted by wireless communication device 204A. Wireless communication devices 204B, 204C each have a modem (e.g., modem 112 shown in FIG. 1) that is configured to process received signals to detect motion of an object in space 200.

As shown, an object is in first position 214A in FIG. 2A, and the object has moved to second position 214B in FIG. 2B. In FIG. 2A and FIG. 2B, the moving object in space 200 is represented as a human, but the moving object can be another type of object. For example, the moving object can be an animal, an inorganic object (e.g., a system, device, apparatus, or assembly), an object that defines all or part of the boundary of space 200 (e.g., a wall, door, window, etc.), or another type of object.

As shown in FIG. 2A and FIG. 2B, multiple example paths of the wireless signals transmitted from wireless communication device 204A are illustrated by dashed lines. Along first signal path 216, the wireless signal is transmitted from wireless communication device 204A and reflected off first wall 202A toward the wireless communication device 204B. Along second signal path 218, the wireless signal is transmitted from the wireless communication device 204A and reflected off second wall 202B and first wall 202A toward wireless communication device 204C. Along third signal path 220, the wireless signal is transmitted from the wireless communication device 204A and reflected off second wall 202B toward wireless communication device 204C. Along fourth signal path 222, the wireless signal is transmitted from the wireless communication device 204A and reflected off third wall 202C toward the wireless communication device 204B.

In FIG. 2A, along fifth signal path 224A, the wireless signal is transmitted from wireless communication device 204A and reflected off the object at first position 214A toward wireless communication device 204C. Between FIG. 2A and FIG. 2B, a surface of the object moves from first position 214A to second position 214B in space 200 (e.g., some distance away from first position 214A). In FIG. 2B, along sixth signal path 224B, the wireless signal is transmitted from wireless communication device 204A and reflected off the object at second position 214B toward wireless communication device 204C. Sixth signal path 224B depicted in FIG. 2B is longer than fifth signal path 224A depicted in FIG. 2A due to the movement of the object from first position 214A to second position 214B. In some examples, a signal path can be added, removed, or otherwise modified due to movement of an object in a space.

The example wireless signals shown in FIG. 2A and FIG. 2B may experience attenuation, frequency shifts, phase shifts, or other effects through their respective paths and may have portions that propagate in another direction, for example, through the first, second and third walls 202A, 202B, and 202C. In some examples, the wireless signals are radio frequency (RF) signals. The wireless signals may include other types of signals.

In the example shown in FIG. 2A and FIG. 2B, wireless communication device 204A can repeatedly transmit a wireless signal. In particular, FIG. 2A shows the wireless signal being transmitted from wireless communication device 204A at a first time, and FIG. 2B shows the same wireless signal being transmitted from wireless communication device 204A at a second, later time. The transmitted signal can be transmitted continuously, periodically, at random or intermittent times or the like, or a combination thereof. The transmitted signal can have a number of frequency components in a frequency bandwidth. The transmitted signal can be transmitted from wireless communication device 204A in an omnidirectional manner, in a directional manner or otherwise. In the example shown, the wireless signals traverse multiple respective paths in space 200, and the signal along each path may become attenuated due to path losses, scattering, reflection, or the like and may have a phase or frequency offset.

As shown in FIG. 2A and FIG. 2B, the signals from first to sixth paths 216, 218, 220, 222, 224A, and 224B combine at wireless communication device 204C and wireless communication device 204B to form received signals. Because of the effects of the multiple paths in space 200 on the transmitted signal, space 200 may be represented as a transfer function (e.g., a filter) in which the transmitted signal is input and the received signal is output. When an object moves in space 200, the attenuation or phase offset affected upon a signal in a signal path can change, and hence, the transfer function of space 200 can change. Assuming the same wireless signal is transmitted from wireless communication device 204A, if the transfer function of space 200 changes, the output of that transfer function—the received signal—will also change. A change in the received signal can be used to detect movement of an object.

Mathematically, a transmitted signal f(t) transmitted from the first wireless communication device 204A may be described according to Equation (1):

$$f ( t ) = {\sum }_{n = - ∞}^{∞} {c}_{n} {e}^{j {ω}_{n} t} \qquad ( 1 )$$

Where ωₙ represents the frequency of nth frequency component of the transmitted signal, cₙ represents the complex coefficient of the nth frequency component, and t represents time. With the f(t) being transmitted from the first wireless communication device 204A, an output signal rₖ(t) from a path, k, may be described according to Equation (2):

$${r}_{k} ( t ) = {\sum }_{n = - ∞}^{∞} {α}_{n , k} {c}_{n} {e}^{j ( {ω}_{n} t + {ϕ}_{n , k} )} \qquad ( 2 )$$

Where α_{n,k} represents an attenuation factor (or channel response; e.g., due to scattering, reflection, and path losses) for the nth frequency component along k, and ϕ_{n,k} represents the phase of the signal for nth frequency component along k. Then, the received signal, R, at a wireless communication device can be described as the summation of all output signals rₖ(t) from all paths to the wireless communication device, which is shown in Equation (3):

$$R = {\sum }_{k} {r}_{k} ( t ) \qquad ( 3 )$$

Substituting Equation (2) into Equation (3) renders the following Equation (4):

$$R = {\sum }_{k} {\sum }_{n = - ∞}^{∞} ( {α}_{n , k} {e}^{j {ϕ}_{n , k}} ) {c}_{n} {e}^{j {ω}_{n} t} \qquad ( 4 )$$

R at a wireless communication device can then be analyzed. R at a wireless communication device can be transformed to the frequency domain, for example, using a fast Fourier transform (FFT) or another type of algorithm. The transformed signal can represent R as a series of n complex values, one for each of the respective frequency components (at the n frequencies ωₙ). For a frequency component at frequency ωₙ, a complex value, Hₙ, may be represented as follows in Equation (5):

$${H}_{n} = {\sum }_{k} {c}_{n} {α}_{n , k} {e}^{j {ϕ}_{n , k}} \qquad ( 5 )$$

Hₙ for a given ωₙ indicates a relative magnitude and phase offset of the received signal at ωₙ. When an object moves in the space, Hₙ changes due to α_{n,k} of the space changing. Accordingly, a change detected in the channel response can be indicative of movement of an object within the communication channel. In some instances, noise, interference, or other phenomena can influence the channel response detected by the receiver, and the motion detection system can reduce or isolate such influences to improve the accuracy and quality of motion detection capabilities. In some implementations, the overall channel response can be represented as follows in Equation (6):

$${h}_{ch} = {\sum }_{k} {\sum }_{n = - ∞}^{∞} {α}_{n , k} \qquad ( 6 )$$

In some instances, the channel response, h_{ch}, for a space can be determined, for example, based on the mathematical theory of estimation. For instance, a reference signal, R_{ef}, can be modified with candidate h_{ch}, and then a maximum likelihood approach can be used to select the candidate channel which gives best match to the received signal (R_{cvd}). In some cases, an estimated received signal (\hat{R}_{cvd}) is obtained from the convolution of R_{ef} with the candidate h_{ch}, and then the channel coefficients of h_{ch} are varied to minimize the squared error of \hat{R}_{cvd}. This can be mathematically illustrated as follows in Equation (7):

$${R}_{cvd} = {R}_{ef} ⊗ {h}_{ch} = {\sum }_{k = - m}^{m} {R}_{ef} ( n - k ) {h}_{ch} ( k ) \qquad ( 7 )$$

with the optimization criterion

$${min}_{{h}_{ch}} \{ \sum {( {\hat{R}}_{cvd} - {R}_{cvd} )}^{2} \}$$

The minimizing, or optimizing, process can utilize an adaptive filtering technique, such as least mean squares (LMS), recursive least squares (RLS), batch least squares (BLS), etc. The channel response can be a finite impulse response (FIR) filter, infinite impulse response (IIR) filter, or the like. As shown in the equation above, the received signal can be considered as a convolution of the reference signal and the channel response. The convolution operation means that the channel coefficients possess a degree of correlation with each of the delayed replicas of the reference signal. The convolution operation as shown in the equation above, therefore shows that the received signal appears at different delay points, each delayed replica being weighted by the channel coefficient.

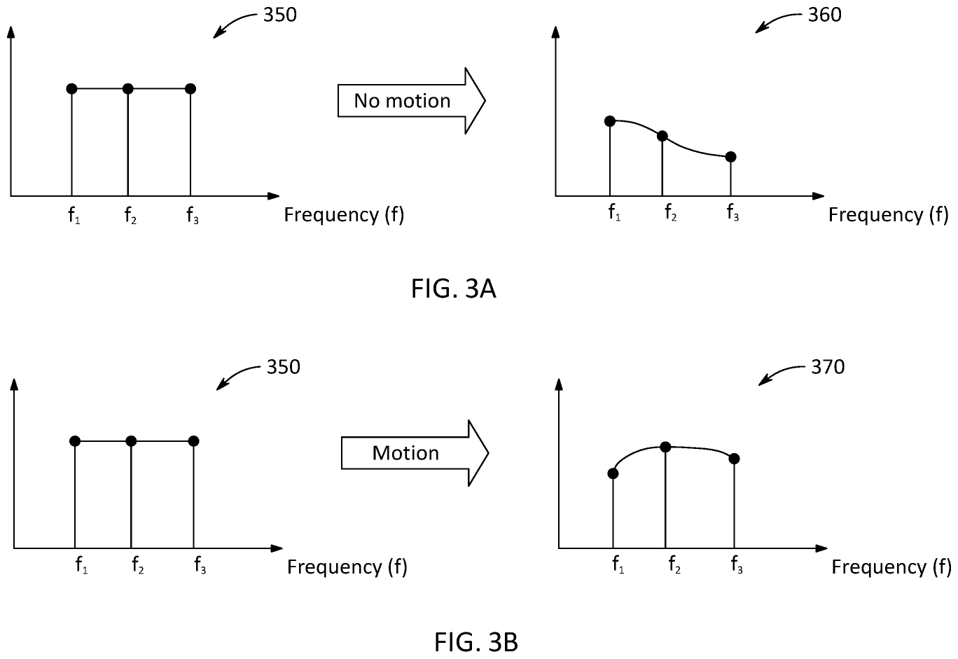

FIG. 3A and FIG. 3B are plots showing examples of channel responses 360, 370 computed from the wireless signals communicated between wireless communication devices 204A, 204B, 204C in FIG. 2A and FIG. 2B. FIG. 3A and FIG. 3B also show frequency domain representation 350 of an initial wireless signal transmitted by wireless communication device 204A. In the examples shown, channel response 360 in FIG. 3A represents the signals received by wireless communication device 204B when there is no motion in space 200, and channel response 370 in FIG. 3B represents the signals received by wireless communication device 204B in FIG. 2B after the object has moved in space 200.

In the example shown in FIG. 3A and FIG. 3B, for illustration purposes, wireless communication device 204A transmits a signal that has a flat frequency profile (the magnitude of each frequency component, f₁, f₂ and f₃ is the same), as shown in frequency domain representation 350. Because of the interaction of the signal with space 200 (and the objects therein), the signals received at wireless communication device 204B that are based on the signal sent from wireless communication device 204A are different from the transmitted signal. In this example, where the transmitted signal has a flat frequency profile, the received signal represents the channel response of space 200. As shown in FIG. 3A and FIG. 3B, channel responses 360, 370 are different from frequency domain representation 350 of the transmitted signal. When motion occurs in space 200, a variation in the channel response will also occur. For example, as shown in FIG. 3B, channel response 370 that is associated with motion of object in space 200 varies from channel response 360 that is associated with no motion in space 200.

Furthermore, as an object moves within space 200, the channel response may vary from channel response 370. In some cases, space 200 can be divided into distinct regions and the channel responses associated with each region may share one or more characteristics (e.g., shape), as described below. Thus, motion of an object within different distinct regions can be distinguished, and the location of detected motion can be determined based on an analysis of channel responses.

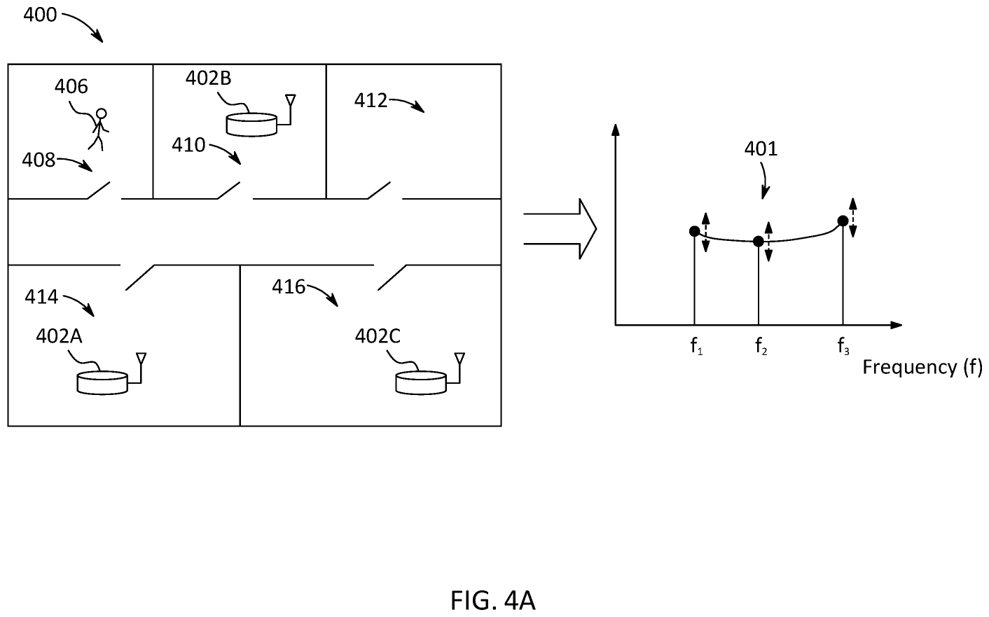

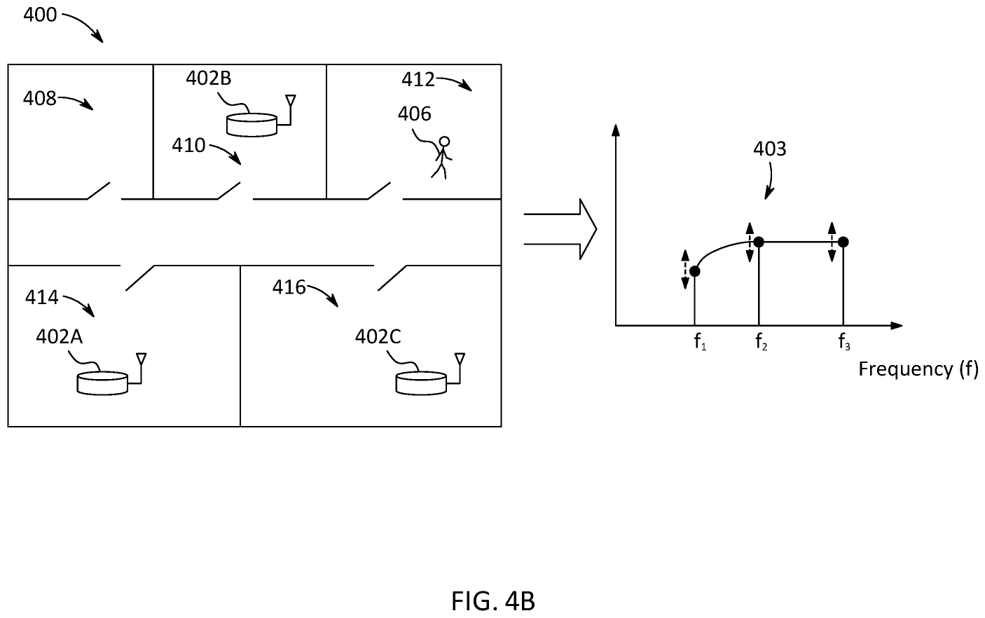

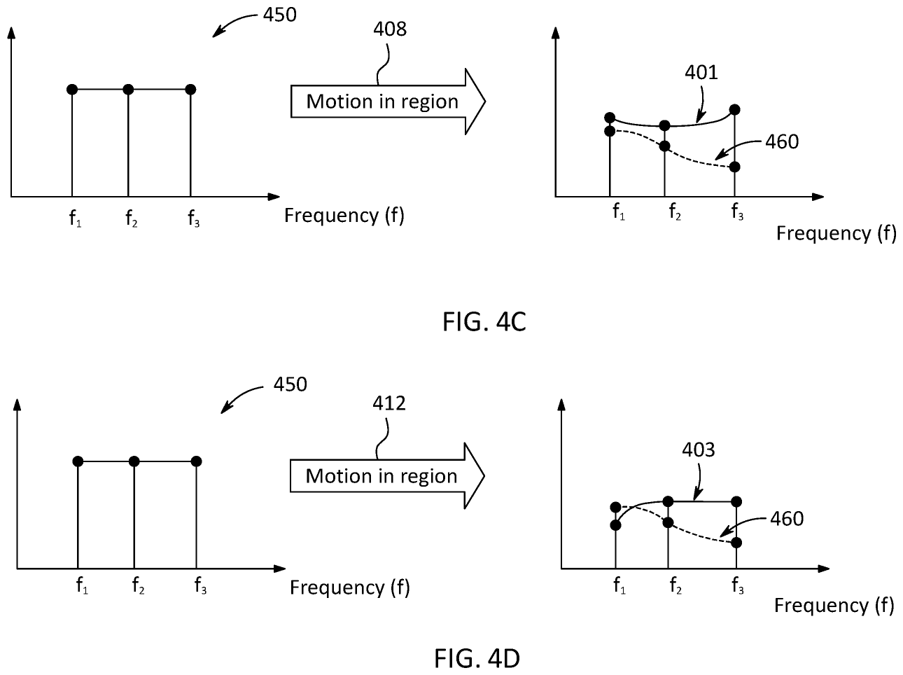

FIG. 4A and FIG. 4B are diagrams showing example channel responses 401, 403 associated with motion of object 406 in distinct regions 408, 412 of space 400. In the examples shown, space 400 is a building, and space 400 is divided into a plurality of distinct regions-first region 408, second region 410, third region 412, fourth region 414, and fifth region 416. Space 400 may include additional or fewer regions, in some instances. As shown in FIG. 4A and FIG. 4B, the regions within space 400 may be defined by walls between rooms. In addition, the regions may be defined by ceilings between floors of a building. For example, space 400 may include additional floors with additional rooms. In addition, in some instances, the plurality of regions of a space can be or include a number of floors in a multistory building, a number of rooms in the building, or a number of rooms on a particular floor of the building. In the example shown in FIG. 4A, an object located in first region 408 is represented as person 406, but the moving object can be another type of object, such as an animal or an inorganic object.

In the example shown, wireless communication device 402A is located in fourth region 414 of space 400, wireless communication device 402B is located in second region 410 of space 400, and wireless communication device 402C is located in fifth region 416 of space 400. Wireless communication devices 402 can operate in the same or similar manner as wireless communication devices 102 of FIG. 1. For instance, wireless communication devices 402 may be configured to transmit and receive wireless signals and detect whether motion has occurred in space 400 based on the received signals. As an example, wireless communication devices 402 may periodically or repeatedly transmit motion probe signals through space 400, and receive signals based on the motion probe signals. Wireless communication devices 402 can analyze the received signals to detect whether an object has moved in space 400, such as, for example, by analyzing channel responses associated with space 400 based on the received signals. In addition, in some implementations, wireless communication devices 402 can analyze the received signals to identify a location of detected motion within space 400. For example, wireless communication devices 402 can analyze characteristics of the channel response to determine whether the channel responses share the same or similar characteristics to channel responses known to be associated with first to fifth regions 408, 410, 412, 414, 416 of space 400.

In the examples shown, one (or more) of wireless communication devices 402 repeatedly transmits a motion probe signal (e.g., a reference signal) through space 400. The motion probe signals may have a flat frequency profile in some instances, wherein the magnitude of f₁, f₂ and f₃ is the same or nearly the same. For example, the motion probe signals may have a frequency response similar to frequency domain representation 350 shown in FIG. 3A and FIG. 3B. The motion probe signals may have a different frequency profile in some instances. Because of the interaction of the reference signal with space 400 (and the objects therein), the signals received at another wireless communication device 402 that are based on the motion probe signal transmitted from the other wireless communication device 402 are different from the transmitted reference signal.

Based on the received signals, wireless communication devices 402 can determine a channel response for space 400. When motion occurs in distinct regions within the space, distinct characteristics may be seen in the channel responses. For example, while the channel responses may differ slightly for motion within the same region of space 400, the channel responses associated with motion in distinct regions may generally share the same shape or other characteristics. For instance, channel response 401 of FIG. 4A represents an example channel response associated with motion of object 406 in first region 408 of space 400, while channel response 403 of FIG. 4B represents an example channel response associated with motion of object 406 in third region 412 of space 400. Channel responses 401, 403 are associated with signals received by the same wireless communication device 402 in space 400.

FIG. 4C and FIG. 4D are plots showing channel responses 401, 403 of FIG. 4A and FIG. 4B overlaid on channel response 460 associated with no motion occurring in space 400. In the example shown, wireless communication device 402 transmits a motion probe signal that has a flat frequency profile as shown in frequency domain representation 450. When motion occurs in space 400, a variation in the channel response will occur relative to channel response 460 associated with no motion, and thus, motion of an object in space 400 can be detected by analyzing variations in the channel responses. In addition, a relative location of the detected motion within space 400 can be identified. For example, the shape of channel responses associated with motion can be compared with reference information (e.g., using a trained artificial intelligence (AI) model) to categorize the motion as having occurred within a distinct region of space 400.

When there is no motion in space 400 (e.g., when object 406 is not present), wireless communication device 402 may compute channel response 460 associated with no motion. Slight variations may occur in the channel response due to a number of factors; however, multiple channel responses 460 associated with different periods of time may share one or more characteristics. In the example shown, channel response 460 associated with no motion has a decreasing frequency profile (the magnitude of each of f₁, f₂ and f₃ is less than the previous). The profile of channel response 460 may differ in some instances (e.g., based on different room layouts or placement of wireless communication devices 402).

When motion occurs in space 400, a variation in the channel response will occur. For instance, in the examples shown in FIG. 4C and FIG. 4D, channel response 401 associated with motion of object 406 in first region 408 differs from channel response 460 associated with no motion and channel response 403 associated with motion of object 406 in third region 412 differs from channel response 460 associated with no motion. Channel response 401 has a concave-parabolic frequency profile (the magnitude of the middle frequency component, f₂, is less than the outer frequency components f₁ and f₃), while channel response 403 has a convex-asymptotic frequency profile (the magnitude of the middle frequency component f₂ is greater than the outer frequency components, f₁ and f₃). The profiles of channel responses 401, 403 may differ in some instances (e.g., based on different room layouts or placement of the wireless communication devices 402).

Analyzing channel responses may be considered similar to analyzing a digital filter. A channel response may be formed through the reflections of objects in a space as well as reflections created by a moving or static human. When a reflector (e.g., a human) moves, it changes the channel response. This may translate to a change in equivalent taps of a digital filter, which can be thought of as having poles and zeros (poles amplify the frequency components of a channel response and appear as peaks or high points in the response, while zeros attenuate the frequency components of a channel response and appear as troughs, low points or nulls in the response). A changing digital filter can be characterized by the locations of its peaks and troughs, and a channel response may be characterized similarly by its peaks and troughs. For example, in some implementations, analyzing nulls and peaks in the frequency components of a channel response (e.g., by marking their location on the frequency axis and their magnitude), motion can be detected.

In some implementations, a time series aggregation can be used to detect motion. A time series aggregation may be performed by observing the features of a channel response over a moving window and aggregating the windowed result by using statistical measures (e.g., mean, variance, principal components, etc.). During instances of motion, the characteristic digital-filter features would be displaced in location and flip-flop between some values due to the continuous change in the scattering scene. That is, an equivalent digital filter exhibits a range of values for its peaks and nulls (due to the motion). By looking this range of values, unique profiles (in examples profiles may also be referred to as signatures) may be identified for distinct regions within a space.

In some implementations, an AI model may be used to process data. AI models may be of a variety of types, for example linear regression models, logistic regression models, linear discriminant analysis models, decision tree models, naïve bayes models, K-nearest neighbors models, learning vector quantization models, support vector machines, bagging and random forest models, and deep neural networks. In general, all AI models aim to learn a function which provides the most precise correlation between input values and output values and are trained using historic sets of inputs and outputs that are known to be correlated. In examples, artificial intelligence may also be referred to as machine learning.

In some implementations, the profiles of the channel responses associated with motion in distinct regions of space 400 can be learned. For example, machine learning may be used to categorize channel response characteristics with motion of an object within distinct regions of a space. In some cases, a user associated with wireless communication devices 402 (e.g., an owner or other occupier of space 400) can assist with the learning process. For instance, referring to the examples shown in FIG. 4A and FIG. 4B, the user can move in each of first to fifth regions 408, 410, 412, 414, 416 during a learning phase and may indicate (e.g., through a user interface on a mobile computing device) that he/she is moving in one of the particular regions in space 400. For example, while the user is moving through first region 408 (e.g., as shown in FIG. 4A) the user may indicate on a mobile computing device that he/she is in first region 408 (and may name the region as “bedroom”, “living room”, “kitchen”, or another type of room of a building, as appropriate). Channel responses may be obtained as the user moves through the region, and the channel responses may be “tagged” with the user's indicated location (region). The user may repeat the same process for the other regions of space 400. The term “tagged” as used herein may refer to marking and identifying channel responses with the user's indicated location or any other information.

The tagged channel responses can then be processed (e.g., by machine learning software) to identify unique characteristics of the channel responses associated with motion in the distinct regions. Once identified, the identified unique characteristics may be used to determine a location of detected motion for newly computed channel responses. For example, an AI model may be trained using the tagged channel responses, and once trained, newly computed channel responses can be input to the AI model, and the AI model can output a location of the detected motion. For example, in some cases, mean, range, and absolute values are input to an AI model. In some instances, magnitude and phase of the complex channel response itself may be input as well. These values allow the AI model to design arbitrary front-end filters to pick up the features that are most relevant to making accurate predictions with respect to motion in distinct regions of a space. In some implementations, the AI model is trained by performing a stochastic gradient descent. For instance, channel response variations that are most active during a certain zone may be monitored during the training, and the specific channel variations may be weighted heavily (by training and adapting the weights in the first layer to correlate with those shapes, trends, etc.). The weighted channel variations may be used to create a metric that activates when a user is present in a certain region.

For extracted features like channel response nulls and peaks, a time-series (of the nulls/peaks) may be created using an aggregation within a moving window, taking a snapshot of few features in the past and present, and using that aggregated value as input to the network. Thus, the network, while adapting its weights, will be trying to aggregate values in a certain region to cluster them, which can be done by creating a logistic classifier based decision surfaces. The decision surfaces divide different clusters and subsequent layers can form categories based on a single cluster or a combination of clusters.

In some implementations, an AI model includes two or more layers of inference. The first layer acts as a logistic classifier which can divide different concentration of values into separate clusters, while the second layer combines some of these clusters together to create a category for a distinct region. Additional, subsequent layers can help in extending the distinct regions over more than two categories of clusters. For example, a fully-connected AI model may include an input layer corresponding to the number of features tracked, a middle layer corresponding to the number of effective clusters (through iterating between choices), and a final layer corresponding to different regions. Where complete channel response information is input to the AI model, the first layer may act as a shape filter that can correlate certain shapes. Thus, the first layer may lock to a certain shape, the second layer may generate a measure of variation happening in those shapes, and third and subsequent layers may create a combination of those variations and map them to different regions within the space. The output of different layers may then be combined through a fusing layer.

### B. Wi-Fi Sensing System Example Methods and Apparatus

Section B describes systems and methods that are useful for a wireless sensing system configured to send sensing transmissions and make sensing measurements.

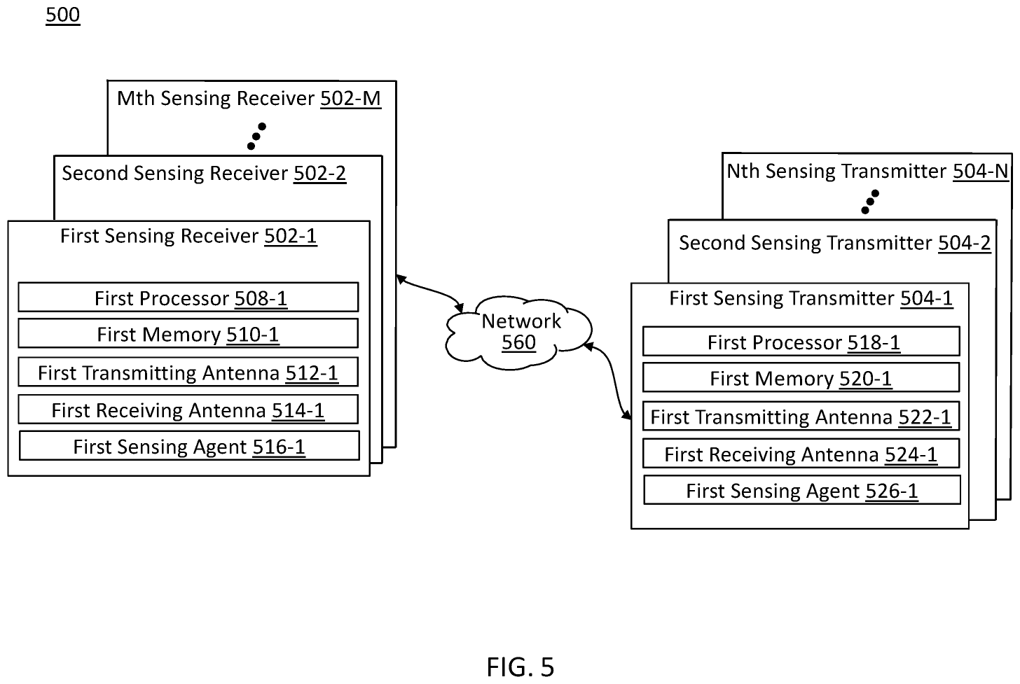

FIG. 5 depicts an implementation of some of an architecture of an implementation of Wi-Fi system 500 for Wi-Fi sensing, according to some embodiments.

Wi-Fi system 500 (also referred to as Wi-Fi sensing system 500) may include a plurality of networked devices. In an implementation, the plurality of networked devices may include plurality of sensing receivers 502-(1-M), plurality of sensing transmitters 504-(1-N), and network 560 enabling communication between the system components for information exchange. Wi-Fi system 500 may be an example or instance of wireless communication system 100, and network 560 may be an example or instance of wireless network or cellular network, details of which are provided with reference to FIG. 1 and its accompanying description.

According to an embodiment, first sensing receiver 502-1 may be configured to receive a sensing transmission (for example, from first sensing transmitter 504-1) and perform one or more measurements (for example, channel state information) useful for Wi-Fi sensing. These measurements may be known as sensing measurements. The sensing measurements may be processed to achieve a sensing result of system 500, such as detecting motions or gestures. In an embodiment, first sensing receiver 502-1 may be an access point (AP). In some embodiments, first sensing receiver 502-1 may be a station (STA). An AP may be a device that provides access to distribution system services via a wireless link for one or more STAs. The AP may have a distribution system access function.

According to an implementation, first sensing receiver 502-1 may be implemented by a device, such as wireless communication device 102 shown in FIG. 1. In some implementations, first sensing receiver 502-1 may be implemented by a device, such as wireless communication device 204 shown in FIG. 2A and FIG. 2B. Further, first sensing receiver 502-1 may be implemented by a device, such as wireless communication device 402 shown in FIG. 4A and FIG. 4B. In some embodiments, first sensing receiver 502-1 may be any computing device, such as a desktop computer, a laptop, a tablet computer, a mobile device, a personal digital assistant (PDA), or any other computing device. According to an implementation, first sensing receiver 502-1 may be enabled to control a measurement campaign to ensure that required sensing transmissions are made at a required time and to ensure an accurate determination of sensing measurements. In some embodiments, first sensing receiver 502-1 may process sensing measurements to achieve the sensing result of system 500.

Referring again to FIG. 5, in some embodiments, first sensing transmitter 504-1 may form a part of a basic service set (BSS) and may be configured to send a sensing transmission to first sensing receiver 502-1 based on which one or more sensing measurements (for example, channel state information) may be performed for Wi-Fi sensing. In an embodiment, first sensing transmitter 504-1 may be a STA. In some embodiments, first sensing transmitter 504-1 may be an AP. According to an implementation, first sensing transmitter 504-1 may be implemented by a device, such as wireless communication device 102 shown in FIG. 1. In some implementations, first sensing transmitter 504-1 may be implemented by a device, such as wireless communication device 204 shown in FIG. 2A and FIG. 2B. Further, first sensing transmitter 504-1 may be implemented by a device, such as wireless communication device 402 shown in FIG. 4A and FIG. 4B. In some embodiments, first sensing transmitter 504-1 may be any computing device, such as a desktop computer, a laptop, a tablet computer, a mobile device, a PDA, or any other computing device. In some implementations, communication between first sensing receiver 502-1 and first sensing transmitter 504-1 may happen via station management entity (SME) and MAC layer management entity (MLME) protocols.

Referring to FIG. 5, in more detail, first sensing receiver 502-1 may include first processor 508-1 and first memory 510-1. For example, first processor 508-1 and first memory 510-1 of first sensing receiver 502-1 may be processor 114 and memory 116, respectively, as shown in FIG. 1. In an embodiment, first sensing receiver 502-1 may further include first transmitting antenna(s) 512-1, first receiving antenna(s) 514-1, and first sensing agent 516-1.

In an implementation, first sensing agent 516-1 may be responsible for receiving sensing transmissions and associated transmission parameters, calculating sensing measurements, and processing sensing measurements to fulfill a sensing result. In some implementations, receiving sensing transmissions and associated transmission parameters, and calculating sensing measurements may be carried out by an algorithm running in the MAC layer of first sensing receiver 502-1 and processing sensing measurements to fulfill a sensing result may be carried out by an algorithm running in the application layer of first sensing receiver 502-1. In some examples, the algorithm running in the application layer of first sensing receiver 502-1 is known as a sensing application or sensing algorithm. In some implementations, the algorithm running in the MAC layer of first sensing receiver 502-1 and the algorithm running in the application layer of first sensing receiver 502-1 may run separately on first processor 508-1. In an implementation, first sensing agent 516-1 may pass physical layer parameters (e.g., such as channel state information) from the MAC layer of first sensing receiver 502-1 to the application layer of first sensing receiver 502-1 and may use the physical layer parameters to detect one or more features of interest. In an example, the application layer may operate on the physical layer parameters and form services or features, which may be presented to an end-user. According to an implementation, communication between the MAC layer of first sensing receiver 502-1 and other layers or components may take place based on communication interfaces, such as MLME interface and a data interface. According to some implementations, first sensing agent 516-1 may include/execute a sensing algorithm. In an implementation, first sensing agent 516-1 may process and analyze sensing measurements using the sensing algorithm and identify one or more features of interest. Further, first sensing agent 516-1 may be configured to determine a number and timing of sensing transmissions and sensing measurements for the purpose of Wi-Fi sensing. In some implementations, first sensing agent 516-1 may be configured to transmit sensing measurements to first sensing transmitter 504-1 for further processing.

In an implementation, first sensing agent 516-1 may be configured to cause at least one transmitting antenna of first transmitting antenna(s) 512-1 to transmit messages to first sensing transmitter 504-1. Further, first sensing agent 516-1 may be configured to receive, via at least one receiving antenna of first receiving antennas(s) 514-1, messages from first sensing transmitter 504-1. In an example, first sensing agent 516-1 may be configured to make sensing measurements based on one or more sensing transmissions received from first sensing transmitter 504-1.

Referring again to FIG. 5, first sensing transmitter 504-1 may include first processor 518-1 and first memory 520-1. For example, first processor 518-1 and first memory 520-1 of first sensing transmitter 504-1 may be processor 114 and memory 116, respectively, as shown in FIG. 1. In an embodiment, first sensing transmitter 504-1 may further include first transmitting antenna(s) 522-1, first receiving antenna(s) 524-1, and first sensing agent 526-1. In an implementation, first sensing agent 526-1 may be a block that passes physical layer parameters from the MAC of first sensing transmitter 504-1 to application layer programs. First sensing agent 526-1 may be configured to cause at least one transmitting antenna of first transmitting antenna(s) 522-1 and at least one receiving antenna of first receiving antennas(s) 524-1 to exchange messages with first sensing receiver 502-1.

In an implementation, first sensing agent 526-1 may be responsible for receiving sensing measurements and associated transmission parameters, calculating sensing measurements, and/or processing sensing measurements to fulfill a sensing result. In some implementations, receiving sensing measurements and associated transmission parameters, and calculating sensing measurements and/or processing sensing measurements may be carried out by an algorithm running in the MAC layer of first sensing transmitter 504-1, and processing sensing measurements to fulfill a sensing result may be carried out by an algorithm running in the application layer of first sensing transmitter 504-1. In some examples, the algorithm running in the application layer of first sensing transmitter 504-1 is known as a sensing application or sensing algorithm. In some implementations, the algorithm running in the MAC layer of first sensing transmitter 504-1 and the algorithm running in the application layer of sensing transmitter 504-1 may run separately on first processor 518-1. In an implementation, first sensing agent 526-1 may pass physical layer parameters (e.g., such as channel state information) from the MAC layer of first sensing transmitter 504-1 to the application layer of first sensing transmitter 504-1 and may use the physical layer parameters to detect one or more features of interest. In an example, the application layer may operate on the physical layer parameters and form services or features, which may be presented to an end-user. According to an implementation, communication between the MAC layer of first sensing transmitter 504-1 and other layers or components may take place based on communication interfaces, such as MLME interface and a data interface. According to some implementations, first sensing agent 526-1 may include/execute a sensing algorithm. In an implementation, first sensing agent 526-1 may process and analyze sensing measurements using the sensing algorithm and identify one or more features of interest. Further, first sensing agent 526-1 may be configured to determine a number and timing of sensing transmissions and sensing measurements for the purpose of Wi-Fi sensing. In an implementation, first sensing agent 526-1 may be configured to receive, via at least one receiving antenna of first receiving antennas(s) 524-1, messages from first sensing receiver 502-1.

In some embodiments, an antenna may be used to both transmit and receive in a half-duplex format. When the antenna is transmitting, it may be referred to as transmitting antenna 512-1/522-1, and when the antenna is receiving, it may be referred to as receiving antenna 514-1/524-1. It is understood by a person of normal skill in the art that the same antenna may be transmitting antenna 512-1/522-1 in some instances and receiving antenna 514-1/524-1 in other instances. In the case of an antenna array, one or more antenna elements may be used to transmit or receive a signal, for example, in a beamforming environment. In some examples, a group of antenna elements used to transmit a composite signal may be referred to as transmitting antenna 512-1/522-1, and a group of antenna elements used to receive a composite signal may be referred to as receiving antenna 514-1/524-1. In some examples, each antenna is equipped with its own transmission and receive paths, which may be alternately switched to connect to the antenna depending on whether the antenna is operating as transmitting antenna 512-1/522-1 or receiving antenna 514-1/524-1.

For ease of explanation and understanding, the description provided above is with reference to first sensing receiver 502-1 and first sensing transmitter 504-1, however, the description is equally applicable to remaining sensing receivers 502-(2-M) and remaining sensing transmitters 504-(2-N).

According to one or more implementations, communications in network 560 may be governed by one or more of the 802.11 family of standards developed by IEEE. Some example IEEE standards may include IEEE 802.11-2020, IEEE 802.11ax-2021, IEEE 802.11me, IEEE 802.11az, and IEEE 802.11be. IEEE 802.11-2020 and IEEE 802.11ax-2021 are fully-ratified standards whilst IEEE 802.11 me reflects an ongoing maintenance update to the IEEE 802.11-2020 standard and IEEE 802.11be defines the next generation of standard. IEEE 802.11az is an extension of the IEEE 802.11-2020 and IEEE 802.11ax-2021 standards, adding new functionality. In some implementations, communications may be governed by other standards (other or additional IEEE standards or other types of standards). In some embodiments, parts of network 560 which are not required by system 500 to be governed by one or more of the 802.11 family of standards may be implemented by an instance of any type of network, including wireless network or cellular network.

In an example, a BSS may include one or more STAs associated with a single AP. Further, an ESS may be created by connecting multiple BSSs together with a backbone network that may be wireless or may be wired (for example, Ethernet). In an example, all APs in an ESS may be given same service set identifier (SSID) that may serve as the network name for users. Each BSS may have a wireless coverage area known as a basic service area (BSA). The BSA of one BSS may include STAs of another BSS, i.e., there may be an overlap of coverage areas of one or more BSSs. An ESS may require that the backbone network provide a specified set of services. In an example, STAs within a same ESS may communicate with each other, even though these STAs may be in different BSSs and may even be moving between the BSSs. A change of association by a STA from one BSS to another BSS in the same ESS may be referred to as BSS transition. Further, a distribution system may be used to interconnect a set of BSSs and integrate local area networks (LANs) to create an ESS.

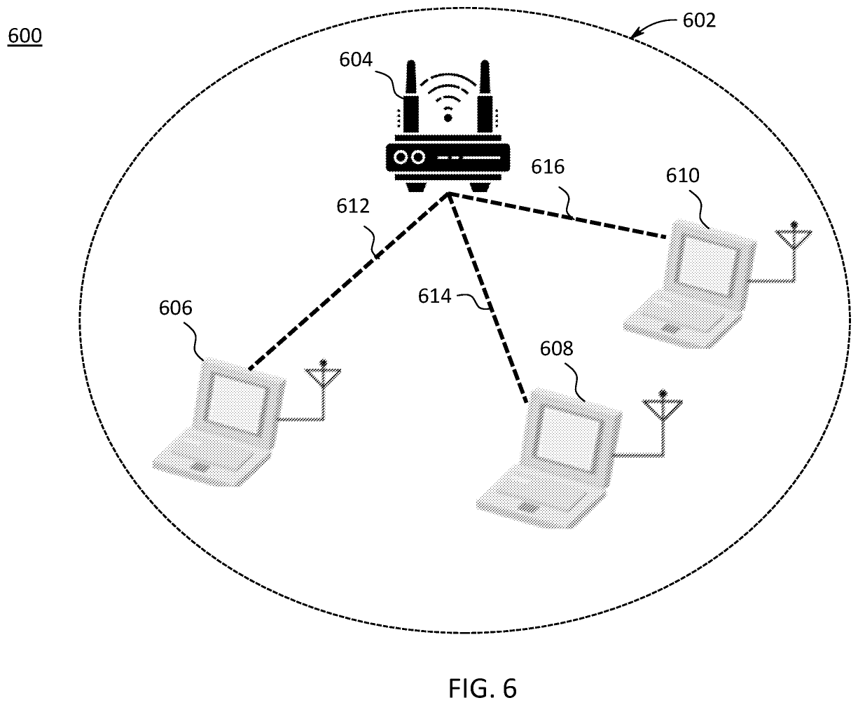

FIG. 6 depicts example representation 600 of BSS 602, according to some embodiments. As described in FIG. 6, BSS 602 includes a single AP and three STAs. In an example, BSS 602 includes AP 604, first STA 606, second STA 608, and third STA 610. Further, communication link 612 used for data communications between AP 604 and first STA 606, communication link 614 used for data communications between AP 604 and second STA 608, and communication link 616 used for data communications between AP 604 and second STA 608 are shown in FIG. 6.

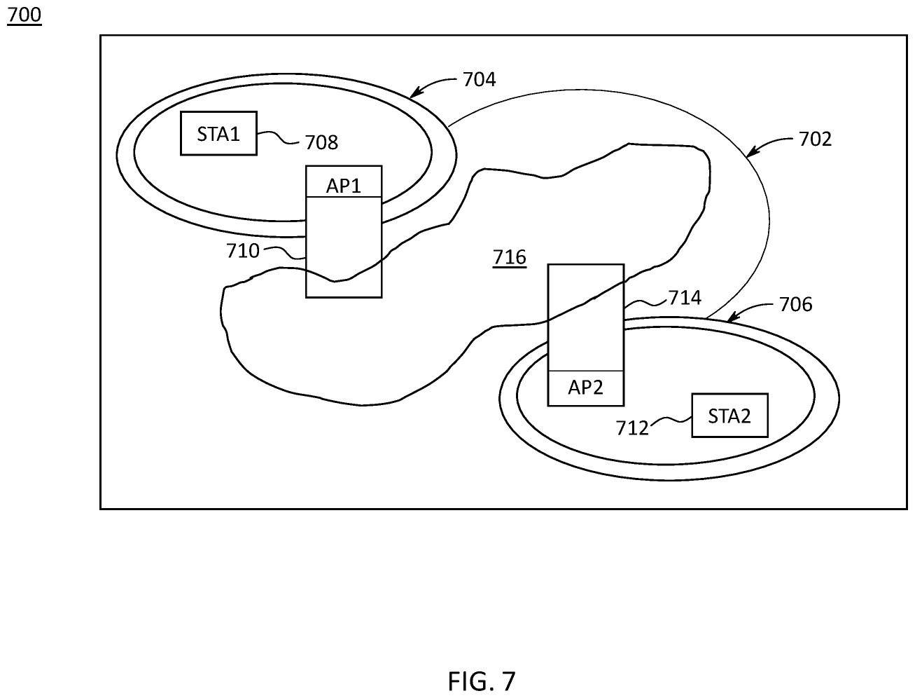

FIG. 7 depicts example representation 700 of ESS 702 created using multiple BSSs, according to some embodiments. FIG. 7 is a reproduction of FIG. 4-3 from Draft 802.11REVmd_D5.0. As described in FIG. 7, ESS 702 may be created by connecting first BSS 704 and second BSS 706. First BSS 704 includes STA1 708 and AP1 710, and second BSS 706 includes STA2 712 and AP2 714. Further, AP1 710 of first BSS 704 and AP2 714 of second BSS 706 may be interconnected using distribution system 716.

In an implementation, 802.11 family of standards developed by IEEE may include three connection states, namely, “not authenticated or associated” state, “authenticated but not yet associated” state, and “authenticated and associated” state. In an example, a STA must be in an “authenticated and associated” state before the STA may send traffic to other devices in a Wi-Fi network. An AP and a STA may exchange a series of 802.11 management frames in order to get to an “authenticated and associated” state.

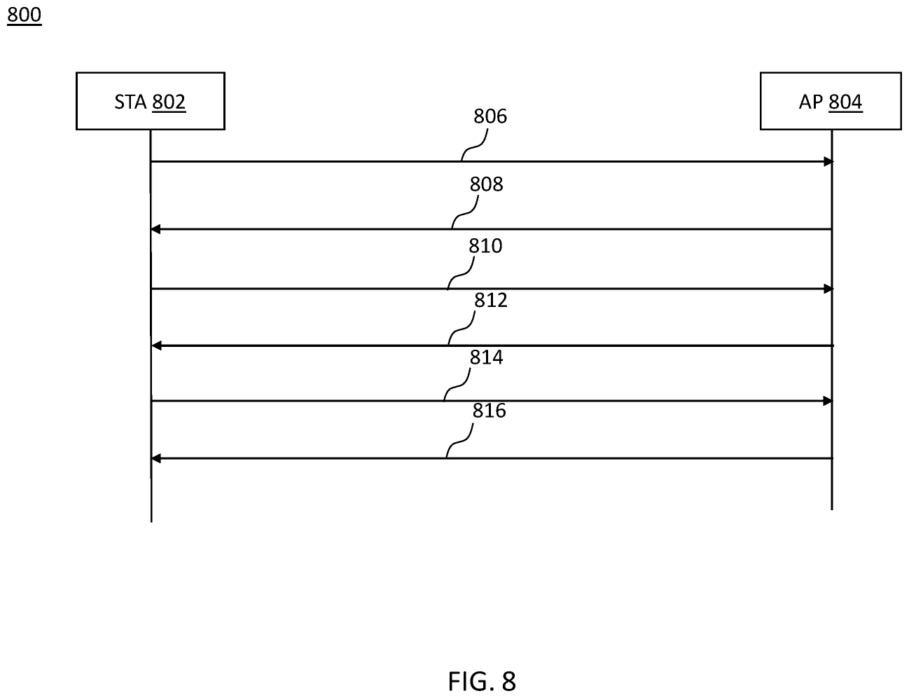

FIG. 8 depicts process 800 of STA 802 authenticating and associating with AP 804. At step 806 of process 800, in some implementations, STA 802 may send IEEE Standard 802.11 probe request to AP 804. At step 808 of process 800, in some implementations, AP 804 may provide IEEE Standard 802.11 probe response to STA 802. In an example, AP 804 may provide security parameters to STA 802. At step 810 of process 800, in some implementations, STA 802 may request IEEE Standard 802.11 Simultaneous Authentication of Equals (SAE) Authentication to AP 804. In an example, STA 802 may transmit SAE Commit message to AP 804. At step 812 of process 800, in some implementations, AP 804 may provide IEEE Standard 802.11 SAE authentication to STA 802. In an example, AP 804 may provide SAE Commit message to STA 802. At step 814 of process 800, in some implementations, STA 802 may provide IEEE Standard 802.11 SAE authentication to AP 804. In an example, STA 802 may provide SAE Confirm message to AP 804. At step 816 of process 800, in some implementations, AP 804 may send IEEE Standard 802.11 SAE Authentication to STA 802. In an example, AP 804 may provide SAE Confirm message to STA 802.

According to an implementation, there may be various reasons for a STA to make a BSS transition and associate with a new BSS (or a different BSS) in an ESS. In an example, the BSS transition may be initiated by a distribution system or by the STA itself. In some examples, due to network coverage or capacity reasons, the STA may be instructed or encouraged by the distribution system to switch to the different BSS in the ESS for load balancing. In an example, load balancing may distribute workload across multiple BSSs in the ESS which have overlapping coverage areas which includes the STA, for example, to achieve optimal utilization, to maximize throughput and minimize response time, and to avoid overloading a single AP. In an example, load balancing of BSSs may be configured as a part of WLAN service profiles. When a new STA arrives at the ESS, the capacity of the BSS that is handling that STA may be compared to the capacity of other BSSs in the ESS by the distribution system. The distribution system may then encourage the STA to associate with a lesser loaded AP. Further, in addition to the distribution system making decisions to move a STA from one BSS to another BSS, the STA itself may make the decision to switch to a different AP. An example of BSS transition may be a mobile phone (that is a STA) that needs to have a network connection with a highest signal strength and unilaterally switches to another AP without taking the overall network loading into account. Further, the distribution system may facilitate the movement of the mobile phone to another BSS to achieve a higher signal strength that may be based on signal strength measurements made by the mobile phone and reported to the network. In an implementation, when a STA moves from a coverage area of a source AP to a coverage area of a destination AP, the STA may inform the network of its new location based on a reassociation process. As a part of the reassociation process, frames that were buffered at the source AP may be moved to the destination AP.

According to an implementation, BSS transition management (described in Section 11.21.7 of Draft 802.11REVmd_D5.0) is a wireless network management (WNM) procedure used for load balancing through transitioning STAs to other points of association within an ESS. According to an embodiments, implementation of BSS transition management may be optional for a WNM STA. In an implementation, BSS transition management may use three action frames to exchange information that is required to enable an AP to inform associated STAs that the BSS will be terminated and to enable a distribution system to manage BSS loads by influencing STA BSS transition decisions. According to an implementation, a STA may send a BSS transition management query frame to its associated AP. The STA may optionally include a BSS transition candidate list entries field in the BSS transition management query frame if the STA needs to provide transition preferences to the AP. In an example, the STA may set BSS transition query reason field of the BSS transition management query frame to a value of 19 to indicate that the candidate list entries field is included. In an example, the BSS transition candidate list entries field may include 0 (zero) or more neighbor report elements for BSS, each of which may have a preference field value that may be set by the STA to a value between 1 and 255, where 255 indicates the most preferred BSS.

In an implementation, an AP may respond to a BSS transition management query frame with a BSS transition management request frame. In an example, at any time, an AP may send an unsolicited BSS transition management request frame to a STA that supports BSS transition management. According to an implementation, the AP may include the BSS transition candidate list entries field in the BSS transition management request frame if the AP has information about the candidate list. In an example, the BSS transition candidate list entries field may include 0 (zero) or more neighbor report elements for BSS, each of which may have a preference field value that describes the preference of the AP for target BSS candidates for the STA. In an example, a preference field value of “0” may indicate that a BSS is excluded, and that the STA should not associate to an AP corresponding to an excluded BSS. According to an implementation, upon receiving a BSS transition management query frame or a BSS transition management response frame from a STA that includes a non-empty BSS transition candidate list entries field, the AP may include at least one BSS candidate from the candidate list with a non-zero preference field value in the BSS transition candidate list entries field of any subsequent BSS transition management request frame. In an implementation, the AP may evaluate the BSSs indicated in the BSS transition candidate list entries field in the latest BSS transition management query frame or BSS transition management response frame received from the STA as BSS transition candidate(s) for the STA. A STA may use the candidate list to make BSS transition decisions. The STA may send a BSS transition management query frame at any time to obtain an updated BSS transition candidate list entries field or to indicate the preferred BSS transition candidates.

According to some implementations, when a STA receives a BSS transition management request frame from an AP that includes preferred candidate list included fields equal to 1 and a non-empty BSS transition candidate list entries field, then the STA may transmit a BSS transition management response frame to the AP with the BSS transition management status code field set to 0 (Accept), following which the STA may disassociate from the AP and may attempt to associate with an AP corresponding to one of the non-excluded BSSs in the BSS transition candidate list entries field of the received BSS transition management request frame. In an implementation, prior to transitioning to an excluded BSS listed in the BSS transition candidate list entries field of a received BSS transition management request frame, or not transitioning from the serving BSS, the non-AP STA may transmit a BSS transition management response frame to the AP indicating a reason for rejection with the BSS transition management status code field set to one of values given in Table 1 provided below. Table 1 is a reproduction of Table 9-428 from Draft P802.11REVmd_D5.0.

TABLE 1
BSS transition management status code field values
for a BSS transition management response frame

| Status code | Status code description |
|---|---|
| 0 | Accept |
| 1 | Reject-Unspecified reject reason. |
| 2 | Reject-Insufficient Beacon or Probe Response frames |
| | received from all candidates. |
| 3 | Reject-Insufficient available capacity from all |
| | candidates. |
| 4 | Reject-BSS termination undesired. |
| 5 | Reject-BSS termination delay requested. |
| 6 | Reject-STA BSS Transition Candidate List provided. |
| 7 | Reject-No suitable BSS transition candidates. |
| 8 | Reject-Leaving ESS. |
| 9-255 | Reserved |

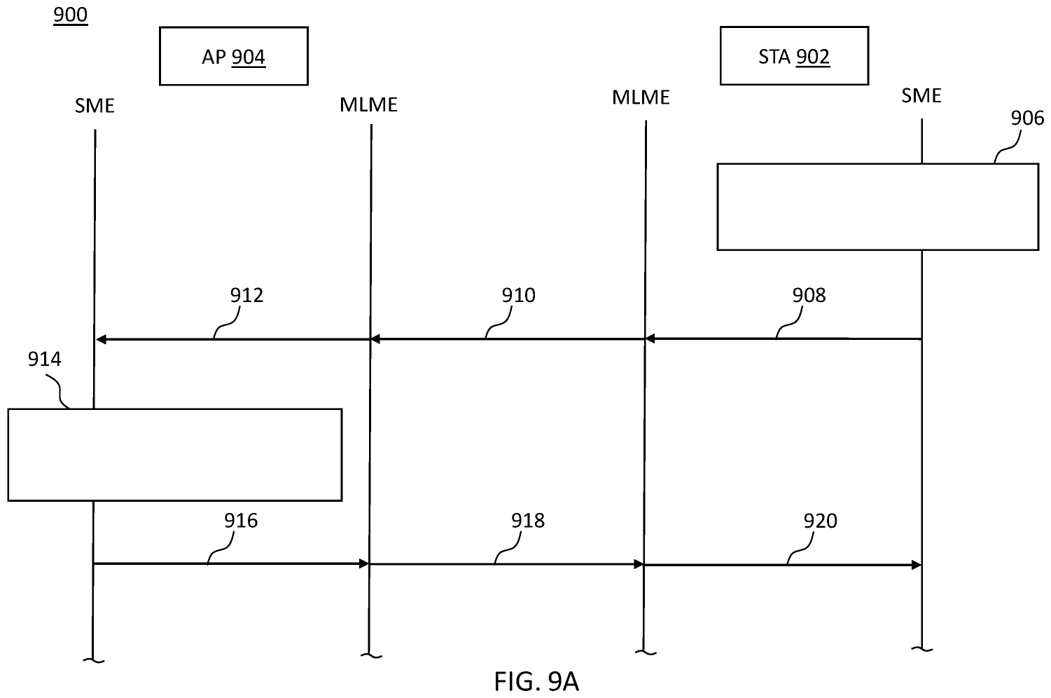

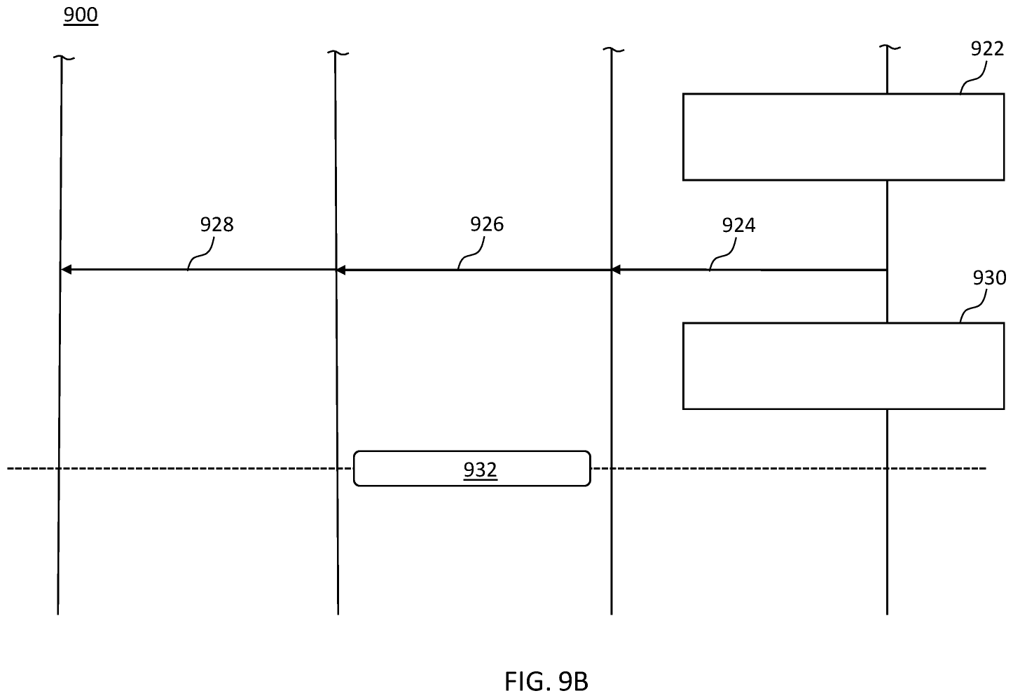

FIG. 9A and FIG. 9B depict process 900 for BSS transition management, according to some embodiments. In particular, FIG. 9A and FIG. 9B depict a scenario where a BSS transition management request is accepted. FIG. 9A and FIG. 9B are reproduction of FIG. 6-18 from Draft 802.11REVmd_D5.0. At step 906 of process 900, in some implementations, Station Management Entity (SME) of STA 902 (which is a non-AP STA) may make a decision to request or provide BSS transition candidate AP list to AP 904. At step 908 of process 900, in some implementations, the SME of STA 902 may send MLME-BTMQUERY.request primitive to MAC layer management entity (MLME) of STA 902. In an implementation, the SME of STA 902 may send the MLME-BTMQUERY.request primitive to the MLME of STA 902 to request that a BSS transition management query frame be sent to AP 904 with which STA 902 is associated to initiate a BSS transition management procedure. At step 910 of process 900, in some implementations, the MLME of STA 902 may transmit a BSS transition management query frame to the MLME of AP 904. At step 912 of process 900, in some implementations, the MLME of AP 904 may transmit MLME-BTMQUERY.indication primitive to SME of AP 904. In an implementation, MLME-BTMQUERY.indication primitive may indicate that a BSS transition management query frame is received from STA 902. At step 914 of process 900, in some implementations, the SME of AP 904 may be triggered by BSS transition query or may make a decision to send autonomous BSS transition request. At step 916 of process 900, in some implementations, the SME of AP 904 may send MLME-BTM.request primitive to the MLME of AP 904. In an implementation, MLME-BTM.request primitive may request that a BSS transition management request frame be sent to STA 902. In an example, MLME-BTM.request primitive may be sent either following the reception of the MLME-BTMQUERY.indication primitive or may be sent autonomously. At step 918 of process 900, in some implementations, the MLME of AP 904 may send BSS transition management request frame to the MLME of STA 902. At step 920 of process 900, in some implementations, the MLME of STA 902 may send MLME-BTM.indication primitive to the SME of STA 902. At step 922 of process 900, in some implementations, the SME of STA 902 may make STA roaming evaluation and decision. At step 924 of process 900, in some implementations, the SME of STA 902 may send MLME-BTM.response primitive to the MLME of STA 902. In an implementation, MLME-BTM.response primitive may indicate a request that a BSS transition management response frame be sent to AP 904. At step 926 of process 900, in some implementations, the MLME of STA 902 may send BSS transition management response frame to the MLME of AP 904. At step 928 of process 900, in some implementations, the MLME of AP 904 may send MLME-BTM.confirm primitive to the SME of AP 904. In an implementation, MLME-BTM.confirm primitive may be generated when transmission of the BSS transition management request frame is acknowledged, (re-)transmission of the BSS transition management request frame fails, the BSS transition management request frame includes invalid parameters, or for unspecified failure reasons. At step 930 of process 900, in some implementations, the SME of STA 902 may make a decision to perform either STA reassociation or fast BSS transition. At step 932 of process 900, in some implementations, STA reassociation may be performed. According to some implementations, steps 910 and 926 may be optional and may not take place.

According to an implementation, fast BSS transition may seek to reduce the time of connection loss between a STA and a distribution system during a BSS transition. In an example, APs capable of fast BSS transition may allow STAs (also referred to as fast transition originators (FTOs)) to request resources prior to reassociation. In an implementation, fast BSS transition protocols may require information to be exchanged during an initial association between a STA and an AP. The initial exchange may be referred to as fast BSS transition (FT) initial mobility domain association. Further, subsequent reassociations to APs within the same mobility domain may make use of two defined fast BSS transition protocols, namely, an FT protocol and an FT resource request protocol. The FT protocol may be executed when an FTO makes a transition to a target AP and does not require a resource request prior to its transition. Further, the FT resource request protocol may be executed when an FTO requires a resource request prior to its transition. In an example, for an FTO to move from a current AP to a target AP utilizing FT protocols, message exchanges may be made over-the-air (i.e., the FTO may communicate directly with the target AP using IEEE 802.11 authentication using an FT authentication algorithm) or over-the-distribution system (i.e., the FTO may communicate with the target AP via the current AP). In an implementation, the communication between the FTO and the target AP may be carried in FT action frames, and communication between the current AP and the target AP may be via an encapsulation method.

According to an implementation, the FT initial mobility domain association may typically be the first association within the ESS. Further, in addition to association request and response frames, reassociation request and response frames may be supported in the FT initial mobility domain association to enable both FT and non-FT APs to be present in a single ESS.

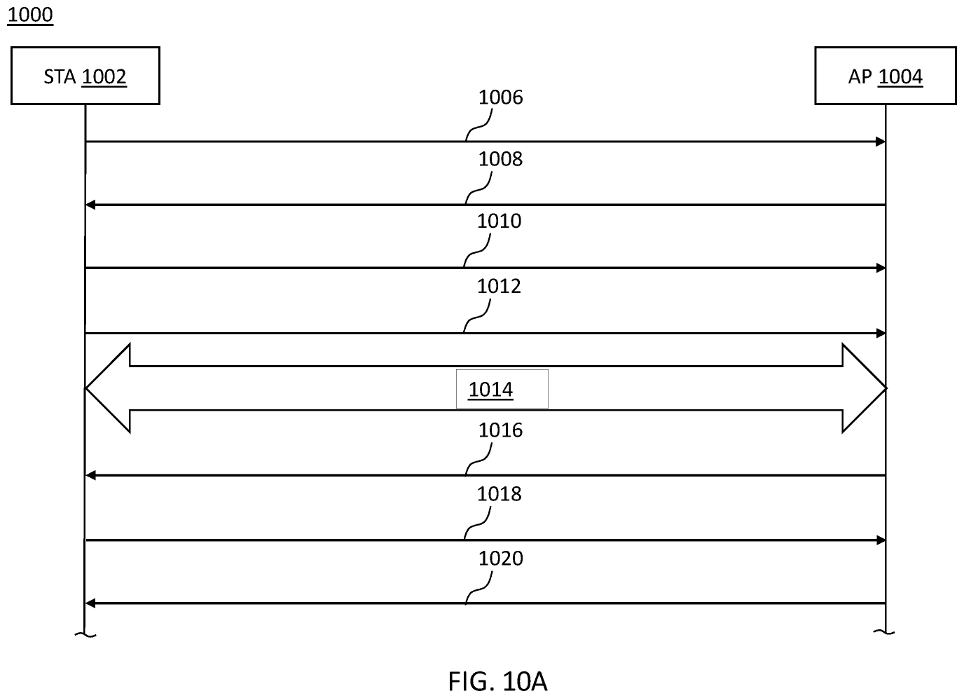

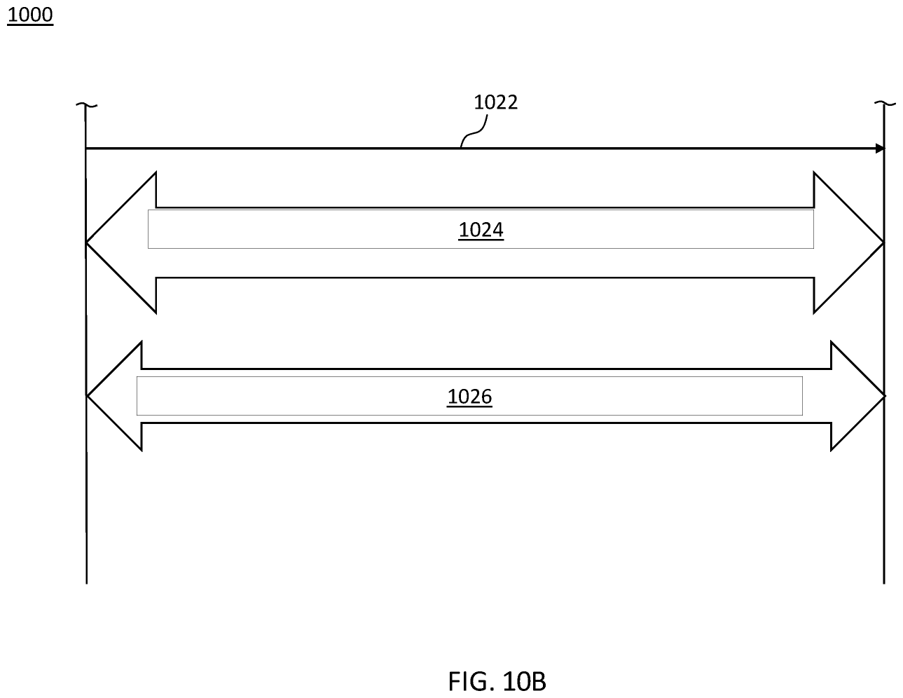

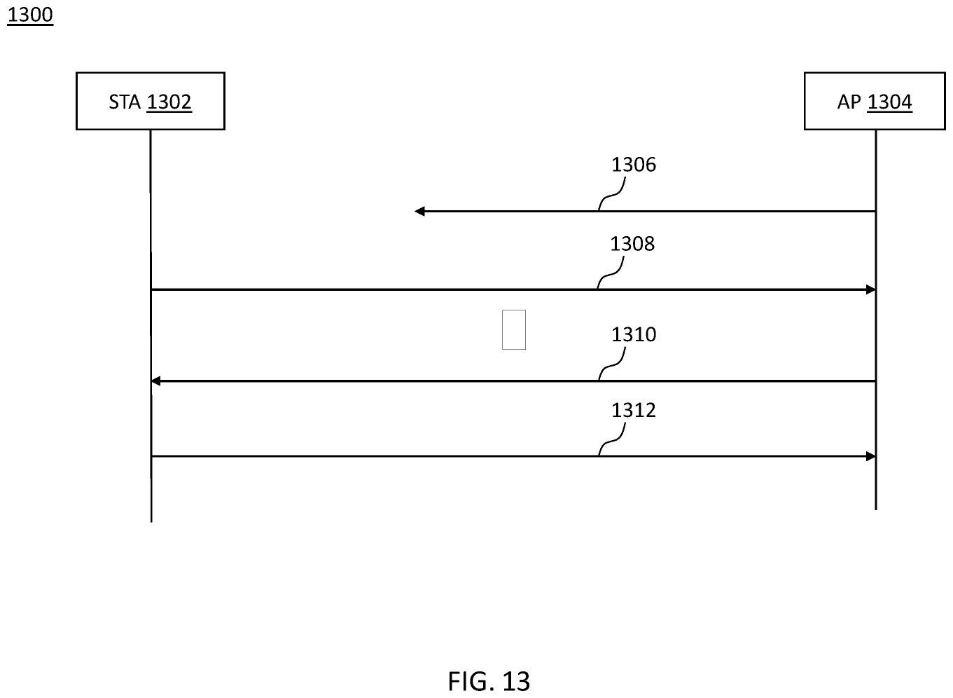

FIG. 10A and FIG. 10B depict process 1000 for FT initial mobility domain association for fast BSS transition in a robust security network (RSN), according to some embodiments. FIG. 10A and FIG. 10B are a reproduction of FIG. 13-2 from Draft 802.11REVmd_D5.0. At step 1006 of process 1000, in some implementations, STA 1002 may send 802.11 Authentication Request (Open) to AP 1004. At step 1008 of process 1000, in some implementations, AP 1004 may send 802.11 Authentication Response (Open) to STA 1002. At step 1010 of process 1000, STA 1002 may send (Re) Association Request (MDE, RSNE, RSNXE) to AP 1004. At step 1012 of process 1000, AP 1004 may send (Re) Association Response (MDE, FTE[R1KH-ID, R0KH-ID], RSNXE) to STA 1002. At step 1014 of process 1000, 802.1X EAP Authentication is performed. In an implementation, 802.1X EAP authentication is bypassed if PSK is used. At step 1016 of process 1000, AP 1004 may send EAPOL-Key (0, 0, 1, 0, P, 0, 0, ANonce, 0, { }) to STA 1002. At step 1018 of process 1000, STA 1002 may send EAPOL-Key (0, 1, 0, 0, P, 0, 0, SNonce, MIC, {RSNE[PMKR1Name], MDE, FTE, RSNXE}) to AP 1004. At step 1020 of process 1000, AP 1004 may send EAPOL-Key (1, 1, 1, 1, P, 0, 0, ANonce, MIC, {RSNE[PMKR1Name], MDE, GTK[N], IGTK[M], BIGTK[Q], FTE, TIE [ReassociationDeadline], TIE [KeyLifetime], RSNXE}). At step 1022 of process 1000, STA 1002 may send EAPOL-Key (1, 1, 0, 0, P, 0, 0, 0, MIC, { }) to AP 1004. At step 1024 of process 1000, 802.1X controlled port is unblocked, and successful (secure) session and data transmission is performed. At step 1026 of process 1000, QoS resources are allocated.

To perform an over-the-air fast BSS transition to a target AP, an FTO and the target AP may perform an exchange described below.

FTO → Target AP: Authentication-Request (FTAA, 0,
RSNE[PMKR0Name], MDE,FTE[SNonce,R0KH-ID])
Target AP → FTO: Authentication-Response (FTAA, Status,
RSNE[PMKR0Name], MDE,FTE[ANonce, SNonce, R1KH-ID, R0KH-
ID])

In an implementation, the SME of the FTO may initiate the authentication exchange using MLMEAUTHENTICATE.request primitive, and the SME of the target AP may respond with an MLMEAUTHENTICATE.response primitive.

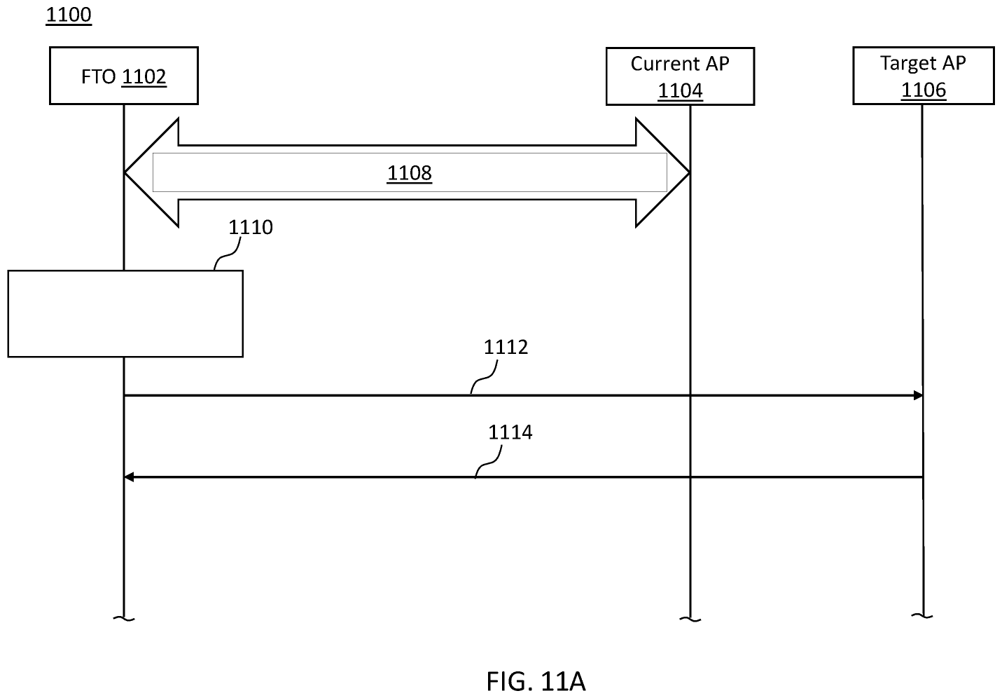

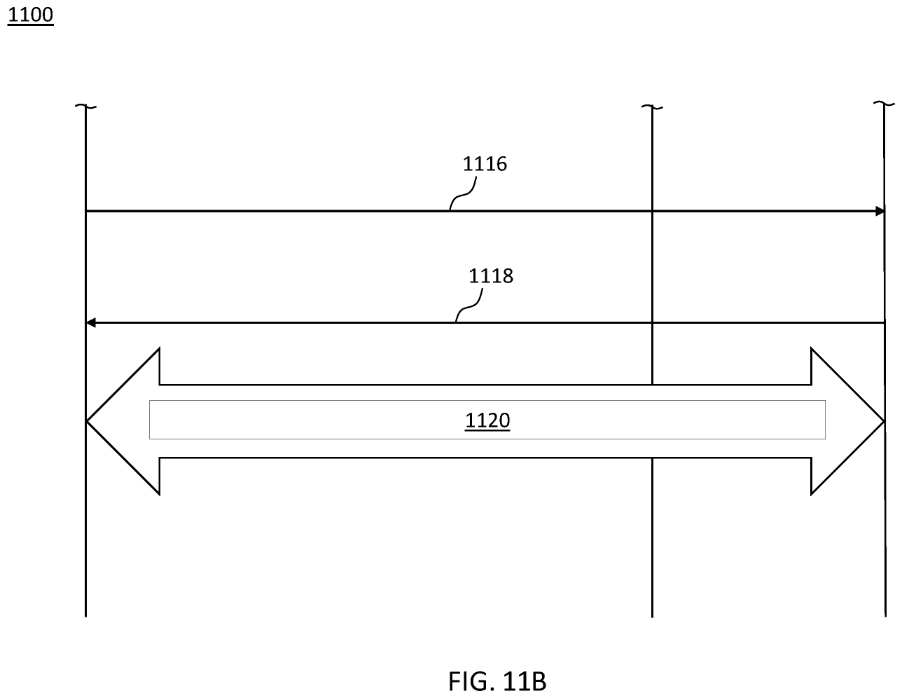

Example 1100 of an over-the-air fast BSS transition protocol (i.e., FT protocol) in an RSN is depicted in FIG. 11A and FIG. 11B, which are reproduction of FIG. 13-2 from Draft 802.11REVmd_D5.0. At step 1108 of process 1100, successful (secure) session and data transmission are performed between FTO 1102 and current AP 1104. At step 1110 of process 1100, FTO 1102 may determine if a transition to target AP 1106 is required. At step 1112 of process 1100, FTO 1102 may send 802.11 Authentication-Request (FTAA, RSNE[PMKR0Name], MDE, FTE[SNonce, R0KH-ID]) to target AP 1106. At step 1114 of process 1100, target AP 1106 may send 802.11 Authentication-Response (FTAA, RSNE[PMKR0Name], MDE, FTE[ANonce, SNonce, R1KH-ID, R0KH-ID]) to FTO 1102. In an implementation, a successful reassociation may occur only when the time between the Authentication-Request and the Reassociation Request does not exceed the reassociation deadline time. At step 1116 of process 1100, FTO 1102 may send Reassociation Request (RSNE[PMKR1Name], MDE, FTE[MIC, ANonce, SNonce, R1KH-ID, R0KH-ID], RIC-Request, RSNXE) to target AP 1106. At step 1118 of process 1100, target AP 1106 may send Reassociation Response (RSNE[PMKR1Name], MDE, FTE[MIC, ANonce, SNonce, R1KH-ID, R0KH-ID, GTK[N]], IGTK[M], BIGTK[Q], RIC-Response, RSNXE) to FTO 1102. At step 1120 of process 1100, 802.1X controlled port is unblocked, and successful (Secure) session and data transmission is performed.

In an implementation, the FT resource request protocol may involve an additional message exchange after the Authentication-Request/Response frame, or FT Request/Response frame, and prior to reassociation. To perform an over-the-air FT resource request protocol to a target AP, after completing the Authentication-Request/Response frame exchange, an FTO and the target AP may perform an exchange described below.

FTO → Target AP: Authentication-Confirm (FTAA, 0,
RSNE[PMKR1Name], MDE, FTE[MIC, ANonce, SNonce, R1KH-ID,
R0KH-ID], RIC-Request)

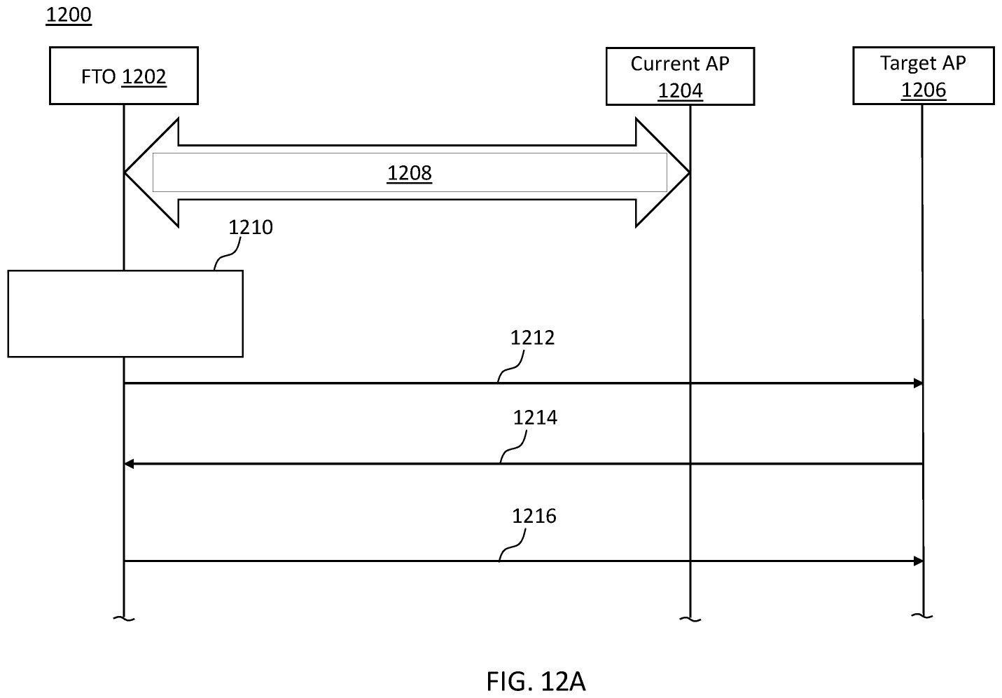

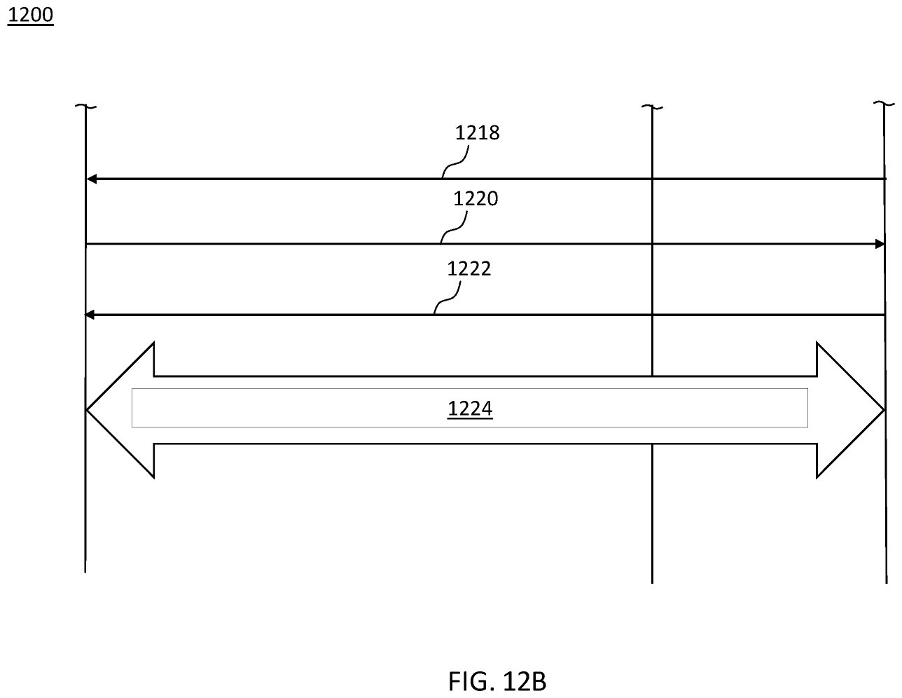

Example 1200 of an over-the-air fast BSS transition protocol with resource request (i.e., FT resource request protocol) in an RSN is depicted in FIG. 12A and FIG. 12B, which are reproduction of FIG. 13-10 from Draft 802.11REVmd_D5.0. At step 1208 of process 1200, successful (secure) session and data transmission are performed between FTO 1202 and current AP 1204. At step 1210 of process 1200, FTO 1202 may determine if a transition to target AP 1206 is required. At step 1212 of process 1200, FTO 1202 may send 802.11 Authentication-Request (FTAA, RSNE[PMKR0Name], MDE, FTE[SNonce, R0KH-ID]) to target AP 1206. At step 1214 of process 1200, target AP 1206 may send 802.11 Authentication-Response (FTAA, RSNE[PMKR0Name], MDE, FTE[ANonce, SNonce, R1KH-ID, R0KH-ID]) to FTO 1202. At step 1216 of process 1200, FTO 1202 may send 802.11 Authentication-Confirm (FTAA, RSNE[PMKR1Name], MDE, FTE[MIC, ANonce, SNonce, R1KH-ID, R0KH-ID], RIC-Request) to target AP 1206. At step 1218 of process 1200, target AP 1206 may send 802.11 Authentication-Ack (FTAA, RSNE[PMKR1Name], MDE, FTE[MIC, ANonce, SNonce, R1KH-ID, R0KH-ID], RIC-Response) to FTO 1202. In an implementation, a successful reassociation may occur only when the time between the Authentication-Request and the Reassociation Request does not exceed the reassociation deadline time. At step 1220 of process 1200, FTO 1202 may send Reassociation Request (RSNE[PMKR1Name], MDE, FTE[MIC, ANonce, SNonce, R1KH-ID, R0KH-ID], RSNXE) to target AP 1206. At step 1222 of process 1200, target AP 1206 may send Reassociation Response (RSNE[PMKR1Name], MDE, FTE[MIC, ANonce, SNonce, R1KH-ID, R0KH-ID, GTK[N]], IGTK[M], BIGTK[Q], RSNXE) to FTO 1202. At step 1224 of process 1200, 802.1X controlled port is unblocked, and successful (Secure) session and data transmission is performed.

According to an implementation, when an FTO invokes the FT protocol, first two messages of the sequence (i.e., a first message and a second message) may be carried in authentication frames or in action frames, and these messages are described in Section 13.8.2 (FT authentication sequence: contents of first message) and in Section 13.8.3 (FT authentication sequence: contents of second message) of Draft 802.11REVmd_D5.0. The first message may be used by the FTO to initiate a fast BSS transition. In an implementation, when robust security networks association (RSNA) is enabled, the FTO may include the R0KH-ID and the SNonce in the FTE and the PMKR0Name in the RSN element (RSNE). The target AP may use the PMKR0Name to derive the PMKR1Name, and if the target AP does not have the PMK-R1 identified by PMKR1Name, the target AP may attempt to retrieve that key from the R0KH identified by R0KH-ID. This protocol is described in Section 13.2 (Key holders) of Draft 802.11REVmd_D5.0. The FTO may include a fresh SNonce as its contribution to the association instance identifier and to provide key separation of derived pairwise transient key (PTK). The second message may be used by the target AP to respond to the requesting FTO. The target AP may provide the key holder identifiers and key names used to generate the PTK. The target AP may also include a fresh ANonce as its contribution to the association instance identifier and to provide key separation of the derived PTK. The response may include a status code.

In an implementation, a third message and a fourth message in the sequence may be carried in the Reassociation Request frame and the Reassociation Response frame, and are described in Section 13.8.4 (FT authentication sequence: contents of third message) and Section 13.8.5 (FT authentication sequence: contents of fourth message) of Draft 802.11REVmd_D5.0. The third message may be used by the FTO to assert to the target AP that it has a valid PTK. If no resources are required, then the FTO may omit inclusion of the RIC. The fourth message may be used by the target AP to respond to the requesting FTO. The fourth message may serve as final confirmation of the transition, establishes that the AP holds the PMK-R1 and is participating in the association instance, and protects against downgrade attacks. However, the RIC may be absent if no resources were requested in the third message. This also includes a status code and may include a reassociation deadline.

In an implementation, when the FTO invokes the FT resource request protocol, then the first message, the second message, the third message, and the fourth message of the sequence may be carried in authentication frames or in action frames, and these messages are described in Section 13.8.2 (FT authentication sequence: contents of first message) to Section 13.8.5 (FT authentication sequence: contents of fourth message) of Draft 802.11REVmd_D5.0. According to an implementation, a fifth frame and a sixth frame of the FT resource request protocol are carried in the Reassociation Request frame and Reassociation Response frame, and are described in Section 13.8.4 (FT authentication sequence: contents of third message) and Section 13.8.5 (FT authentication sequence: contents of fourth message) of Draft 802.11REVmd_D5.0.

According to an implementation, pre-association security negotiation (PASN) may be an RSNA authentication protocol in scenarios where it relies on the existence of a pairwise master key security association (PMKSA) for an authentication and key management (AKM). PASN was introduced in IEEE 802.11az and allowed a pre-association encrypted exchange with an AP.

FIG. 13 depicts process 1300 for PASN authentication, according to some embodiments. FIG. 13 is a reproduction of FIG. 12-55a from Draft P802.11az_D4.0. In FIG. 13, STA 1302 may be a supplicant and AP 1304 may be an authenticator. At step 1306 of process 1300, AP 1304 may send Beacon (RSNE (PASN AKM, Base AKM), [RSNXE]). At step 1308 of process 1300, STA 1302 may send 802.11 Authentication (1, PASN, RSNE (Base AKM, PMKID[0 . . . n]), [RSNXE], S-Ephemeral Pub, PASN Parameters, Base AKM Data-1) to AP 1304. At step 1310 of process 1300, AP 1304 may send 802.11 Authentication (2, PASN, RSNE (Base AKM, PMKID[0 . . . n]), [RSNXE], A-Ephemeral Pub, PASN Parameters, Base AKM Data-2, MIC) to STA 1302. At step 1312 of process 1300, STA 1302 may send 802.11 Authentication (3, Base AKM Data-3, MIC) to AP 1304.

In an implementation, an AP may indicate that it is capable of performing PASN authentication by including the PASN AKM as part of the RSNE included in beacon and probe response frames. The RSNE may indicate that security network that allows only the creation of robust security network associations (RSNAs) and that the group cipher suite specified is not wired equivalent privacy (WEP). The group cipher suite relies on the existence of a PMKSA for an AKM. A successful PASN exchange may result in establishment of PTKSA using the ephemeral keys and PMK from the Base AKM (if any). The PMK may be designed to last the entire session and should be exposed as little as possible. Hence, keys to encrypt the traffic need to be derived. A four-way handshake may be used to establish another key called PTK. PMK is a lifetime key, while PTK is a temporary key.

In an implementation, three PASN frames may be constructed, namely a first PASN frame, a second PASN frame, and a third PASN frame. The first PASN frame may be sent from a STA to an AP. If the STA initiates PASN authentication, then the STA may first select the authentication parameters and may then compose an RSNE. The STA may send the first PASN frame to the AP. Upon receiving the first PASN frame, the AP may begin the construction of the second PASN frame and when complete, the AP may send the second PASN frame to the STA. Upon receiving the second PASN frame, the STA may begin the construction of the third PASN frame and when complete, the STA may send the third PASN frame to the AP and then install the temporal key derived using the MLME-SETKEYS.request primitive. The AP may install the temporal key derived using the MLME-SETKEYS.request primitive.

According to an implementation, PASN authentication may be performed using different security protocols such as FT protocol. In an implementation, PASN authentication with FT protocol may rely on FT key hierarchy which may be established via the FT initial mobility domain association. In an implementation, PASN protocol messages may carry FT PMKR1Name as the PMKID, and the PASN PTKSA may be established like any other Base AKM. In an example, wrapped data may optionally be present in the first PASN frame and in the second PASN frame. If wrapped data was present in the first PASN frame, then wrapped data may be present in the second PASN frame. The third PASN frame may be from the STA to the AP and the third frame may not carry wrapped data.

### C. Systems and Methods for Maintaining a Preferential Sensing Link Upon Reassociation

The present disclosure generally relates to systems and methods for Wi-Fi sensing. In particular, the present disclosure relates to systems and methods for maintaining a preferential sensing link upon reassociation.

The present disclosure describes a Wi-Fi sensing system that enables sensing measurements to continue to be made on a preferred sensing link in an extended service set (ESS) even when a preferred communication link in the ESS is no longer the same. In an implementation, when a distribution system of an ESS determines to move a station (STA) from one access point (original or serving AP) or basic service set (original or serving BSS) to another access point (target AP) or BSS using BSS transition management procedures, the Wi-Fi sensing system may signal its sensing link preferences to the ESS to influence association decisions made on behalf of the STA. The Wi-Fi sensing system may indicate that it must stay associated with the serving AP (or current AP) for its sensing link and not be moved to a target AP, even if the quality of the communication link between the serving AP and the STA deteriorates. In an implementation, the Wi-Fi sensing system may indicate that it should stay associated with the serving AP for its sensing link provided the quality of the communication link between the serving AP and the STA does not drop below a minimum performance level. In an implementation, the Wi-Fi sensing system may indicate that the sensing link of the STA may be moved to a target AP, however the STA should be given preference over other STA to move back to the original AP if the data communication conditions of the Wi-Fi system permit this. The Wi-Fi sensing system may also indicate that the STA of the original sensing link may be moved to a target AP, however the original sensing link with the original AP should be reestablished periodically for sensing measurements to meet the requirements of the Wi-Fi sensing system.

In scenarios where the Wi-Fi sensing system indicates that the original sensing link with the original AP should be reestablished periodically for sensing measurements, Fast BSS transition procedures may be used to reassociate the STA to the original AP to reestablish the original sensing link and to return and associated the STA back to the target AP to reestablish the preferred communication link after the sensing measurements have been made. The BSS of the preferred communication link (the target BSS) may buffer data for the STA while it makes sensing measurements on the original sensing link. The target BSS may then send the buffered data to the STA when the STA returns to the preferred communication link. In an implementation, in scenarios where the Wi-Fi sensing system indicates that the original sensing link should be reestablished periodically for sensing measurements, pre-association security negotiation (PASN) procedure may be used between the STA and the AP of the original sensing link (the original AP), where the sensing measurements are made on the training fields of the PASN messages themselves. In examples, the STA does not reassociate with the original AP of the original sensing link through completion of the PASN procedure, and the PASN procedure is aborted after one or more PASN messages and the STA returns to the preferred communication link with the target AP, where communication data that may have been buffered is sent.

Referring to FIG. 5, according to some implementations, first sensing receiver 502-1 may be configured to operate as an AP of an original BSS and first sensing transmitter 504-1 may be configured to operate as STA. For ease of explanation and understanding, first sensing receiver 502-1 may hereinafter be referred to as an original AP and first sensing transmitter 504-1 may hereinafter be referred to as STA.

According to an implementation, first sensing agent 526-1 may be configured to associate the STA (i.e., first sensing transmitter 504-1) with the original AP of the original BSS (i.e., first sensing receiver 502-1) to establish an original association between the STA and the original AP. In an implementation, the STA and the original AP may have an original communication link and an original sensing link established therebetween. The original communication link may be established for data transmissions and the original sensing link may be established for sensing transmissions.

In an implementation, first sensing transmitter 504-1 may receive a transition management request identifying a preferred communication link between the STA and a preferred AP of a preferred BSS, different than the original communication link with the original AP. The preferred BSS may be different from the original BSS. Further, in an example, the preferred AP may be second sensing receiver 502-2 or any sensing receiver other than first sensing receiver 502-1. According to an example implementation, the preferred communication link may be identified by a distribution system based on load balancing within an ESS including the original BSS and the preferred BSS.

According to an implementation, first sensing agent 526-1 may cause transmission of a transition preference indicating a preference to preserve the original sensing link. In an implementation, first sensing agent 526-1 may cause sensing transmitter 504-1 to maintain the original association with the original AP (sensing receiver 502-1) responsive to the transition preference. In an example implementation, the transition preference may be indicated by a sensing link preference action frame indicating the preference to maintain the original association between the sensing transmitter STA 504-1 and the original AP (sensing receiver 502-1). In some example implementations, the transition preference may be indicated by a wireless network management field value in a wireless network management action frame. In an example, the transition preference may indicate a requirement that the sensing transmitter STA 504-1 maintain the original association with the original AP (sensing receiver 502-1). In some examples, the transition preference may indicate a request that at least one other STA within the original BSS associates with an alternate AP before the sensing transmitter STA 504-1 associates with an alternate AP. In an example, the at least one other STA may include second sensing transmitter 504-2 or any sensing transmitter other than first sensing transmitter 504-1. Further, in an example, the alternate AP may be second sensing receiver 502-2 or any sensing receiver other than first sensing receiver 502-1. In some examples, the transition preference may indicate a minimum performance threshold for the original communication link between sensing transmitter 504-1 and sensing receiver 502-1, and a requirement that the STA maintain the original association with the original AP (sensing receiver 502-1) while the original communication link maintains performance above the minimum performance threshold.

In an implementation, the transition preference may include one of a BSS transition management query and a BSS transition management response indicating a preference to maintain the original association for the original sensing link, by using a preferred BSS transition candidate list. In some implementations, the transition preference may include a BSS transition management response indicating a preference to maintain the original association for the original sensing link by a BSS transition management status code. In some implementations, the transition preference may include a BSS transition management query indicating a preference to maintain the original association for the original sensing link in a BSS transition query reason field.

According to an implementation, sensing transmitter 604-1 may establish a preferred association between the STA and the preferred AP (target AP). In an implementation, first sensing agent 526-1 may periodically reassociate the STA to the original AP to perform a sensing measurement. In an example, first sensing agent 526-1 may perform reassociation of the STA to the original AP via a fast BSS transition protocol. Further, first sensing agent 526-1 may reassociate the STA to the preferred AP (target AP) subsequent to the sensing measurement.

According to some implementations, to enable the sensing measurement, first sensing agent 526-1 may cause sensing transmitter 504-1 to establish a PASN between the STA and the original AP (sensing receiver 502-1) while maintaining the preferred association (i.e., the associated between sensing transmitter 504-1 and the target AP). In an example, sensing agent 526-1 on the STA (sensing transmitter 504-1) may perform a sensing measurement on one or more training fields of one or more PASN authentication frames sent by the original AP (sensing receiver 502-1) while maintaining the preferred association. According to some implementations, to enable the sensing measurement, first sensing agent 516-1 on the original AP (sensing receiver 502-1) may perform a sensing measurement on one or more training fields of one or more PASN authentication frames sent by the STA (sensing transmitter 504-1) while not associated with the STA (the STA maintains the preferred association with the target AP). In examples, first sensing agent 526-1 on sensing transmitter 504-1 may send the sensing measurement to first sensing agent 516-1 on sensing receiver 502-1, which may be further processed by sensing receiver 502-1 to generate a sensing result. In examples, first sensing agent 516-1 on sensing receiver 502-1 may send the sensing measurement to first sensing agent 526-1 on sensing transmitter 504-1, which may be further processed by sensing transmitter 504-1 to generate a sensing result. In examples, the sensing measurement may be sent by sensing receiver 502-1 or sensing transmitter 504-1 to a networked device which comprises a sensing algorithm, wherein the networked device generates a sensing result.

According to an implementation, first sensing agent 516-1 may be configured to associate the original AP (i.e., first sensing receiver 502-1) with the STA (i.e., first sensing transmitter 504-1) to establish an original association between the AP and the STA. In an implementation, the original AP and the STA may have an original communication link and an original sensing link established therebetween. The original communication link may be established for data transmissions and the original sensing link may be established for sensing transmissions.

In an implementation, sensing receiver 502-1 may receive a transition management query identifying a preferred communication link between the sensing transmitter 504-1 STA and a preferred AP different from sensing receiver 502-1, of a preferred BSS, where the preferred communication link is different than the original communication link with the original AP (sensing receiver 502-1. The preferred BSS may be different from the original BSS. Further, in an example, the preferred AP may be second sensing receiver 502-2 or any sensing receiver other than first sensing receiver 502-1. In an implementation, first sensing agent 516-1 of sensing receiver 502-1 may cause transmission of a transition preference indicating a preference to preserve the original sensing link between sensing receiver 502-1 and sensing transmitter 504-1. According to some implementations, sensing receiver 502-1 may maintain the original association between the original AP (sensing receiver 502-1) and the STA (sensing transmitter 504-1) responsive to the transition preference. In an example, the transition preference may indicate a requirement that the STA (sensing transmitter 504-1) maintain the original association with the original AP (sensing receiver 502-1). In some examples, the transition preference may indicate a minimum performance threshold for the original communication link and a requirement that the STA (sensing transmitter 504-1) maintain the original association with the original AP (sensing receiver 502-1) while the original communication link maintains performance above the minimum performance threshold. In some examples, the transition preference may be indicated by a sensing link preference action frame indicating the preference to maintain the original sensing link. In some examples, the transition preference is indicated by a wireless network management field value in a wireless network management action frame. Further, in some examples, the transition preference may include a BSS transition management request sent from sensing receiver 502-1 to sensing transmitter 504-1. The BSS transition management request may indicate the preference to maintain the original association (and therefore the original sensing link) by a preferred BSS transition candidate list.

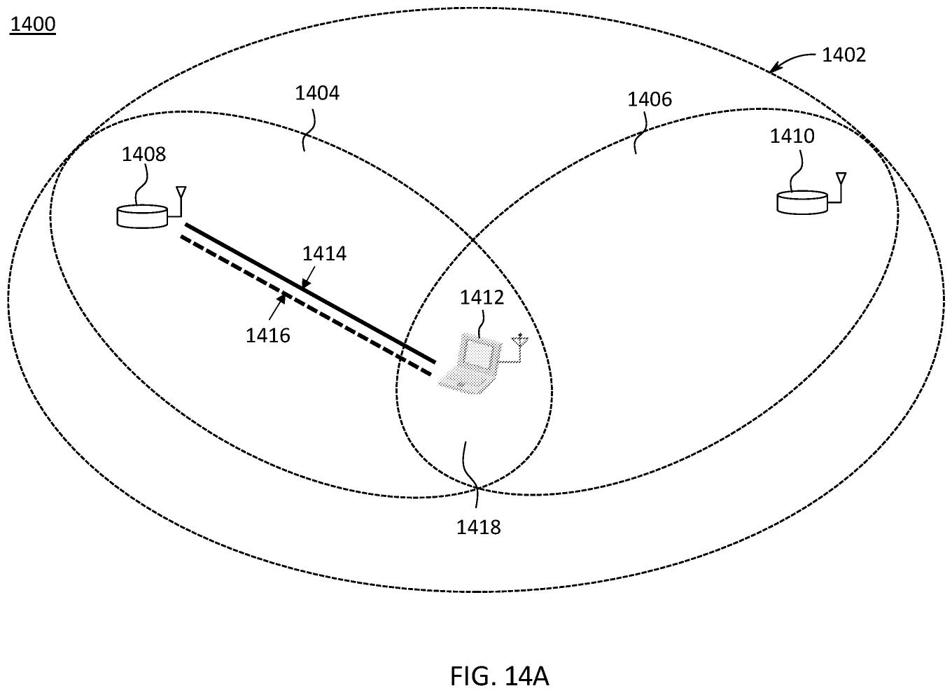

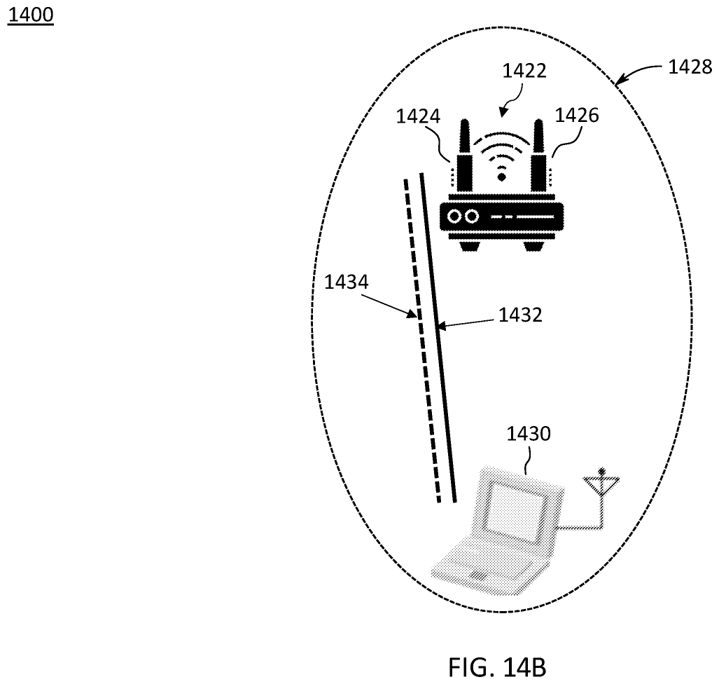

FIG. 14A depicts example of a Wi-Fi network including two APs that are in different BSSs as a part of an ESS, according to some embodiments. As described in FIG. 14A, ESS 1402 is created by connecting first BSS 1404 and second BSS 1406, for example using a distribution system. First BSS 1404 includes AP1 1408 and second BSS 1406 includes AP2 1410. Further, AP1 1408 and STA 1412 may have communication link 1414 (also referred to as original communication link 1414) and sensing link 1416 (also referred to as original sensing link 1416) established therebetween. According to an implementation, an original association (or an original association link) is established between AP1 1408 and STA 1412. In an implementation, AP1 1408 and AP2 1410 may operate on the same frequency channel (for example, “f₁”) and there may be coverage overlapping area 1418 between AP1 1408 and AP2 1410 for STA 1412. In some implementations, AP1 1408 and AP2 1410 may operate on different frequency channels. In an example, AP1 1408 may operate on f₁ and AP2 1410 may operate on f₂.

FIG. 14B depicts an example of a Wi-Fi network including dual-band AP 1422, according to some embodiments. In an implementation, dual-band AP 1422 may have one frequency band AP_{f}_{₁} (represented by reference number “1424”) at f₁ and another frequency band AP_{f}_{₂} (represented by reference number “1426”) at f₂. In an implementation, dual-band AP 1422 may operate a BSS on frequency bands AP_{f}_{₁} and AP_{f}_{₂} that are a part of ESS 1428. Further, dual-band AP 1422 and STA 1430 may have communication link 1432 and sensing link 1434 established therebetween on frequency band AP_{f}_{₁}. According to an implementation, an original association is established between STA 1430 and dual-band AP 1422 operating on frequency band AP_{f}_{₁}. Although, it is shown in FIG. 14B that the AP is a dual-band AP, in some embodiments, the AP may be a tri-band AP or more.

As described earlier, a communication link may be used for data communications between an AP and a STA and a sensing link may be used for sensing transmissions and sensing measurements between an AP and a STA. According to an implementation, a STA may only be associated with one AP at one time. In examples, the decision of the STA to change the BSS in the ESS that it is associated with the STA may generally be an autonomous decision made by the STA, although mechanisms exist for an AP or a distribution system to influence the decision. In certain scenarios, it may be preferable in the ESS to change the communication link of the STA to a different AP. However, at the same time it may be preferable to the Wi-Fi sensing system to maintain the original sensing link. Generally, it may be advantageous to ensure that sensing measurements can be made in a preferred sensing link in an ESS even when a preferred communication link in the ESS is different. This may result in greater sensitivity, accuracy, or efficiency of Wi-Fi sensing system 500 for detecting or measuring various aspects of motion, such as the localization of motion in a sensing space.

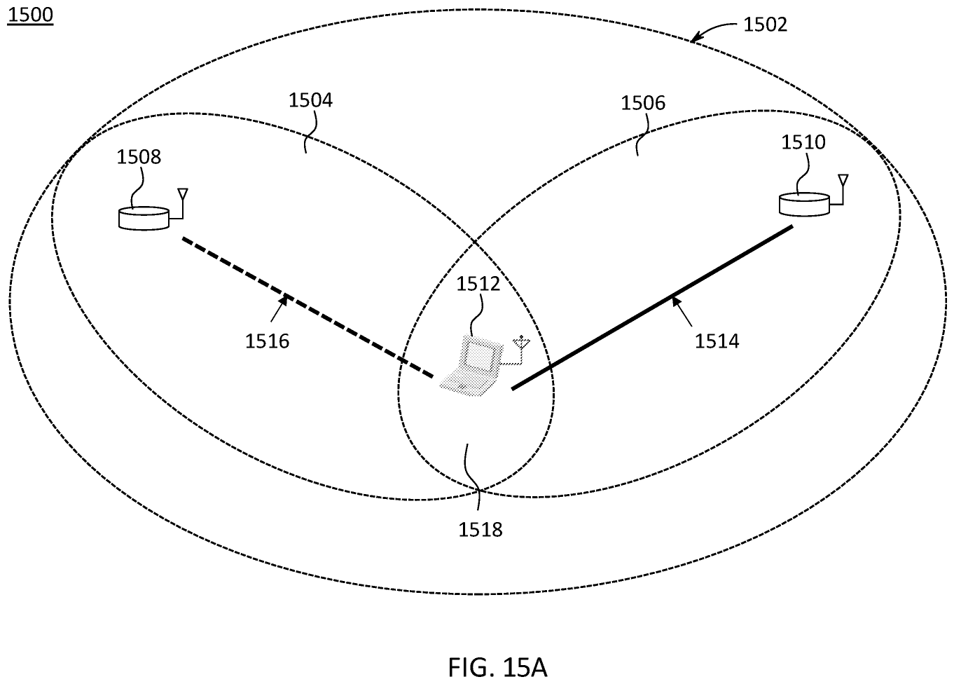

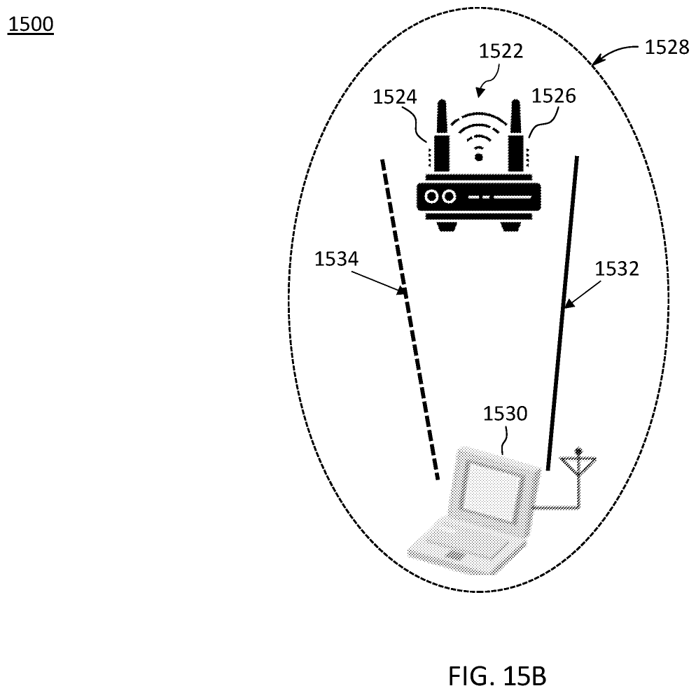

FIG. 15A and FIG. 15B depict preferred communication links and preferred sensing links for an STA, where the preferred communication links have changed such that they are no longer the same as the preferred sensing links (as they were in FIG. 14A and FIG. 14B), according to some embodiments. As described in FIG. 15A, ESS 1502 is created by connecting first BSS 1504 and second BSS 1506. First BSS 1504 includes AP1 1508 and second BSS 1506 includes AP2 1510. Further, AP2 1510 and STA 1512 may have preferred communication link 1514 (also referred to as changed communication link 1514) established therebetween, and AP1 1508 and STA 1512 may have preferred sensing link 1516 established therebetween. According to an implementation, a changed association link, after reassociation of STA 1512 to AP2 1510, preferred communication link 1514 is established between AP2 1510 and STA 1512. In an implementation, AP1 1508 and AP2 1510 may operate on the same frequency channel (for example, “f₁”) and there may be coverage overlapping area 1518 between AP1 1508 and AP2 1510 for STA 1512. In some implementations, AP1 1508 and AP2 1510 may operate on different frequency channels. In an example, AP1 1508 may operate on f₁ and AP2 1510 may operate on f₂. FIG. 15B describes dual-band AP 1522, according to some embodiments. In an implementation, dual-band AP 1522 may have one frequency band AP_{f}_{₁} (represented by reference number “1524”) at f₁ and another frequency band APs, (represented by reference number “1526”) at f₂. Dual-band AP 1522 may operate a BSS on frequency band AP_{f}_{₁} and a BSS on frequency band AP_{f}_{₂}, that are a part of ESS 1528. In an implementation, dual-band AP 1522 and STA 1530 may have preferred communication link 1532 established therebetween on frequency band AP_{f}_{₂}. Further, dual-band AP 1522 and STA 1530 may have preferred sensing link 1534 established therebetween on frequency band AP_{f}_{₁}. According to an implementation, a changed association link, after reassociation of STA 1530 with dual-band AP 1522 operating on frequency band AP_{f}_{₂} is preferred communication link 1532.

According to an implementation, system 500 may not accept an interruption in sensing measurements on an original sensing link, i.e., system 500 may not allow an STA to reassociate and establish data communications with another AP and may require the STA to maintain the original communication link. An original communication link for the STA may have a suboptimal signal strength, and this may result in the initiation of reassociation of the STA (initiated by the STA itself or by a distribution system in an ESS). In an implementation, the distribution system, the STA, and the AP may reference sensing link preferences to be aware of when the original sensing link (and therefore the original association and the original communication link) must be maintained, in spite of indicators that the STA would have better communication link performance if it were to reassociate with another AP. In such scenario, the STA may be referred to as “Selfish STA”. In examples, a Selfish STA may be associated with AP1, and AP1 may be associated with multiple other STAs, resulting in a lack of throughput for one or more of the STAs, causing an overall deterioration of the communication link performance for the Selfish STA. In examples, AP1 may move one or more of the multiple other STAs to other APs to reduce the load on AP1. As a result, performance of the communication link for the Selfish STA that remains on AP1 may improve.

In an implementation, system 500 may indicate a strong preference for maintaining the association between the STA and AP1. In such scenario, the STA may be referred to as “Assertive STA”. In an example, this indication may trigger the distribution system in the ESS to encourage other STAs to associate to different APs or may move other STAs to other APs. Thus, load on AP1 may reduce, and this may result in better performance of the communication link between the STA and AP1. In an implementation, if the distribution system in the ESS is not enabled to improve the communication performance for the STA while on AP1, then the distribution system in the ESS may move the STA to a different AP.

In an implementation, a distribution system in an ESS may determine that a STA associated with AP1 that is a sensing transmitter should associate with AP2 because a changed communication link between the STA and AP2 may perform better than an original communication link between the STA and AP1. In such scenarios, system 500 may send indicate to the distribution system in the ESS the preference to maintain a sensing session with AP1 by maintaining the association between the STA and AP1 provided a minimum performance of the original communication link is maintained. In such scenario, the STA may be referred to as “Helpful STA”.

A minimum performance of a communication link may be described in terms of signal strength (RSRP), signal to noise ratio (SNR), signal to noise plus interference ratio (SINR), data throughput (e.g., bits per second or bits per hertz), quality of service (QOS), bit error rate (BER), block error rate (BLER), or any other known metric used to characterize the quality of a data connection. If the distribution system in the ESS cannot maintain that minimum performance of the original communication link between the STA and AP1, then the STA may reassociate (initiated by the STA itself or by the distribution system in the ESS) to a different AP. In an implementation, system 500 may trigger distribution system in the ESS to encourage other STAs (for example, STAs that are not sensing transmitters) to change from an association with AP1 to associate to different APs, or may move other STAs to other APs. As a result, the load on AP1 may be reduced, and the performance of the original communication link between the STA and AP1 is improved such that it meets the minimum performance threshold. The distribution system in the ESS may alternatively elect to make no changes to improve the communication performance for the STA while on AP1.

According to some implementations, may tolerate an interruption of sensing measurements made on an original sensing link, provided sensing measurements are made on the original sensing link periodically. In examples, the distribution system in the ESS may determine that a STA that is a sensing transmitter should associate with AP2 because a changed communication link between the STA and AP2 may perform better than an original communication link between the STA and AP1. The STA (or system 500) may send a signal to the distribution system in the ESS indicating a preference make periodic sensing measurements between the STA and AP1 even if the STA is associated with a different AP. The STA (or system 500) as part of the preference may indicate a frequency (or a maximum elapsed time) between sensing measurements on the original sensing link between STA1 and AP1 that it can tolerate. The distribution system in the ESS may use different protocols or procedures to reestablish the original sensing link between the STA and AP1 in an efficient way, while pausing the data connection on a preferred communication link with AP2 that the STA reassociated to, for the time required to make periodic sensing measurements on the original sensing link. In such scenario, the STA may be referred to as “Periodic STA”.

The manner in which an original sensing link can be maintained or periodically restored where a STA has identified a preferred communication link is described in detail below.

In certain situations, from a data communications point of view, it may be preferable for a STA to move to a new AP, however system 500 may want the STA to continue to perform sensing measurements with an original AP that a Wi-Fi sensing session was established over. As a STA can only have one association with one AP at a time, an association of the STA is consistent with a communication link (and a corresponding AP). In an implementation, system 500 is enabled to continue to make sensing measurements on an original sensing link (which is a preferred sensing link) where the preferred sensing link and the preferred communication link were originally the same as shown in FIG. 14A and FIG. 14B, and subsequently the preferred communication link changes while the preferred sensing link stays the same as shown in FIG. 15A and FIG. 15B.

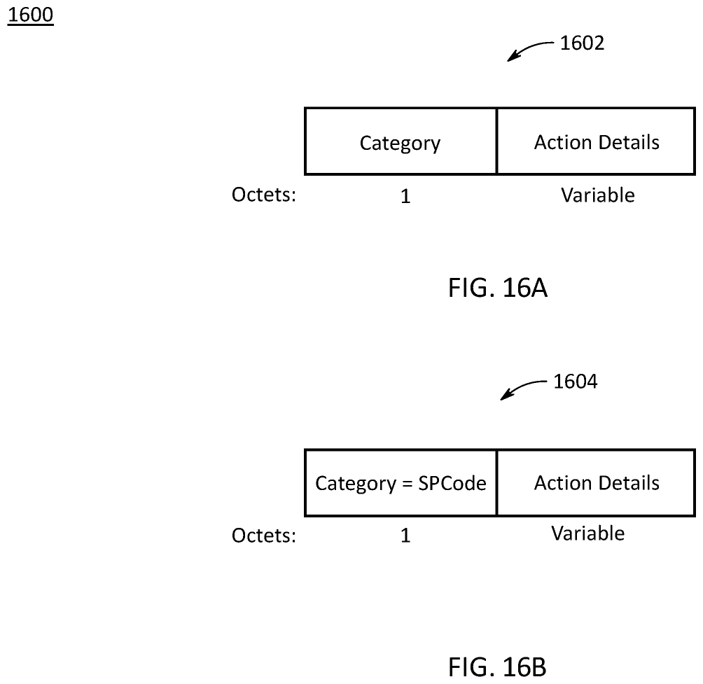

According to an implementation, an action field in an action frame may provide a mechanism for specifying extended management actions. FIG. 16A depicts an action field format for action frame 1602, according to some embodiments. FIG. 16A is a reproduction of FIG. 9-94 from Draft 802.11REVmd_D5.0.

In an embodiment, a new category of an action frame is defined for a management frame in order to specify sensing link preferences. In an example, a category value code is defined as a sensing link preference action frame. In an implementation, this may be added to Table 9-51 (Category values) in Draft P802.11REVmd_D5.0. Table 2 provided below shows an example of a new category value which may be defined for communicating a sensing link preference.

TABLE 2
New category value for sensing link preference for
an 802.11 action field format for an action frame

| | | | | Group addressed |
|---|---|---|---|---|
| Code | Meaning | See subclause | Robust | privacy |
| SPCode | Sensing Link | 9.6.SPCode | Yes | No |
| | Preference | | | |

FIG. 16B depicts an action field format for sensing link preference action frame 1604, according to some embodiments. In an example, SPCode may use a Reserved Category value. In Draft P802.11REVmd_D5.0, Category values 30 to 125 are reserved. In an example, SPCode may be a value between 30 and 125.

In an embodiment, a wireless network management (WNM) category of an action frame may be used with a new WNM action defined for specifying sensing link preference. The action frame category for WNM is category 10. The action field (for example, Category field) provides a mechanism for specifying extended management actions. The format of the action field is shown in FIG. 16A. In examples, the Category field for an WNM action frame (also referred to as a wireless network management action frame) is “10”. In an implementation, several action frame formats are defined for WNM purposes. A WNM action field is specified in the field immediately after the Category field in the WNM action frame. The WNM action field values (also referred to as wireless network management field values) associated with each frame format are defined in Table 9-425 (WNM Action field values) in Draft P802.11REVmd_D5.0, which is reproduced in part below in Table 3.

TABLE 3
802.11 WNM action field values

| WNM Action Field value | Description |
|---|---|
| 0 | Event Request |
| 1 | Event Report |
| 2 | Diagnostic Request |
| 3 | Diagnostic Report |
| . . . | . . . |
| 26 | WNM Notification Request |
| 27 | WNM Notification Response |
| 28-255 | Reserved |

In an embodiment, one or more new WNM action field values may be defined for a WNM action frame in order to specify sensing link preferences. In an example, a new WNM action field value is defined for a sensing link preference request (STA→AP) and a new WNM action field value is defined for a sensing link preference response (AP→STA). Table 4 provided below describes 802.11 WNM action field values including sensing link preference request and response fields. In an example, SPfield-Request and SPfield-Response WNM Action field values may be values between 28 and 255.

TABLE 4
802.11 WNM action field values including sensing
link preference request and response fields

| WNM Action field value | Description |
|---|---|
| 0 | Event Request |
| 1 | Event Report |
| 2 | Diagnostic Request |
| 3 | Diagnostic Report |
| . . . | . . . |
| 26 | WNM Notification Request |
| 27 | WNM Notification Response |
| . . . | . . . |
| SPfield-Request | Sensing Link Preference Request |
| SPfield-Response | Sensing Link Preference Response |

FIG. 17A depicts exemplary sensing link preference request action frame 1702, according to some embodiments. In particular, FIG. 17A shows an exemplary action field format for a sensing link preference request action field of a WNM management frame. In an example, a Dialog Token may be added in the Octet after the SPfield-Request WNM Action field value in the sensing link preference request action frame 1702. FIG. 17B depicts exemplary sensing link preference response action frame 1704, according to some embodiments. In particular, FIG. 17B shows an exemplary action field format for a sensing link preference request action field of a WNM management frame. In an example, a Dialog Token may be added in the Octet after the SPfield-Response WNM Action field value in sensing link preference response action frame 1704.

According to some implementations, load balancing algorithms may be enabled in an 802.11 Wi-Fi network using BSS transition management. In an example, the BSS transition management may be a wireless network management procedure used for load balancing of APs in a distribution system through moving STAs between APs (points of association) within an ESS. In an implementation, load balancing decisions may arise, for example, from assessments of AP capacity, available throughput, and STA received signal strength. Generally, load balancing decisions are made in the context of the performance of a communication link. In an implementation, BSS transition management may be achieved using three different wireless network management action frames: i) BSS transition management query frame (WMN Action field value=6), ii) BSS transition management request frame (WMN Action field value=7), and iii) BSS transition management response frame (WMN Action field value=8).

In an implementation, a BSS transition management query frame may be transmitted to request or provide information on BSS transition candidate APs. The action field format for BSS transition management query action frame 1800 is depicted in FIG. 18. FIG. 18 is a reproduction of FIG. 9-922 from Draft 802.11REVmd_D5.0. In an implementation, the Dialog Token field (shown in FIG. 18) may be used for matching action responses with action requests when there are multiple concurrent action requests. The length of the Dialog Token field is 1 octet. More information on use of the Dialog Token field is provided in Section 10.28.5 (Operation of the Dialog Token field) of Draft P802.11REVmd_D5.0. Further, the BSS Transition Query Reason field (shown in FIG. 18) may include a reason code for a BSS transition management query as defined in Table 9-198 of Draft P802.11REVmd_D5.0, which is reproduced in part in Table 5 below.

TABLE 5
Transition and Transition Query Reasons

| Transition | |
|---|---|
| Reason value | Description |
| 0 | Unspecified |
| 1 | Excessive frame loss rates and/or poor conditions |
| 2 | Excessive delay for current traffic streams |
| 3 | Insufficient QoS capacity for current traffic streams |
| | (TSPEC rejected) |
| 4 | First association to ESS (the association initiated by an |
| | Association Request frame instead of a Reassociation |
| | Request frame) |
| 5 | Load Balancing |
| 6 | Better AP found |
| . . . | . . . |
| 16 | Low RSSI |
| . . . | . . . |
| 19 | Preferred BSS transition candidate list included |
| 20 | Leaving ESS |
| 21-255 | Reserved |

In an example, the STA may use Transition Reason value 19—“Preferred BSS transition candidate list included” when using the BSS transition management procedures to indicate a preferred sensing link.

FIG. 19 depicts BSS transition management query action frame 1900 when a preferred BSS transition candidate list is included, according to some embodiments. In an implementation, the BSS Transition Candidate List Entries field (as shown in FIG. 19) may include 0 (zero) or more Neighbor Report elements, as described in Section 9.4.2.36 (Neighbor Report element) of Draft P802.11REVmd_D5.0. The Neighbor Report elements may be collected by a STA as a part of a scanning procedure and provided to the AP as described in Section 11.21.7.2 (BSS transition management query) of Draft P802.11REVmd_D5.0. Further, the Neighbor Report element describes an AP.

FIG. 20 depicts Neighbor Report element format 2000 for use in a BSS transition management query action frame when BSS transition candidate list entries are included, according to some embodiments. The Optional Subelements ID field values for the defined subelements are given in Table 9-173 in Draft P802.11REVmd_D5.0, which is reproduced in part in Table 6 below.

TABLE 6
Optional Subelements ID field values
for the Neighbor Report element

| Subelement ID | Name | Extensible |
|---|---|---|
| 0 | Reserved | |
| 1 | TSF Information | Yes |
| 2 | Condensed Country String | Yes |
| 4 | BSS Transition Candidate Preference | No |
| . . . | . . . | . . . |
| 7-38 | Reserved | |
| . . . | . . . | . . . |
| 40-44 | Reserved | |
| . . . | . . . | . . . |
| 46-60 | Reserved | |
| . . . | . . . | . . . |
| 63-65 | Reserved | |
| . . . | . . . | . . . |
| 67-69 | Reserved | |
| . . . | . . . | . . . |
| 72-190 | Reserved | |
| . . . | . . . | . . . |
| 193-220 | Reserved | |
| . . . | . . . | . . . |
| 222-255 | Reserved | |

In an implementation, a “Selfish STA” as described earlier may include Subelement 4 in the Neighbor Report element and for each of the BSS for which a Neighbor Report element is included, the STA may include a Reserved Subelement with which the STA can indicate the preference of the BSS such that it indicates that the STA shall not be moved to the BSS.

FIG. 21 depicts BSS transition candidate preference subelement format 2100, according to some embodiments. FIG. 21 is a reproduction of FIG. 9-340 of Draft P802.11REVmd_D5.0. In an implementation, the preference field of BSS transition candidate preference subelement format 2100 may indicate the network preference for BSS transition to the BSS listed in this BSS transition candidate list entries field, the BSS transition management request frame, BSS transition management query frame, and BSS transition management response frame. The preference field value is a number ranging from 0 to 255, as defined in Table 9-174 (preference field values) which is reproduced below as Table 7, indicating an ordering of preferences for the BSS transition candidates for the STA. Additional details describing use of the preference field are provided in Section 11.21.7 (BSS transition management for network load balancing) of Draft P802.11REVmd_D5.0.

TABLE 7
Preference field value for the BSS transition
candidate list entries field

| Preference | |
|---|---|
| field value | Description |
| 0 | Excluded BSS; reserved when present in the BSS Transition |
| | Management Query or BSS Transition Management Response |
| | frames. |
| 1-255 | Relative values used to indicate the preferred ordering of |
| | BSSs, with 255 indicating the most preferred candidate and 1 |
| | indicating the least preferred candidate. |

In some examples, the STA may indicate the BSS preference for all Neighbor BSS to the lowest defined BSS preference setting (which is in a range of 1-255) to indicate that the STA shall not be moved to the BSS of the Neighbor Report element. In an example, the STA may indicate that it shall not be moved to the BSS of the Neighbor Report element by indicating the Reserved value of 0 for the BSS preference. In an example, a new transition reason value may be defined to indicate the sensing preferred link behavior of the STA to the ESS. This is described in an updated Table 9-198 from Draft P802.11REVmd_D5.0, a portion of which is shown below in Table 8.

TABLE 8
Transition and transition query reasons including
reasons for preferred sensing link

| Transition | |
|---|---|
| Reason value | Description |
| 0 | Unspecified |
| 1 | Excessive frame loss rates and/or poor |
| | conditions |
| 2 | Excessive delay for current traffic |
| | streams |
| 3 | Insufficient QoS capacity for current |
| | traffic streams (TSPEC rejected) |
| 4 | First association to ESS (the |
| | association initiated by an Association |
| | Request frame instead of a |
| | Reassociation Request frame) |
| 5 | Load Balancing |
| 6 | Better AP found |
| . . . | . . . |
| 16 | Low RSSI |
| . . . | . . . |
| 19 | Preferred BSS transition candidate list |
| | included |
| 20 | Leaving ESS |
| 21-255 | Reserved |
| SSTA-value | Selfish STA - Not to move |
| ASTA-value | Assertive STA - Move last |
| HSTA-value | Helpful STA - Minimum acceptable |
| | performance |
| PSTA-value | Periodic STA |

In an example, SSTA-value, ASTA-value, HSTA-value, and PSTA-value may be assigned one of the Reserved values, from 21-255. Further, in an example, when the HSTA-value transition reason value is used, an additional element may be included such that the STA may specify a minimum acceptable communication link performance on its original AP, such that as long as the minimum acceptable communication link performance is met, the STA shall not move or be moved to another AP. In an example, the minimum acceptable communication link performance of the original AP (AP1) may be specified in terms of Beacon RSSI of the Beacon frame of the original AP (AP1) as described in Section 11.43 (Beacon RSSI) of Draft P802.11REVmd_D5.0. The Beacon RSSI is reported in dBm, and so the minimum acceptable communication link performance level may be specified in dBm. In some examples, the minimum acceptable communication link performance of the original AP may be specified in terms of RXVECTOR RSSI of a PPDU received from the original AP as described in Section 15.2.3.3 (RXVECTOR RSSI) of Draft P802.11REVmd_D5.0. Further, in some examples, instead of an RSSI value, the minimum acceptable communication link performance on the original AP may be specified in terms of received channel power indicator (RCPI), signal quality (SQ), or indicated DATARATE via the PHY SAP of the Receive PHY as described in Section 15.3.7 (Receive PHY) of Draft P802.11REVmd_D5.0. PHY measures the RSSI and SQ, and the parameters are reported to the MAC in the RXVECTOR. The RCPI is a measure of the received RF power in the selected channel for a received frame. This parameter is a measure by the PHY of the received RF power in the channel measured over the entire received frame or by other equivalent means that meet the specified accuracy. The RCPI is described in Section 15.4.6.6 (Received Channel Power Indicator Measurement) of Draft P802.11REVmd_D5.0.

In an example, when the PSTA-value transition reason value is used, an additional element may be included such that the STA may specify a minimum or maximum periodicity (or a minimum or maximum frequency) for which it must return to its original AP to perform a sensing session or sensing measurement. In an example, the ESS may regard the specified minimum periodicity as a maximum interval between sensing sessions or sensing measurements on the original AP, i.e., the STA returns to its original AP for a sensing session or sensing measurement before the maximum interval is exceeded. In an example, the periodicity may be indicated using the ESS detection interval field which is part of the Location Indication Parameters subelement of a Location Parameter element as described in Section 9.4.2.70 (Location Parameters element) of Draft P802.11REVmd_D5.0.

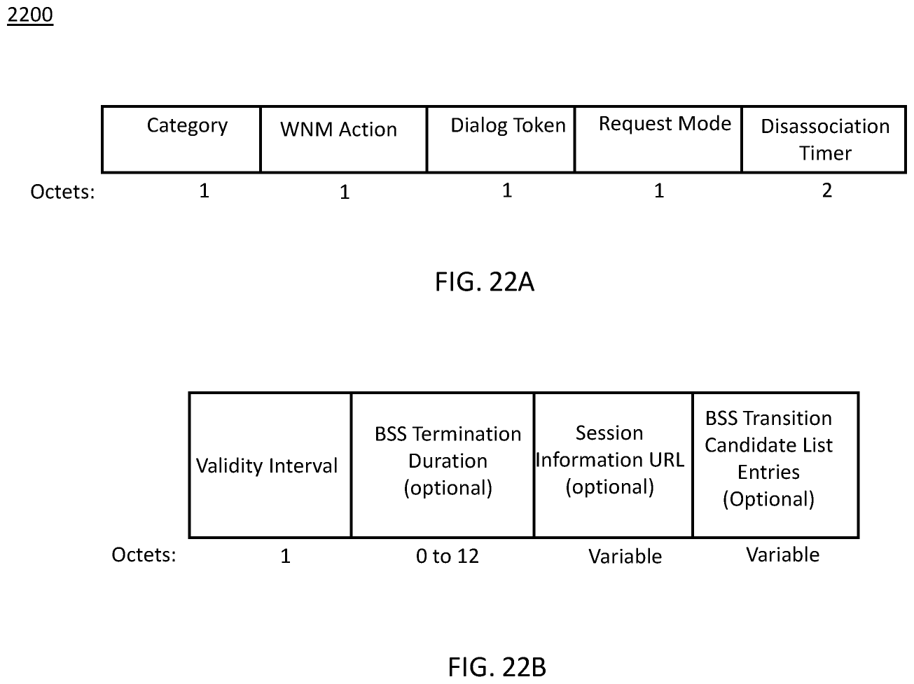

According to some embodiments, the BSS transition management query frame may be optional. In an example, instead of the STA sending a BSS transition management query frame, the AP may send a BSS transition management request frame to the STA. This may occur, for example, in the case where the AP is the sensing initiator of the sensing session. FIG. 22A and FIG. 22B depict BSS transition management request frame Action field format 2200. FIG. 22A and FIG. 22B are reproduction of FIG. 9-923 of Draft P802.11REVmd_D5.0. The WMN Action field value is equal to 7 (seven) for a BSS transition management request frame. The BSS transition management request frame format and procedures are described in Section 9.6.13.9 (BSS Transition Management Request frame format) of Draft P802.11REVmd_D5.0.

In an implementation, system 500 may use the BSS transition management request frame to indicate to the STA that it should maintain the original sensing link. The Request mode changes are analogous to the BSS transition management query frame changes as previously described. Further, the BSS transition candidate list entries field changes are analogous to those described for the BSS transition management query frame changes.

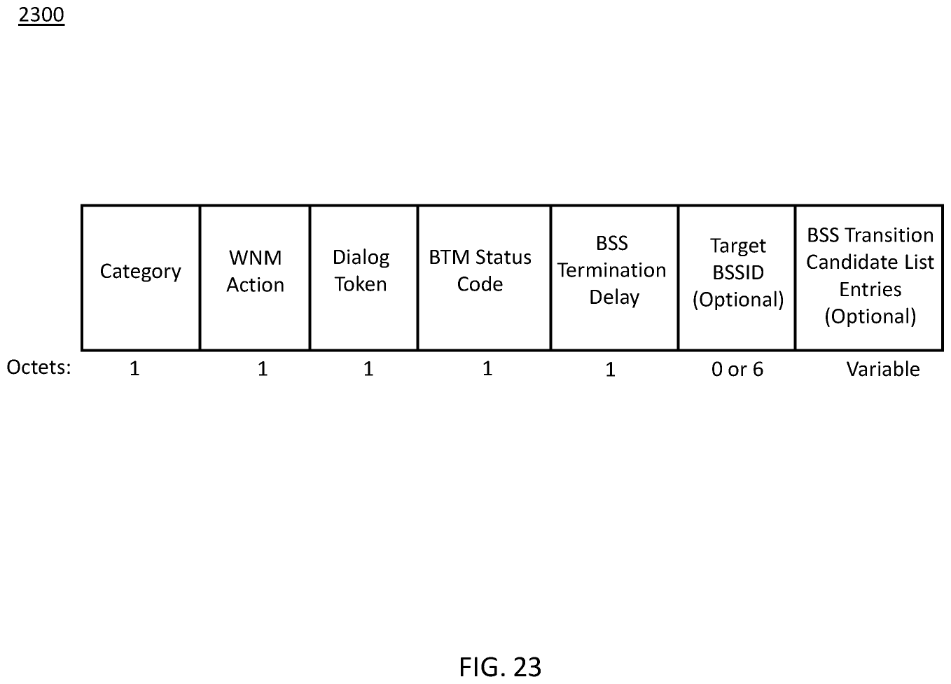

According to some implementations, the BSS transition management response frame may optionally be transmitted by a STA in response to a BSS transition management request frame. The WMN Action field value is equal to 8 (eight) for a BSS transition management response frame. FIG. 23 depicts BSS transition management response frame action field format 2300, according to some embodiments. FIG. 23 is a reproduction of FIG. 9-927 of Draft P802.11REVmd_D5.0.

In an example, the BTM Status Code field may include the status code in response to a BSS transition management request frame as defined in Table 9-428 (BTM status code definitions) of Draft P802.11REVmd_D5.0. In some examples, if the STA accepts a use case proposed by the AP, the STA may respond with the Status code “0” (Accept). In some examples, if the STA is a “Selfish STA”, the STA may respond with Status code “4” (BSS termination undesired), or with Status code “7” (No suitable BSS transition candidates). In an implementation, either of these status codes may have the effect of maintaining the original sensing link.

In some examples, if the STA is an “Assertive STA”, the STA may respond with Status code “5” (BSS termination delay requested). As a result, the ESS is signaled that the STA wants to be the last STA chosen to reassociate if the communication link is poor. In some examples, when using Status code “5”, the STA may additionally specify a number of minutes using the BSS termination delay field, which is the time for which the original association must be maintained before the association may be moved. The BSS termination delay field indicates the number of minutes that the responding STA requests the BSS to delay termination. In examples, this field is reserved if the Status code field value is not set to 5 (five).

According to some examples, the STA may respond with Status code “6” and provide the BSS transition candidate list, following the same procedures as were described above in Error! Reference source not found. In some examples, the STA may respond with one of four new status codes to indicate the use case that the STA wants to use. This may occur, for example, when the STA is the sensing initiator. A modified version of Table 9-428 (BTM status code definitions) from Draft P802.11REVmd_D5.0 is provided below in Table 9. In an implementation, additional fields may be provided for the Status code HSTA-code and the status code PSTA-code in order to specify minimum communication link thresholds or timing requirements for periodic measurements. In an example, SSTA-value, ASTA-value, HSTA-value and PSTA-value may be assigned one of the Reserved values, from 9-255.

TABLE 9
BTM status code definitions including
status codes for preferred sensing link

| Status code | Status code description |
|---|---|
| 0 | Accept |
| 1 | Reject - Unspecified reject reason. |
| 2 | Reject - Insufficient Beacon or Probe |
| | Response frames received from all |
| | candidates. |
| 3 | Reject - Insufficient available capacity |
| | from all candidates. |
| 4 | Reject - BSS termination undesired. |
| 5 | Reject - BSS termination delay |
| | requested. |
| 6 | Reject - STA BSS Transition Candidate |
| | list provided. |
| 7 | Reject - No suitable BSS transition |
| | candidates. |
| 8 | Reject - Leaving ESS. |
| SSTA-code | Reject - Selfish STA - Not to move |
| ASTA-code | Reject - Assertive STA - Move last |
| HSTA-code | Reject - Helpful STA - Minimum |
| | acceptable performance |
| PSTA-code | Reject - Periodic STA |

Examples by which an original sensing link is restored for a “Periodic STA” are described in detail below.

In an implementation, a “Periodic STA” may enable a STA that has been moved to the preferred communication link to periodically return back to the original association (or the original sensing link) for a sensing measurement. In other words, the STA may re-establish the original association with an original AP on a periodic basis to enable the sensing measurement of the original sensing link. In an example, the STA may re-establish the original association with the original AP via a fast BSS transition protocol. In some examples, the STA may achieve a sensing measurement with the original AP via a partial or complete PASN procedure.

According to an implementation, a fast BSS transition procedure using a fast transition key hierarchy may allow STAs to make fast BSS transitions between APs without the need for re-authentication. In an implementation, fast BSS transition (described in Section 13 of Draft 802.11REVmd_D5.0) may reduce the time that connectivity is lost between a STA and a distribution system during a BSS transition. According to an implementation, APs capable of fast BSS transition may allow STAs to request resources prior to reassociation. Further, the fast transition protocols may require information to be exchanged during the initial association between a STA (FTO) and an AP. The initial exchange may be referred to as the FT initial mobility domain association, and subsequent reassociations to APs within the same mobility domain may make use of fast BSS transition protocols.

In an implementation, four action frame formats are defined to support fast BSS transitions over the distribution system, that are initiated through the currently associated AP. The FT action frames may be sent over-the-air between the STA and the current AP. The action frame may be used as a transport mechanism for data that are destined for the target AP. An FT action field, in the octet immediately after the Category field, differentiates the FT action frame formats. The FT action field values associated with each FT action frame format are defined in Table 9-398 (FT Action field values) of Draft 802.11REVmd_D5.0. The Table 9-398 is reproduced as Table 10 described below.

TABLE 10
FT action field values for fast BSS transitions

| FT Action field value | Description |
|---|---|
| 0 | Reserved |
| 1 | FT Request frames |
| 2 | FT Response frames |
| 3 | FT Confirm frames |
| 4 | FT Ack frames |
| 5-255 | Reserved |

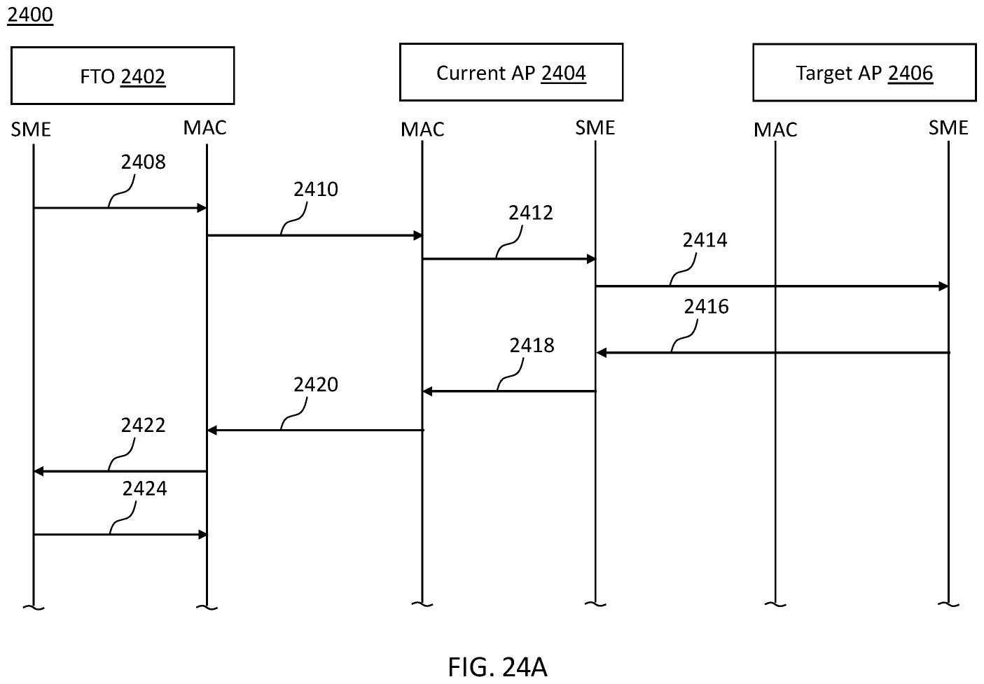

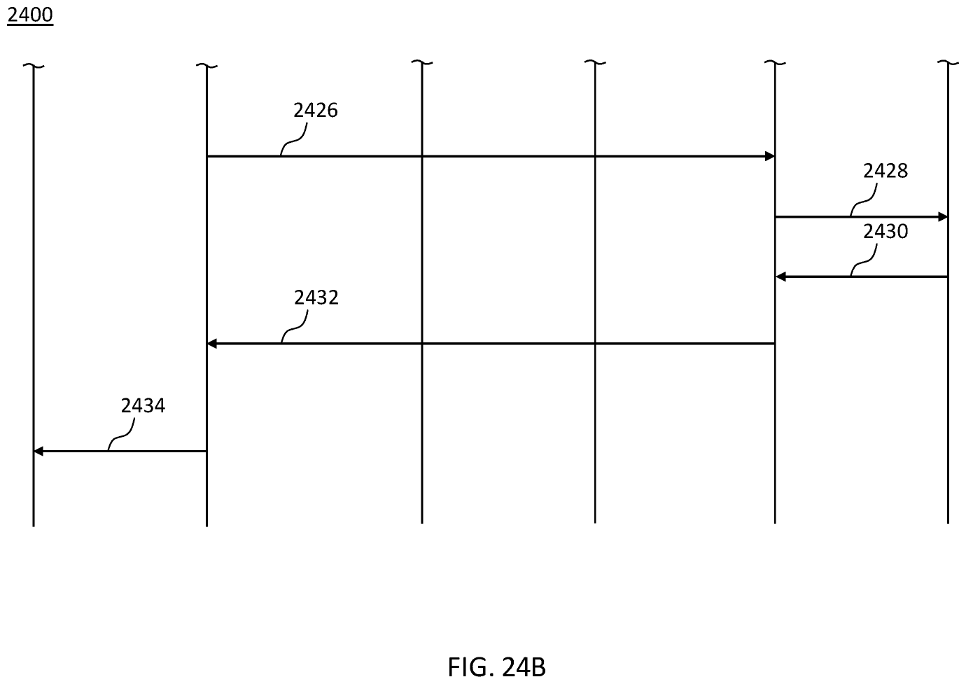

FIG. 24A and FIG. 24B depict process 2400 in MLME interfaces for over-the-distribution system FT protocol messages, according to some embodiments. FIG. 24A and FIG. 24B may be a reproduction of FIG. 13-7 MLME interfaces for over-the-DS FT protocol messages of Draft 802.11REVmd_D5.0. Referring to FIG. 24A and FIG. 24B, FTO 2402 may be an STA, Current AP 2404 may be AP2, and Target AP 2406 may be is AP1. At step 2408 of process 2400, SME of FTO 2402 may send MLME-REMOTE-REQUEST.request primitive to MAC of FTO 2402. At step 2410 of process 2400, the MAC of FTO 2402 may send FT Action Request (elements) to MAC of Current AP 2404. At step 2412 of process 2400, the MAC of Current AP 2404 may send MLME-REMOTE-REQUEST.indication primitive to SME of Current AP 2404. At step 2414 of process 2400, the SME of Current AP 2404 may send RemoteRequest (elements) to SME of Target AP 2406. Upon receiving the RemoteRequest (elements) from the SME of Current AP 2404, the SME of Target AP 2406 may process the RemoteRequest (elements). At step 2416 of process 2400, the SME of Target AP 2406 may send RemoteResponse (elements) to SME of Current AP 2404. At step 2418 of process 2400, the SME of Current AP 2404 may send MLME-REMOTE-REQUEST.request primitive to the MAC of Current AP 2404. At step 2420 of process 2400, the MAC of Current AP 2404 may send FT Action Response (elements) to the MAC of FTO 2402. At step 2422 of process 2400, the MAC of FTO 2402 may send MLME-REMOTE-REQUEST.indication primitive to SME of FTO 2402. At step 2424 of process 2400, the SME of FTO 2402 may send MLME-REASSOCIATE.request primitive to MAC of FTO 2402. At step 2426 of process 2400, the MAC of FTO 2402 may send Reassociation Request (elements) to the MAC of Target AP 2406. At step 2428 of process 2400, the MAC of Target AP 2406 may send MLME-REASSOCIATE.indication primitive to the SME of Target AP 2406. At step 2430 of process 2400, the SME of Target AP 2406 may send MLME-REASSOCIATE. response primitive to the MAC of Target AP 2406. At step 2432 of process 2400, the MAC of Target AP 2406 may send Reassociation Response (elements) to the MAC of FTO 2402. At step 2434 of process 2400, the MAC of FTO 2402 may send MLME-REASSOCIATE.confirm primitive to the SME of FTO 2402.

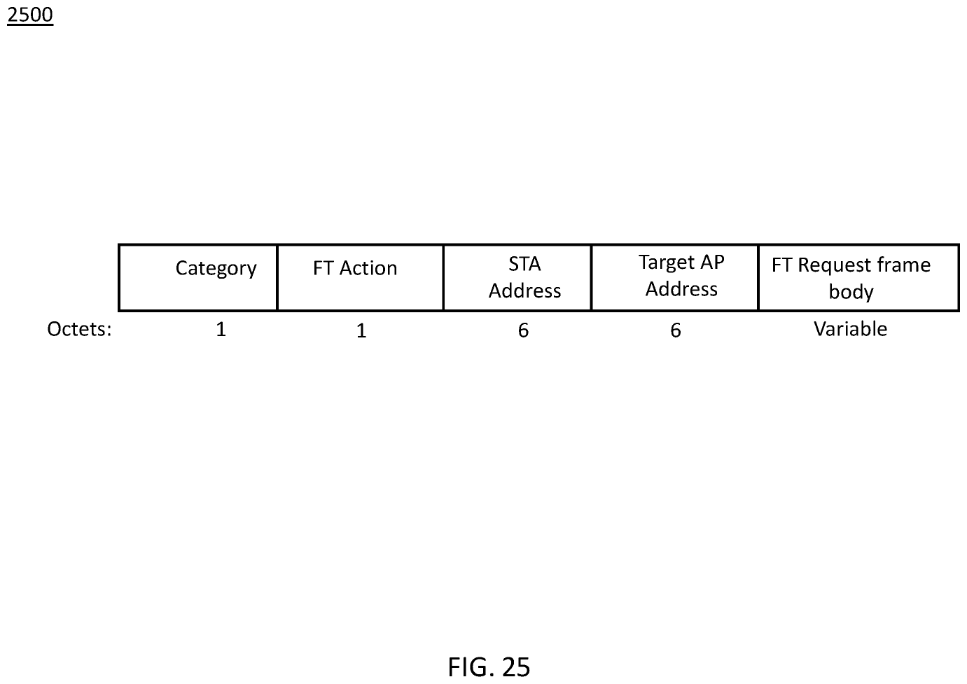

In an implementation, the FT request frame (described in Section 9.6.8.2 of Draft 802.11REVmd_D5.0) may be sent by the STA to AP2 (with which it is associated for the communications link) to initiate an over-the-distribution system fast BSS transition to AP1 for the original sensing link. FIG. 25 depicts FT request frame action field format 2500, according to some embodiments. FIG. 25 is a reproduction of FIG. 9-910-FT Request frame Action field format of Draft 802.11REVmd_D5.0.

According to an implementation, the “Periodic STA” may set the Target AP address to the address of AP1. Once the STA is reassociated with AP1, a sensing session or sensing measurement may occur. The fast BSS transition may be used to transition the STA back to AP2 to use the preferred communication link.

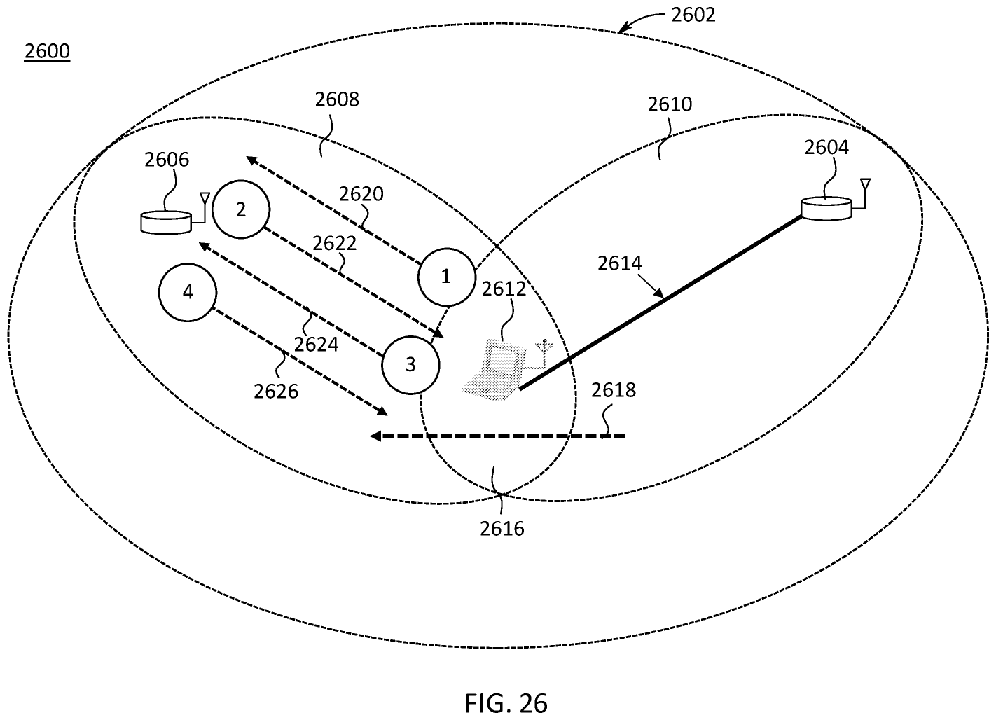

FIG. 26 depicts example representation 2600 of an over-the-air FT protocol in the context of ESS 2602, according to some embodiments. In particular, FIG. 26 depicts FT procedures from AP2 2604 to AP1 2606 in the context of ESS 2602. Further, a coverage area of AP1 2606 is represented by reference number “2608” and a coverage area of AP2 2604 is represented by reference number “2610”. As described in FIG. 26, AP2 2604 is associated with STA 2612. Further, association link 2614 between AP2 2604 and STA 2612 is shown in FIG. 26. Also, there may be coverage overlapping area 2616 between AP1 2606 and AP2 2604 for STA 2612. An arrow (represented by reference number “2618”) may show a transition direction. In an implementation, STA 2612 may send an FT authentication request to AP1 2606 (shown by arrow 2620). AP1 2606 may send an FT authentication response to STA 2612 (shown by arrow 2620). Thereafter, STA 2612 may send a reassociation request to AP1 2606 (shown by arrow 2624). Further, AP1 2606 may send a reassociation response to STA 2612 (shown by arrow 2626).

In an implementation, when an STA (FTO) invokes the FT protocol, the first two messages of the sequence (i.e., the first message and the second message) are carried in authentication frames or in action frames, and these messages are described in Section 13.8.2 (FT authentication sequence: contents of first message) and in Section 13.8.3 (FT authentication sequence: contents of second message) of Draft 802.11REVmd_D5.0. The third message and the fourth message in the sequence are carried in the reassociation request frame and the reassociation response frame, and are described in Section 13.8.4 (FT authentication sequence: contents of third message) and Section 13.8.5 (FT authentication sequence: contents of fourth message) of Draft 802.11REVmd_D5.0.

According to an implementation, when the STA (FTO) invokes the FT resource request protocol, then the first four messages of the sequence (i.e., the first message, the second message, the third message, and the fourth message) are carried in authentication frames or in action frames, and these messages are described in Section 13.8.2 (FT authentication sequence: contents of first message) to Section 13.8.5 (FT authentication sequence: contents of fourth message) of Draft 802.11REVmd_D5.0. According to an implementation, the fifth frame and the sixth frame of the FT resource request protocol are carried in the Reassociation Request frame and Reassociation Response frame, and are described in Section 13.8.4 (FT authentication sequence: contents of third message) and Section 13.8.5 (FT authentication sequence: contents of fourth message) of Draft 802.11REVmd_D5.0.

According to an implementation, the first message may be used by the STA (FTO) to initiate a fast BSS transition. When RSNA is enabled, the FTO may include the R0KH-ID and the SNonce in the FTE, and the PMKR0Name in the RSNE. The target AP may use the PMKR0Name to derive the PMKR1Name, and if the target AP does not have the PMK-R1 identified by PMKR1Name, the target AP may attempt to retrieve the key from the R0KH identified by R0KH-ID as described in Section 13.2 (Key holders) of Draft P802.11REVmd_D5.0. The FTO includes a fresh SNonce as its contribution to the association instance identifier and to provide key separation of the derived PTK. In an implementation, the second message may be used by the target AP to respond to the requesting FTO. The target AP may provide the key holder identifiers and key names used to generate the PTK. The target AP may also include fresh ANonce as its contribution to the association instance identifier and to provide key separation of the derived PTK. The response may include a status code.

In an RSN, the third message may be used by the FTO to assert to the target AP that it has a valid PTK. If no resources are required, then the FTO may omit inclusion of the RIC. The fourth message may be used by the target AP to respond to the requesting FTO. In an implementation, the fourth message may serve as final confirmation of the transition, establishes that the AP possesses the PMK-R1 and is participating in this association instance, and protects against downgrade attacks. In some implementation, the RIC may be absent, for example, if no resources were requested in the third message. The response may include a status code and a reassociation deadline.

According to an implementation, a periodic performance of sensing measurements between the STA and AP1 without the re-establishment of the original association link may be achieved through the use and potential modification of PASN procedures. In an implementation, PASN may allow a pre-association encrypted exchange with an AP, such that PASN could enable a non-AP STA (or a STA which is “Out of BSS”) to perform sensing with an AP with which it is not associated. In an implementation, when the association link of the STA changes from AP1 to AP2 for preferred data communications (as shown in FIG. 15A and FIG. 15B), either autonomously or using BSS transition management procedures, the preferred sensing link may still be the original sensing link (e.g., the link between the STA and AP1 in FIG. 15A and FIG. 15B). In an example, in order to perform sensing measurements on the original sensing link, a partial or complete PASN pre-association encrypted exchange with the original AP1 may be used for periodic sensing measurements. As shown in FIG. 13, there are Beacon and three PASN pre-association authentication frames between the AP and the STA as part of the PASN procedure.

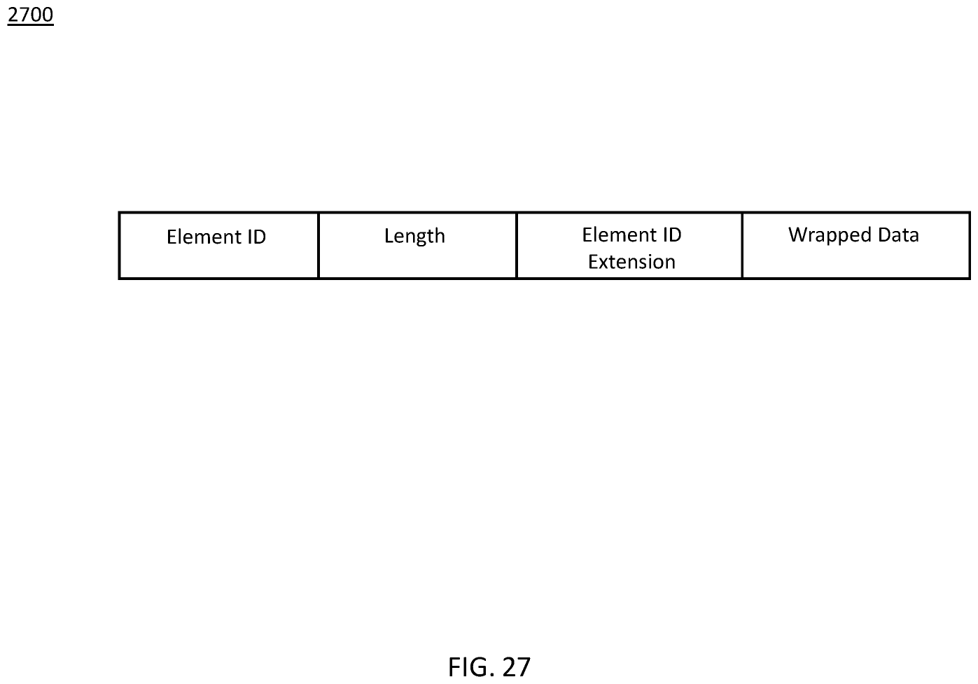

In an example, for information exchange between the STA and the AP along with the PASN authentication frames, the wrapped data element as described in Section 9.4.2.187 (Wrapped Data element) of Draft P802.11az_D4.0 may be used for the STA and the AP to communicate data using the RSNA protocols. FIG. 27 depicts wrapped data element format 2700, according to some embodiments. FIG. 27 is a reproduction of FIG. 9—664—Wrapped Data element format from Draft P802.11az_D4.0. In an implementation, the Element ID, Length, and Element ID Extension fields are defined in Section 9.4.2.1, General of Draft P802.11az_D4.0. In an example, the Wrapped Data field may include the data that could be used by PASN authentication algorithm.

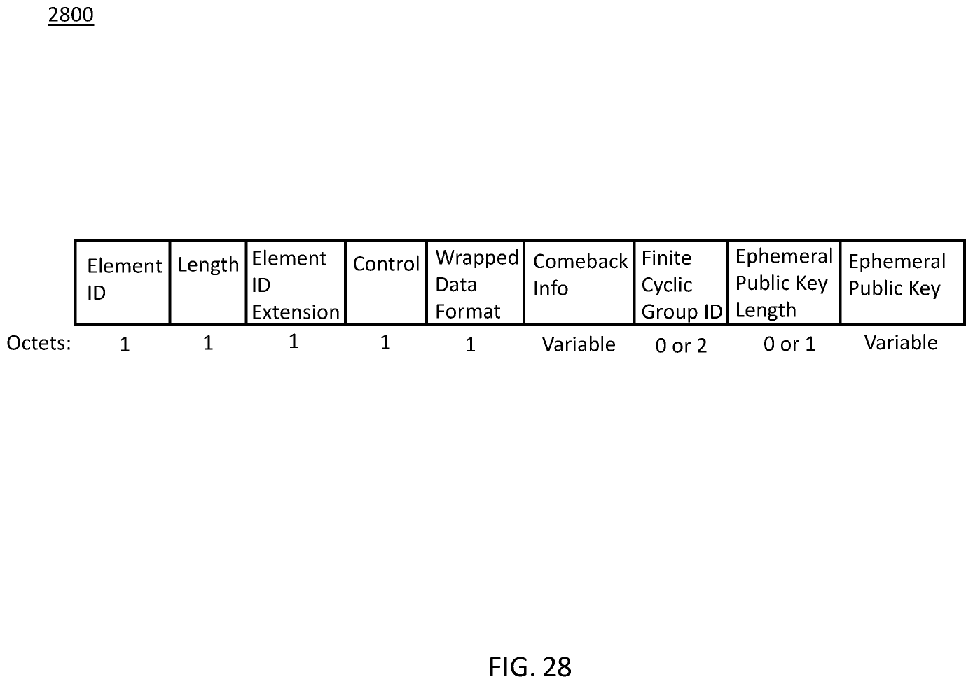

FIG. 28 depicts PASN parameters element format 2800, according to some embodiments. FIG. 28 is a reproduction of FIG. 9—778ued—PASN Parameters element format from Draft P802.11az_D4.0. The Wrapped Data Format field (as shown in FIG. 28) indicates the format of the data in the Wrapped Data element included along with the PASN parameters element. The values defined for the format are described below.

| | |
|---|---|
| 0: | No wrapped data |
| 1: | Fast BSS Transition Wrapped Data (described in Section |
| | 12.12.6 (PASN Authentication with FT) of Draft |
| | P802.11az_D4.0) |
| 2: | FILS Shared Key authentication without PFS Wrapped Data |
| 3: | SAE Wrapped Data (described in Section 12.12.5 (PASN |
| | authentication with SAE) of Draft P802.11az_D4.0) |
| Other: | Reserved |

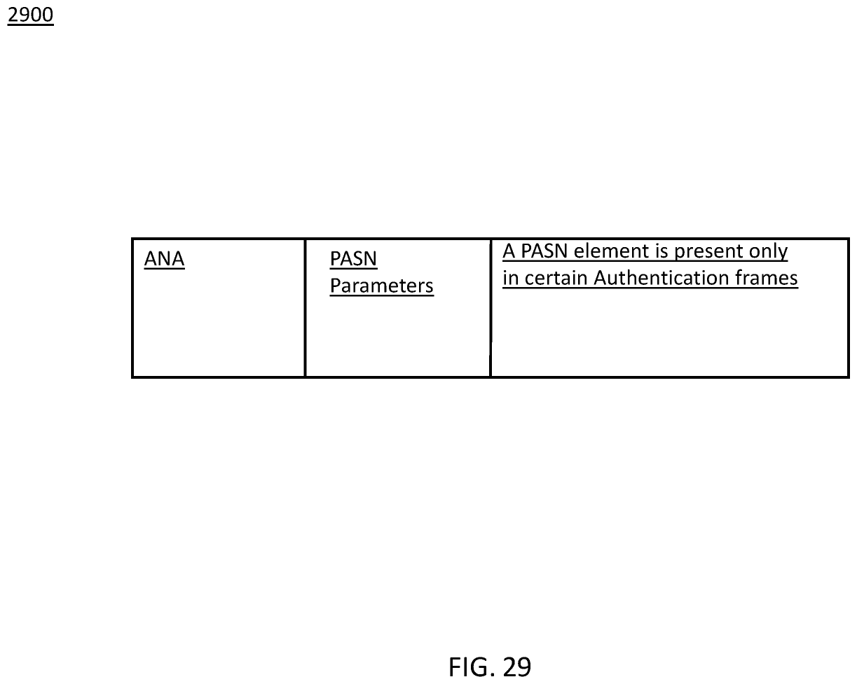

As described in Section 12.12.3.2 (PASN Frame Construction and Processing) of Draft P802.11az_D4.0, the wrapped data is included in the three PASN authentication frames, namely a first PASN authentication frame, a second PASN authentication frame, and a third PASN authentication frame. In the first PASN authentication frame (as described in Section 9.3.3.11 (Authentication frame format) of Draft P802.11az_D4.0) of the exchange, the authentication frame authentication algorithm number field (ANA), described in Section 9.4.1.1 (Authentication Algorithm Number field) of Draft P802.11az_D4.0 is described as shown in Table 9-40 of Draft P802.11az_D4.0. The Table 9-40 of Draft P802.11az_D4.0 is reproduced as FIG. 29. In particular, FIG. 29 depicts authentication frame body 2900, according to some embodiments. In an implementation, the PASN element may be defined in Table 9-41 (Presence of fields and elements in Authentication frames) of Draft P802.11az_D4.0. The Table 9-41 is reproduced in part in Table 11 provided below.

TABLE 11
Presence of fields and elements in Authentication frames

| | Authentication | | |
|---|---|---|---|
| | transaction | | |
| Authentication | sequence | Status | |
| algorithm | number | code | Presence of fields 4 onwards |
| PASN | 1 | Reserved | RSNE is present. |
| authentication | | | RSNXE is present if any subfield of the |
| | | | Extented RSN Capabilities field in this |
| | | | element, except the Field Length subfield, is |
| | | | nonzero. (#TC1106r0) |
| | | | PASN Parameters element is present. |
| | | | Timeout Interval element may be present. |
| | | | Wrapped Data element is present if wrapped |
| | | | data format in PASN parameters element is |
| | | | non-zero and not reserved. |
| | | | Fragment element may be present if any of |
| | | | the elements are fragmented. |
| PASN | 2 | Status | RSNE is present and PASN Parameters |
| authentication | | | element is present if Status Code field is 0. |
| | | | RSNXE is present if any subfield of the |
| | | | Extented RSN Capabilities field in this |
| | | | element, except the Field Length subfield, is |
| | | | nonzero. (#TC1106r0) |
| | | | Timeout Interval element may be present. |
| | | | Wrapped data element is present if wrapped |
| | | | data format in PASN parameters element is |
| | | | non-zero and not reserved and Status Code |
| | | | field is 0. |
| | | | MIC element is present. |
| | | | Fragment element may be present if any of |
| | | | the elements are fragmented and Status |
| | | | Code Field is 0. (#2051) |
| PASN | 3 | Status | PASN Parameters element is present if |
| authentication | | | Status Code field is 0. |
| | | | Wrapped data element is present if wrapped |
| | | | data format in PASN parameters element is |
| | | | non-zero and not reserved; and Status Code |
| | | | field is 0. |
| | | | MIC element is present. |
| | | | Fragment element may be present if any of |
| | | | the elements are fragmented and Status |
| | | | Code field is 0. (#2051) |

According to an implementation, the STA may construct a first PASN frame. In an example, the first PASN frame may be constructed as follows: a) Step 1: Including the constructed RSNE; b) Step 2: Including Section 9.4.2.303 (PASN Parameters Element) of Draft P802.11az_D4.0 with the wrapped data format, chosen finite cyclic group ID, and the ephemeral public key. Comeback information is included and is set to the cookie length and the cookie is received from the AP if the authentication is being retried; and c) Step 3: Including Section 9.4.2.187 (Wrapped Data Element) of Draft P802.11az_D4.0 corresponding to Base AKM data, if any. This element may be fragmented using the mechanism specified in Section 10.28.11 (Element fragmentation) of Draft P802.11az_D4.0, as necessary.

In an implementation, the STA may send the first PASN frame to the AP. Upon receiving the first PASN frame, the AP may construct the second PASN frame. In an example, the second PASN frame may be constructed as follows: a) Step 1: Section 9.4.1.1 (Authentication Algorithm Number field) of Draft P802.11az_D4.0 set to ANA (PASN Authentication); b) Step 2: Section 9.4.1.2 (Authentication Transaction Sequence Number field) of Draft P802.11az_D4.0 set to 2; c) Step 3: Status code indicating the processing status; d) Step 4: Including Section 9.4.2.303 (PASN Parameters Element) of Draft P802.11az_D4.0 with the wrapped data format, chosen finite cyclic group ID, and the ephemeral public key of the AP. The Control field in the element may be set appropriately to indicate the presence or absence of fields in the element. e) Step 5: Including Section 9.4.2.187 (Wrapped Data Element) of Draft P802.11az_D4.0 corresponding to Base AKM data to be returned to the non-AP STA, if any. This element may be fragmented using the mechanism specified in Section 10.28.11 (Element fragmentation) of Draft P802.11az_D4.0, as necessary.

Once the second PASN frame is constructed, the AP may send the second PASN frame to the unassociated STA. Upon receiving the second PASN frame, the unassociated STA may construct the third PASN frame. In an example, the third PASN frame may be constructed as follows: a) Step 1: Section 9.4.1.1 (Authentication Algorithm Number field) of Draft P802.11az_D4.0 set to ANA (PASN Authentication); b) Step 2: Section 9.4.1.2 (Authentication Transaction Sequence Number field) of Draft P802.11az_D4.0 set to 3; c) Step 3: Status code indicating success; d) Step 4: Including Section 9.4.2.303 (PASN Parameters Element) of Draft P802.11az_D4.0 with the wrapped data format. Public Key information and Comeback Info fields may not be present. The Control field in the element is set appropriately to indicate the presence or absence of fields in the element. e) Step 5: Including Section 9.4.2.187 (Wrapped Data Element) of Draft P802.11az_D4.0 corresponding to Base AKM data to be returned to the non-AP STA, if any. This element may be fragmented using mechanism specified in Section 10.28.11 (Element fragmentation) of Draft P802.11az_D4.0, as necessary. f) Step 6: Including Section 9.4.2.118 (MIC element) of Draft P802.11az_D4.0 with MIC computed as specified in Section 12.12.8 (MIC computation for PASN third frame) of Draft P802.11az_D4.0.

According to an implementation, based on the wrapped data in the PASN authentication frames as described above, the sensing measurement may be performed during the sensing period scheduled by the distribution system using either of a first option and a second option described below.

A) First Option: If the AP is the sensing initiator (and the sensing receiver, i.e., the sensing measurement is processed at the AP), then the long training field (LTF) within the preamble on the physical layer of the first PASN frame or the third PASN frame (from the STA to the original AP1) may be used for making sensing measurements by AP1 on the original sensing link. The AP may use the wrapped data field of the second PASN frame to indicate to the STA to abort the PASN authentication procedure after receiving the third PASN frame.

B) Second Option: If the STA is the sensing initiator (and the sensing receiver, i.e., the sensing measurement is processed at the STA), then the LTF within the preamble on the physical layer of the Beacon of the second PASN frame (from the original AP1 to the STA) may be used for making the sensing measurements by the STA. The STA may use the wrapped data field of the third PASN frame to upload the sensing measurement reports to the original AP1 and indicate to the original AP1 to abort the PASN authentication procedure after receiving the third PASN frame.

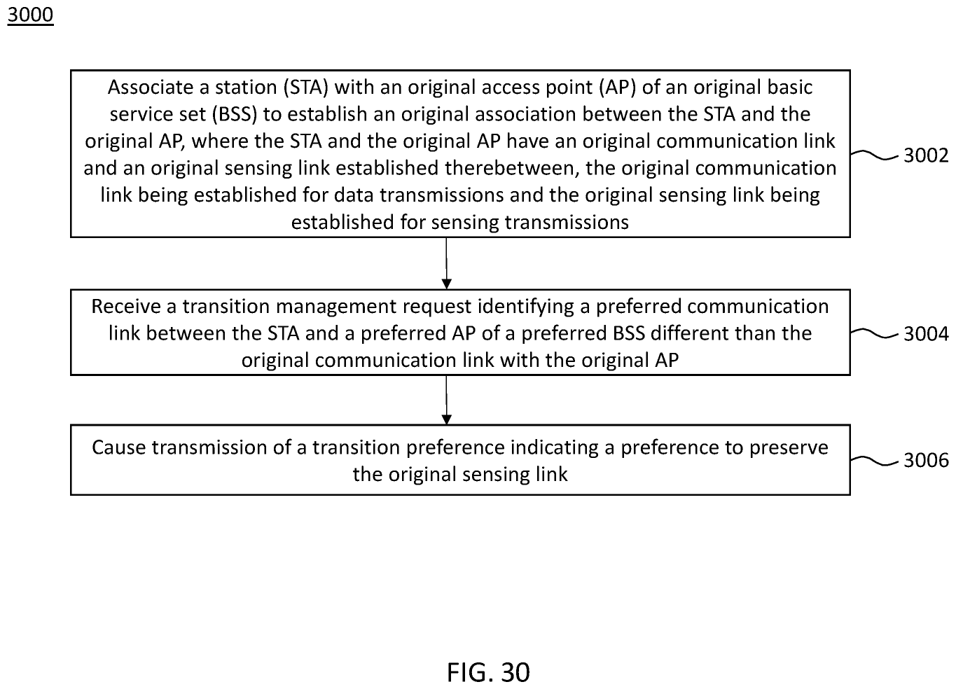

FIG. 30 depicts flowchart 3000 for causing transmission of a transition preference indicating a preference to preserve an original sensing link, according to some embodiments.

In a brief overview of an implementation of flowchart 3000, at step 3002, a station (STA) is associated with an original access point (AP) of an original basic service set (BSS) to establish an original association between the STA and the original AP, where the STA and the original AP have an original communication link and an original sensing link established therebetween, the original communication link being established for data transmissions and the original sensing link being established for sensing transmissions. At step 3004, a transition management request identifying a preferred communication link between the STA and a preferred AP of a preferred BSS different than the original communication link with the original AP is received. At step 3006, transmission of a transition preference indicating a preference to preserve the original sensing link is caused.

Step 3002 includes associating a STA with an original AP of an original BSS to establish an original association between the STA and the original AP, where the STA and the original AP have an original communication link and an original sensing link established therebetween, the original communication link being established for data transmissions and the original sensing link being established for sensing transmissions. According to an implementation, first sensing transmitter 504-1 may be configured to operate as the STA. In an implementation, first sensing agent 526-1 may be configured to associate the STA (i.e., first sensing transmitter 504-1) with the original AP of the original basic service set (BSS) (for example, first sensing receiver 502-1) to establish an original association between the STA and the original AP. The STA and the original AP have an original communication link and an original sensing link established therebetween, the original communication link being established for data transmissions and the original sensing link being established for sensing transmissions.

Step 3004 includes receiving a transition management request identifying a preferred communication link between the STA and a preferred AP of a preferred BSS different than the original communication link with the original AP. In an implementation, first sensing agent 526-1 may be configured to receive the transition management request identifying the preferred communication link between the STA and the preferred AP of the preferred BSS different than the original communication link with the original AP. In an example, the preferred AP may be second sensing receiver 502-2 or any sensing receiver other than first sensing receiver 502-1. In an implementation, the preferred communication link may be identified by a distribution system based on load balancing within an extended service set (ESS) including the original BSS and the preferred BSS.

Step 3006 includes causing transmission of a transition preference indicating a preference to preserve the original sensing link. In an implementation, first sensing agent 526-1 may be configured to cause the transmission of the transition preference indicating the preference to preserve the original sensing link. In an example, the transition preference may indicate a request that at least one other STA within the original BSS associates with alternate AP before the STA associates with an alternate AP. According to an example, the at least one other STA may include second sensing transmitter 504-2 or any sensing transmitter other than first sensing transmitter 504-1. Further, in an example, the alternate AP may be second sensing receiver 502-2 or any sensing receiver other than first sensing receiver 502-1. In some examples, the transition preference may indicate a minimum performance threshold for the original communication link and a requirement that the STA maintain the original association while the original communication link maintains performance above the minimum performance threshold. In some examples, the transition preference may be indicated by a sensing link preference action frame indicating the preference to maintain the original association. In some examples, the transition preference may be indicated by a wireless network management field value in a wireless network management action frame. Further, in some examples, the transition preference may include one of a BSS transition management query and a BSS transition management response indicating a preference to maintain the original association by a preferred BSS transition candidate list. In some examples, the transition preference may include a BSS transition management response indicating a preference to maintain the original association by a BSS transition management status code. In some examples, the transition preference may include a BSS transition management query indicating a preference to maintain the original association in a BSS transition query reason field.

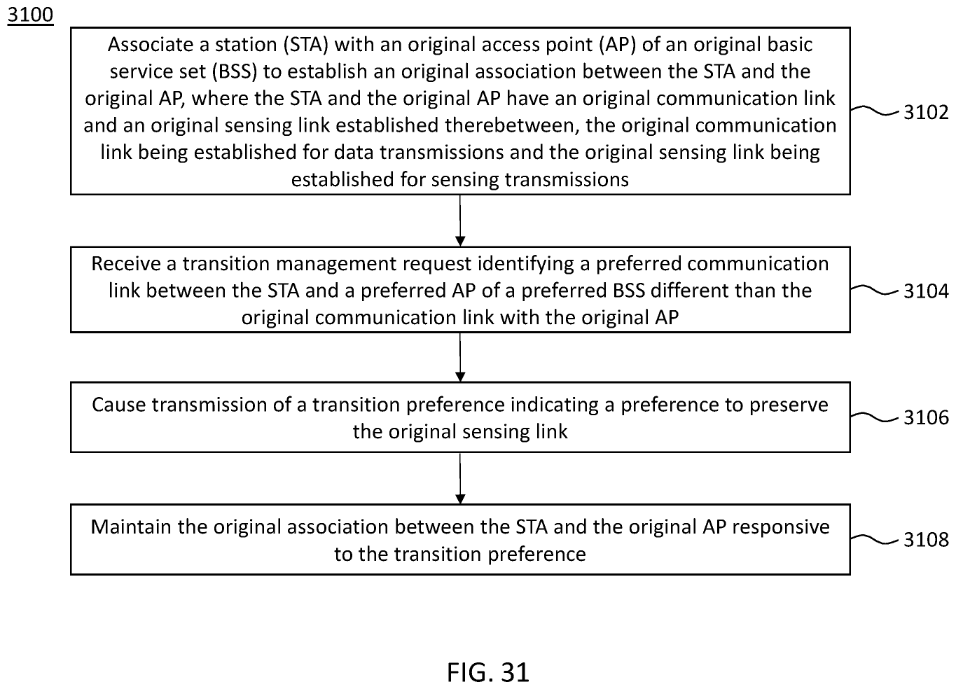

FIG. 31 depicts flowchart 3100 for maintaining an original association between a STA and an original AP responsive to a transition preference, according to some embodiments.

In a brief overview of an implementation of flowchart 3100, at step 3102, a STA is associated with an original AP of an original BSS to establish an original association between the STA and the original AP, where the STA and the original AP have an original communication link and an original sensing link established therebetween. The original communication link being established for data transmissions and the original sensing link being established for sensing transmissions. At step 3104, a transition management request identifying a preferred communication link between the STA and a preferred AP of a preferred BSS different than the original communication link with the original AP is received. At step 3106, transmission of a transition preference indicating a preference to preserve the original sensing link is caused. At step 3108, the original association between the STA and the original AP is maintained responsive to the transition preference.

Step 3102 includes associating a STA with an original AP of an original BSS to establish an original association between the STA and the original AP, where the STA and the original AP have an original communication link and an original sensing link established therebetween, the original communication link being established for data transmissions and the original sensing link being established for sensing transmissions. According to an implementation, first sensing transmitter 504-1 may be configured to operate as the STA. In an implementation, first sensing agent 526-1 may be configured to associate the STA (i.e., first sensing transmitter 504-1) with the original AP of the original basic service set (BSS) (for example, first sensing receiver 502-1) to establish an original association between the STA and the original AP. The STA and the original AP have an original communication link and an original sensing link established therebetween, the original communication link being established for data transmissions and the original sensing link being established for sensing transmissions.

Step 3104 includes receiving a transition management request identifying a preferred communication link between the STA and a preferred AP of a preferred BSS different than the original communication link with the original AP. In an implementation, first sensing agent 526-1 may be configured to receive the transition management request identifying the preferred communication link between the STA and the preferred AP of the preferred BSS different than the original communication link with the original AP. In an example, the preferred AP may be second sensing receiver 502-2 or any sensing receiver other than first sensing receiver 502-1. In an implementation, the preferred communication link may be identified by a distribution system based on load balancing within an extended service set (ESS) including the original BSS and the preferred BSS.

Step 3106 includes causing transmission of a transition preference indicating a preference to preserve the original sensing link. In an implementation, first sensing agent 526-1 may be configured to cause the transmission of the transition preference indicating the preference to preserve the original sensing link. In an example, the transition preference may indicate a request that at least one other STA within the original BSS associates with alternate AP before the STA associates with an alternate AP. According to an example, the at least one other STA may include second sensing transmitter 504-2 or any sensing transmitter other than first sensing transmitter 504-1. Further, in an example, the alternate AP may be second sensing receiver 502-2 or any sensing receiver other than first sensing receiver 502-1. In some examples, the transition preference may indicate a minimum performance threshold for the original communication link and a requirement that the STA maintain the original association while the original communication link maintains performance above the minimum performance threshold. In some examples, the transition preference may be indicated by a sensing link preference action frame indicating the preference to maintain the original association. In some examples, the transition preference may be indicated by a wireless network management field value in a wireless network management action frame. Further, in some examples, the transition preference may include one of a BSS transition management query and a BSS transition management response indicating a preference to maintain the original association by a preferred BSS transition candidate list. In some examples, the transition preference may include a BSS transition management response indicating a preference to maintain the original association by a BSS transition management status code. In some examples, the transition preference may include a BSS transition management query indicating a preference to maintain the original association in a BSS transition query reason field.

Step 3108 includes maintaining the original association between the STA and the original AP responsive to the transition preference. In an implementation, first sensing agent 526-1 may be configured to maintain the original association between the STA and the original AP responsive to the transition preference.

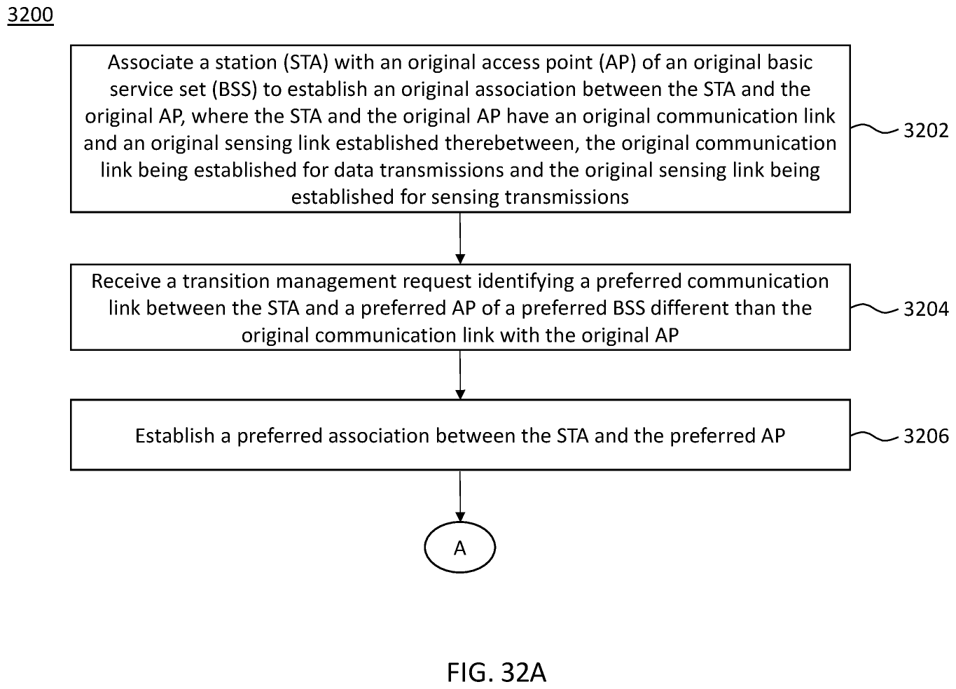

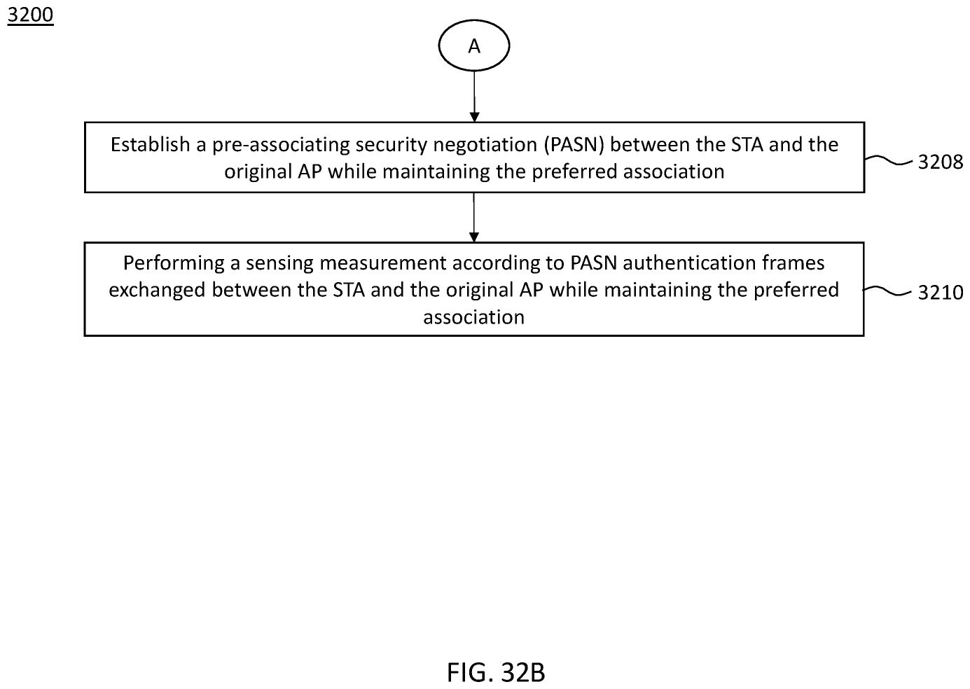

FIG. 32A and FIG. 32B depict flowchart 3200 for performing a sensing measurement according to pre-associating security negotiation (PASN) authentication frames exchanged between a STA and an original AP while maintaining a preferred association, according to some embodiments.

In a brief overview of an implementation of flowchart 3200, at step 3202, a STA is associated with an original AP of an original BSS to establish an original association between the STA and the original AP, where the STA and the original AP have an original communication link and an original sensing link established therebetween. The original communication link being established for data transmissions and the original sensing link being established for sensing transmissions. At step 3204, a transition management request identifying a preferred communication link between the STA and a preferred AP of a preferred BSS different than the original communication link with the original AP is received. At step 3206, a preferred association between the STA and the preferred AP is established. At step 3208, a PASN between the STA and the original AP is established while maintaining the preferred association. At step 3210, a sensing measurement is performed according to PASN authentication frames exchanged between the STA and the original AP while maintaining the preferred association.

Step 3202 includes associating a STA with an original AP of an original BSS to establish an original association between the STA and the original AP, where the STA and the original AP have an original communication link and an original sensing link established therebetween, the original communication link being established for data transmissions and the original sensing link being established for sensing transmissions. According to an implementation, first sensing transmitter 504-1 may be configured to operate as the STA. In an implementation, first sensing agent 526-1 may be configured to associate the STA (i.e., first sensing transmitter 504-1) with the original AP of the original basic service set (BSS) (for example, first sensing receiver 502-1) to establish an original association between the STA and the original AP. The STA and the original AP have an original communication link and an original sensing link established therebetween, the original communication link being established for data transmissions and the original sensing link being established for sensing transmissions.

Step 3204 includes receiving a transition management request identifying a preferred communication link between the STA and a preferred AP of a preferred BSS different than the original communication link with the original AP. In an implementation, first sensing agent 526-1 may be configured to receive the transition management request identifying the preferred communication link between the STA and the preferred AP of the preferred BSS different than the original communication link with the original AP. In an example, the preferred AP may be second sensing receiver 502-2 or any sensing receiver other than first sensing receiver 502-1. In an implementation, the preferred communication link may be identified by a distribution system based on load balancing within an extended service set (ESS) including the original BSS and the preferred BSS.

Step 3206 includes establishing a preferred association between the STA and the preferred AP. In an implementation, first sensing agent 526-1 may be configured to establish the preferred association between the STA and the preferred AP.

Step 3208 includes establishing a PASN between the STA and the original AP while maintaining the preferred association. In an implementation, first sensing agent 526-1 may be configured to establish the PASN between the STA and the original AP while maintaining the preferred association.

Step 3210 includes performing a sensing measurement according to PASN authentication frames exchanged between the STA and the original AP while maintaining the preferred association. In an implementation, first sensing agent 526-1 may be configured to perform the sensing measurement according to the PASN authentication frames exchanged between the STA and the original AP while maintaining the preferred association.

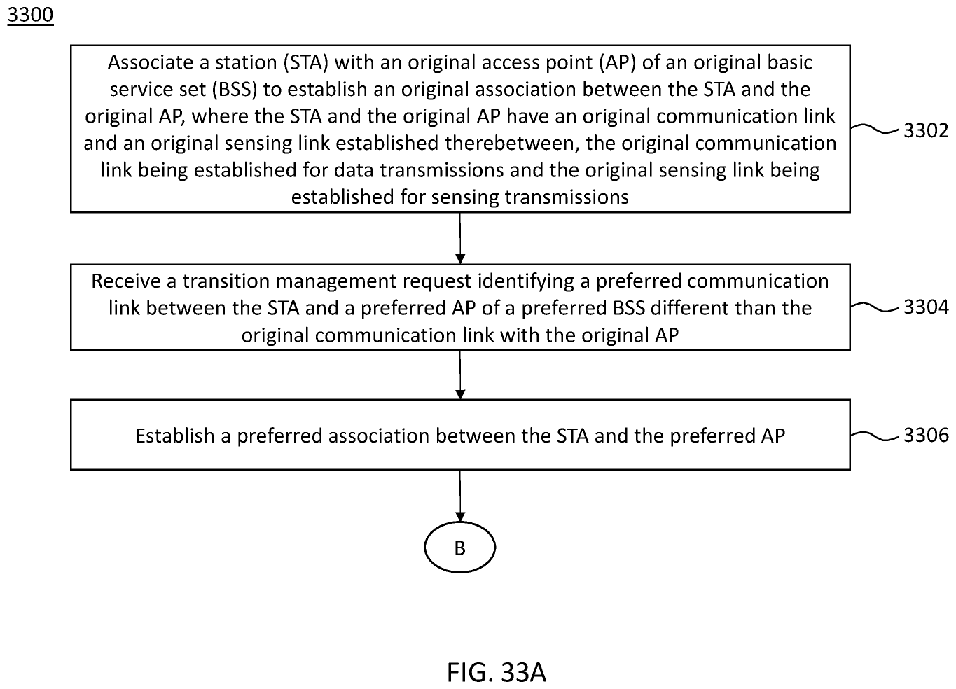

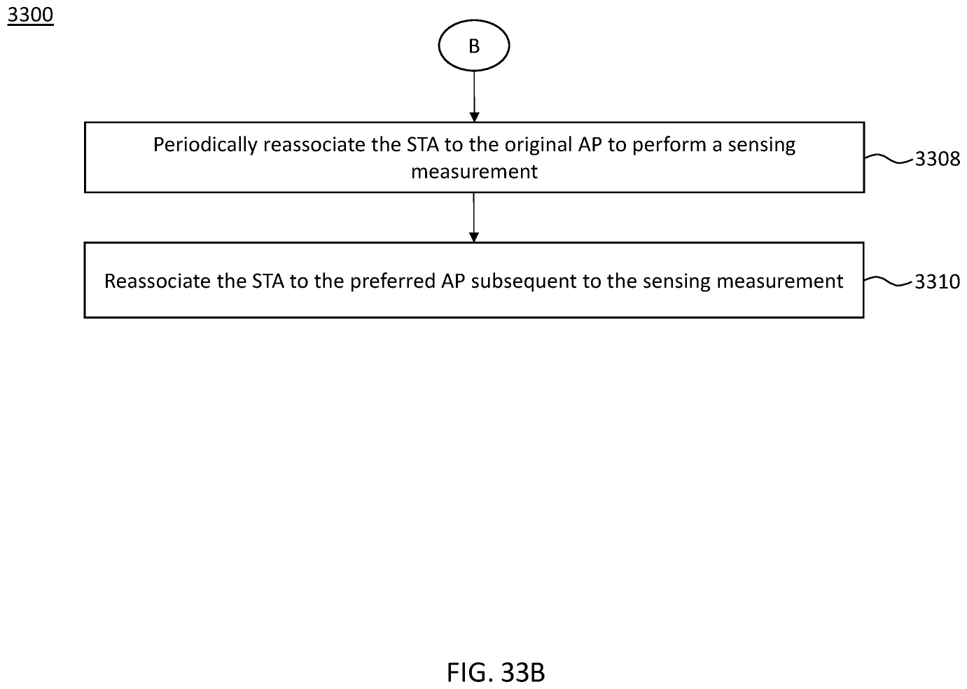

FIG. 33A and FIG. 33B depict flowchart 3300 for reassociation of a STA to a preferred AP subsequent to a sensing measurement, according to some embodiments.

In a brief overview of an implementation of flowchart 3300, at step 3302, a STA is associated with an original AP of an original BSS to establish an original association between the STA and the original AP, where the STA and the original AP have an original communication link and an original sensing link established therebetween. The original communication link being established for data transmissions and the original sensing link being established for sensing transmissions. At step 3304, a transition management request identifying a preferred communication link between the STA and a preferred AP of a preferred BSS different than the original communication link with the original AP is received. At step 3306, a preferred association between the STA and the preferred AP is established. At step 3308, the STA is periodically reassociated to the original AP to perform a sensing measurement. At step 3310, the STA is reassociated to the preferred AP subsequent to the sensing measurement.

Step 3302 includes associating a STA with an original AP of an original BSS to establish an original association between the STA and the original AP, where the STA and the original AP have an original communication link and an original sensing link established therebetween, the original communication link being established for data transmissions and the original sensing link being established for sensing transmissions. According to an implementation, first sensing transmitter 504-1 may be configured to operate as the STA. In an implementation, first sensing agent 526-1 may be configured to associate the STA (i.e., first sensing transmitter 504-1) with the original AP of the original basic service set (BSS) (for example, first sensing receiver 502-1) to establish an original association between the STA and the original AP. The STA and the original AP have an original communication link and an original sensing link established therebetween, the original communication link being established for data transmissions and the original sensing link being established for sensing transmissions.

Step 3304 includes receiving a transition management request identifying a preferred communication link between the STA and a preferred AP of a preferred BSS different than the original communication link with the original AP. In an implementation, first sensing agent 526-1 may be configured to receive the transition management request identifying the preferred communication link between the STA and the preferred AP of the preferred BSS different than the original communication link with the original AP. In an example, the preferred AP may be second sensing receiver 502-2 or any sensing receiver other than first sensing receiver 502-1. In an implementation, the preferred communication link may be identified by a distribution system based on load balancing within an extended service set (ESS) including the original BSS and the preferred BSS.

Step 3306 includes establishing a preferred association between the STA and the preferred AP. In an implementation, first sensing agent 526-1 may be configured to establish the preferred association between the STA and the preferred AP.

Step 3308 includes periodically reassociating the STA to the original AP to perform a sensing measurement. In an implementation, first sensing agent 526-1 may be configured to periodically reassociate the STA to the original AP to perform the sensing measurement.

Step 3310 includes reassociate the STA to the preferred AP subsequent to the sensing measurement. In an implementation, first sensing agent 526-1 may be configured to reassociate the STA to the preferred AP subsequent to the sensing measurement. In an example implementation, reassociating the STA to the original AP is performed via a fast BSS transition protocol.

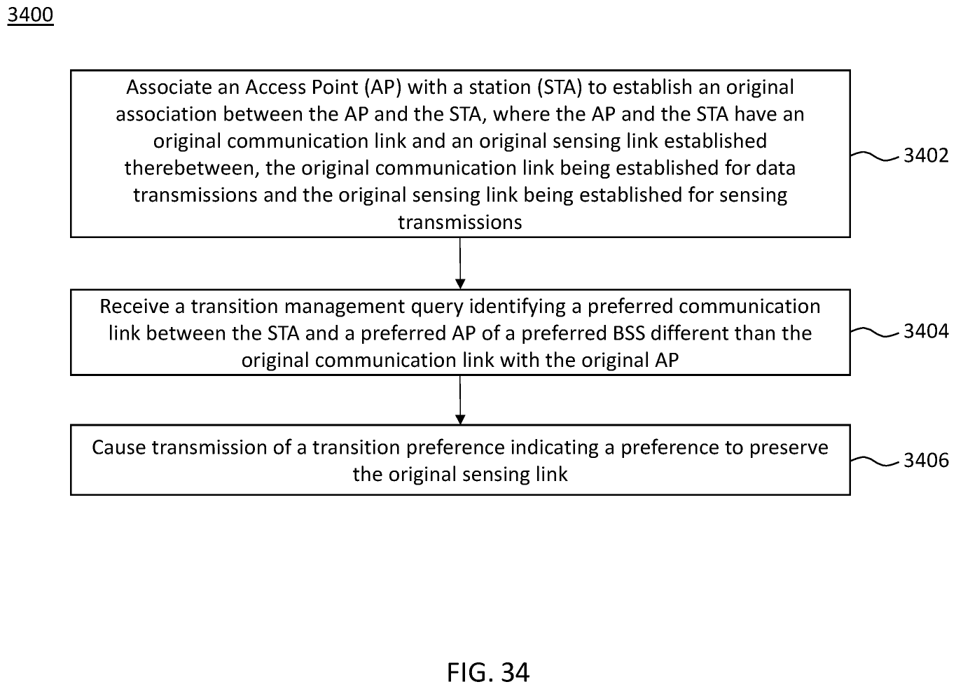

FIG. 34 depicts flowchart 3400 for causing transmission of a transition preference indicating a preference to preserve an original sensing link, according to some embodiments.

In a brief overview of an implementation of flowchart 3400, at step 3402, an AP is associated with a STA to establish an original association between the AP and the STA, where the AP and the STA have an original communication link and an original sensing link established therebetween. The original communication link being established for data transmissions and the original sensing link being established for sensing transmissions. At step 3404, a transition management query identifying a preferred communication link between the STA and a preferred AP of a preferred BSS different than the original communication link with the AP is received. At step 3406, transmission of a transition preference indicating a preference to preserve the original sensing link is caused.

Step 3402 includes associating an AP with a STA to establish an original association between the AP and the STA, where the AP and the STA have an original communication link and an original sensing link established therebetween, the original communication link being established for data transmissions and the original sensing link being established for sensing transmissions. According to an implementation, first sensing receiver 502-1 may be configured to operate as the AP. In an implementation, first sensing agent 516-1 may be configured to associate the AP (i.e., first sensing receiver 502-1) with the STA (for example, first sensing transmitter 504-1) to establish an original association between the AP and the STA. The AP and the STA may have an original communication link and an original sensing link established therebetween, the original communication link being established for data transmissions and the original sensing link being established for sensing transmissions.

Step 3404 includes receiving a transition management query identifying a preferred communication link between the STA and a preferred AP of a preferred BSS different than the original communication link with the AP. In an implementation, first sensing agent 516-1 may be configured to receive the transition management query identifying the preferred communication link between the STA and the preferred AP of the preferred BSS different than the original communication link with the AP. In an example, the preferred AP may be second sensing transmitter 504-2 or any sensing transmitter other than first sensing transmitter 504-1.

Step 3406 includes causing transmission of a transition preference indicating a preference to preserve the original sensing link. In an implementation, first sensing agent 516-1 may be configured to cause the transmission of the transition preference indicating the preference to preserve the original sensing link. In an example, the transition preference may indicate a requirement that the STA maintain the original association with the AP. In some examples, the transition preference may indicate a minimum performance threshold for the original communication link and a requirement that the STA maintain the original association with the AP while the original communication link maintains performance above the minimum performance threshold. Further, in some examples, the transition preference may be indicated by a sensing link preference action frame indicating the preference to maintain the original sensing link. In some example, the transition preference may be indicated by a wireless network management field value in a wireless network management action frame. In some examples, the transition preference may include a BSS transition management request. Further, in some examples, the BSS transition management request may indicate the preference to maintain the original association by a preferred BSS transition candidate list.

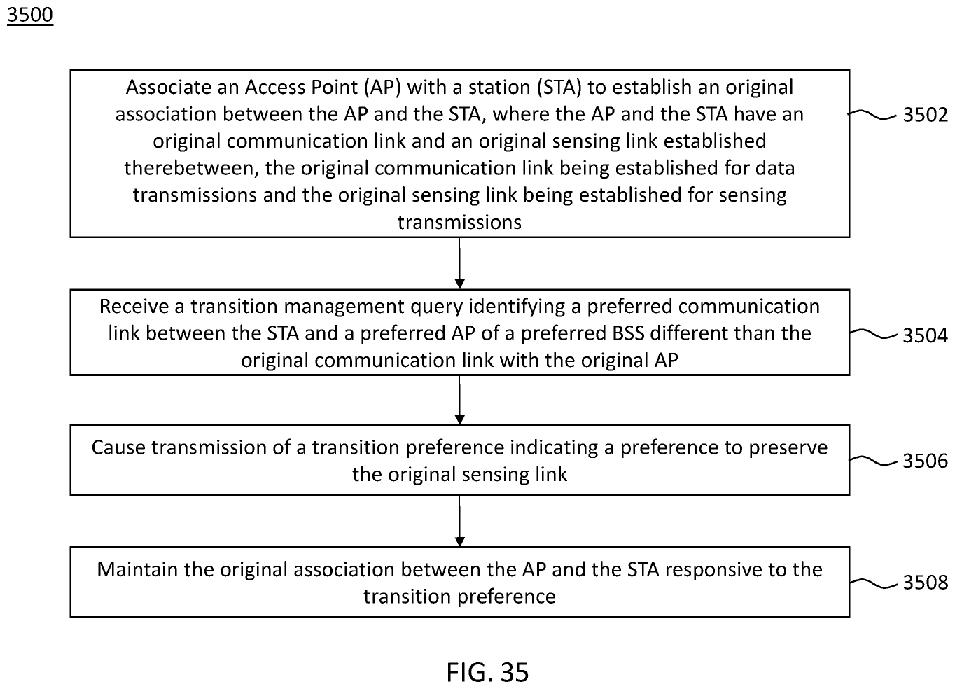

FIG. 35 depicts flowchart 3500 for maintaining an original association between an AP and a STA responsive to a transition preference, according to some embodiments.

In a brief overview of an implementation of flowchart 3500, at step 3502, an AP is associated with a STA to establish an original association between the AP and the STA, where the AP and the STA have an original communication link and an original sensing link established therebetween. The original communication link being established for data transmissions and the original sensing link being established for sensing transmissions. At step 3504, a transition management query identifying a preferred communication link between the STA and a preferred AP of a preferred BSS different than the original communication link with the AP is received. At step 3506, transmission of a transition preference indicating a preference to preserve the original sensing link is caused. At step 3508, the original association between the AP and the STA is maintained responsive to the transition preference.

Step 3502 includes associating an AP with a STA to establish an original association between the AP and the STA, where the AP and the STA have an original communication link and an original sensing link established therebetween, the original communication link being established for data transmissions and the original sensing link being established for sensing transmissions. According to an implementation, first sensing receiver 502-1 may be configured to operate as the AP. In an implementation, first sensing agent 516-1 may be configured to associate the AP (i.e., first sensing receiver 502-1) with the STA (for example, first sensing transmitter 504-1) to establish an original association between the AP and the STA. The AP and the STA may have an original communication link and an original sensing link established therebetween, the original communication link being established for data transmissions and the original sensing link being established for sensing transmissions.

Step 3504 includes receiving a transition management query identifying a preferred communication link between the STA and a preferred AP of a preferred BSS different than the original communication link with the AP. In an implementation, first sensing agent 516-1 may be configured to receive the transition management query identifying the preferred communication link between the STA and the preferred AP of the preferred BSS different than the original communication link with the AP. In an example, the preferred AP may be second sensing transmitter 504-2 or any sensing transmitter other than first sensing transmitter 504-1.

Step 3506 includes causing transmission of a transition preference indicating a preference to preserve the original sensing link. In an implementation, first sensing agent 516-1 may be configured to cause the transmission of the transition preference indicating the preference to preserve the original sensing link. In an example, the transition preference may indicate a requirement that the STA maintain the original association with the AP. In some examples, the transition preference may indicate a minimum performance threshold for the original communication link and a requirement that the STA maintain the original association with the AP while the original communication link maintains performance above the minimum performance threshold. Further, in some examples, the transition preference may be indicated by a sensing link preference action frame indicating the preference to maintain the original sensing link. In some example, the transition preference may be indicated by a wireless network management field value in a wireless network management action frame. In some examples, the transition preference may include a BSS transition management request. Further, in some examples, the BSS transition management request may indicate the preference to maintain the original association by a preferred BSS transition candidate list.

Step 3508 includes maintaining the original association between the AP and the STA responsive to the transition preference. In an implementation, first sensing agent 516-1 may be configured to maintain the original association between the AP and the STA responsive to the transition preference.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

1-46. (canceled)

47. A method for Wi-Fi sensing carried out by a networking device configured to operate as a station (STA) and including at least one processor configured to execute instructions, the method comprising:
associating the STA with a first access point (AP) of a first basic service set (BSS) to establish an association between the STA and the first AP, wherein the STA and the first AP have a communication link established for data transmissions;
transmitting, by the STA, a signal requesting a sensing session between the STA and a second AP with which the STA is not associated, the signal including a requested periodicity of the sensing session; and
performing, by the STA, according to the periodicity, sensing measurements with the second AP with which the STA is not associated.

48. The method of claim 47, wherein the first AP is a preferred AP for data transmissions.

49. The method of claim 47, wherein the second AP is a preferred AP for sensing measurements

50. The method of claim 47, further comprising pausing the data transmissions during performing of the sensing measurements.

51. The method of claim 50, further comprising resuming the data transmissions subsequent to performing of the sensing measurements.

52. The method of claim 48, wherein the preferred AP for data transmissions is identified by a distribution system based on load balancing within an extended service set (ESS) including at least the first BSS.

53. The method of claim 47, further comprising causing transmission of a transition preference indicating a preference to perform sensing measurements with the second AP.

54. The method of claim 57, wherein the periodicity represents a maximum elapsed time between sensing measurements.

55. A system for Wi-Fi sensing, comprising:
a networking device configured to operate as a station (STA) and including at least one processor configured to:
associate the STA with a first access point (AP) of a first basic service set (BSS) to establish an association between the STA and the first AP, wherein the STA and the first AP have a communication link established for data transmissions;
transmit a signal requesting a sensing session between the STA and a second AP with which the STA is not associated, the signal including a requested periodicity of the sensing session; and
perform, according to the periodicity, sensing measurements with the second AP with which the STA is not associated.

56. The system of claim 55, wherein the first AP is a preferred AP for data transmissions.

57. The system of claim 55, wherein the second AP is a preferred AP for sensing measurements

58. The system of claim 55, wherein the at least one processor is further configured to pause the data transmissions during performing of the sensing measurements.

59. The system of claim 58, wherein the at least one processor is further configured to resume the data transmissions subsequent to performing of the sensing measurements.

60. The system of claim 56, wherein the preferred AP for data transmissions is identified by a distribution system based on load balancing within an extended service set (ESS) including at least the first BSS.

61. The system of claim 55, wherein the at least one processor is further configured to cause the transmission of a transition preference indicating a preference to perform sensing measurements with the second AP.

62. The system of claim 55, wherein the periodicity represents a maximum elapsed time between sensing measurements.

63. A method for Wi-Fi sensing carried out by a networking device configured to operate as an access point (AP) of an original basic service set (BSS) and including at least one processor configured to execute instructions, the method comprising:
associating the AP with a first station (STA) to establish an association between the first STA and the AP, wherein the first STA and the AP have a communication link established for data transmissions;
receiving, by the AP, a first signal requesting a sensing session between the AP and a second STA with which the AP is not associated,
transmitting, by the AP, a second signal including a requested periodicity of the sensing session; and
performing, by the AP, according to the periodicity, sensing measurements with the second STA with which the AP is not associated.
